(19) United States
(12) Patent Application Publication
(10) Pub. No.: US 2025/0299657 A1
(43) Pub. Date: Sep. 25, 2025

(54) DJ PERFORMANCE DATA CONVERSION

(71) Applicant: DENSITY ONE, INC., Brooklyn, NY (US)

(72) Inventors: Jason Schwartz, New York, NY (US); Oleksii Solodovnikov, New York, NY (US); Aleksandar Genal, Belgrade (RS)

(21) Appl. No.: 19/088,635

(22) Filed: Mar. 24, 2025

Related U.S. Application Data
(60) Provisional application No. 63/569,624, filed on Mar. 25, 2024.

(51) Int. Cl. G10H 1/00

(52) U.S. Cl. CPC G10H 1/0058; G10H 2210/031; G10H 2210/125; G10H 2240/325

(57) ABSTRACT

Examples relate to generating an editable representation of a DJ performance. A computing system accesses at least one data stream representing the DJ performance and analyzes it to identify audio elements within the performance. The system generates a digital representation of the audio elements editable in a digital audio workstation, wherein the digital representation comprises a structured data format including information related to tracks, effects, and timing. The digital representation may include track objects for tracks played, clip objects representing segments of tracks, processor objects representing effects applied to tracks, and tempo objects representing tempo information. The system stores the digital representation, which can be loaded into a digital audio workstation application for editing using tools specific for DJ editing workflows.

### CLAIM OF PRIORITY

This patent application claims the benefit of priority to U.S. Provisional Application Ser. No. 63/569,624, filed Mar. 25, 2024, which is incorporated by reference herein in its entirety.

### TECHNICAL FIELD

The present disclosure relates to specialized monitoring and recording systems for live audio performances, particularly to hardware-integrated solutions that capture, analyze and process multi-source audio performance data for subsequent reproduction and enhancement.

### BACKGROUND

Digital audio editing software allows users to record, edit, and manipulate audio files on a computer. Early digital audio workstations (DAWs) were developed in the 1980s and 1990s to provide features such as non-linear, non-destructive editing and processing of audio. DAWs have evolved to include various tools for audio editing, effects processing, audio mixing, MIDI editing, and more.

DJs performing with vinyl records would mix tracks manually by beatmatching tempos and adjusting audio levels on a hardware DJ mixer. The advent of digital DJ equipment allowed new possibilities like instant looping samples and beat-synced effects. However, performing DJ mixes still require real-time manual manipulation by the DJ.

Some DAWs have developed features to facilitate audio editing for music production and live performance. However, existing DAWs are designed for general-purpose audio editing and do not provide specialized tools tailored for DJ workflows and techniques.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic diagram showing a digital audio environment for recording and processing DJ performances, according to some examples.

FIG. 2 is a block diagram showing an architecture of a message parser, according to some examples.

FIG. 3 is a block diagram representation of a converter and a generated DAW set file, according to some examples.

FIG. 4 is a block diagram illustrating the architecture of a DAW application, according to some examples.

FIG. 5 is an entity relationship diagram highlighting the structure and data fields of output files, according to some examples, generated during the DJ recording pipeline.

FIG. 6 is a flowchart illustrating a method for logging performance data from musical devices, according to some examples.

FIG. 7 is an interaction diagram that provides a different representation of the methods described in FIG. 6.

FIG. 8 is a flowchart illustrating a method for processing a recorded DJ performance data stream, according to some examples.

FIG. 9 is an interaction diagram that provides a different representation of the methods described in FIG. 8.

FIG. 10 is a flowchart illustrating a method for converting recorded DJ performance data into an editable digital audio file, according to some examples.

FIG. 11 is a flowchart that shows a method used by a converter to create a DAW set file, according to some examples.

FIG. 12 illustrates the user interface of a DAW application and demonstrates the downstream propagation of edits to a DJ mix timeline, according to some examples.

FIG. 13 illustrates the user interface of a DAW application and demonstrates the downstream propagation of edits to a DJ mix timeline, according to some examples.

FIG. 14 is a flowchart illustrating a method for propagating downstream changes when editing a digital media timeline, according to some examples.

FIG. 15 is a user interface diagram illustrating a method for modifying an audio track displayed within a user interface of a digital audio workstation (DAW) application to loop a selected track section of the audio track, according to some examples.

FIG. 16 is a flowchart illustrating a method for looping a section of a media track in a DAW application, according to some examples.

FIG. 17 is a flowchart illustrating a method for editing a DJ mix to loop a selected section, according to some examples.

FIG. 18 illustrates the user interface of a DAW application displaying an integrated loudness metering tool, according to some examples,

FIG. 19 is a flowchart illustrating a method for monitoring and displaying loudness of an audio signal during playback, according to some examples.

FIG. 20 illustrates a method for monitoring and displaying loudness of an audio signal during playback in accordance with some examples.

FIG. 21 is an interaction diagram illustrating a method, according to some examples, of displaying loudness of an audio signal during playback.

FIG. 22 is a block diagram showing a software architecture within which the present disclosure may be implemented, according to some examples.

FIG. 23 is a diagrammatic representation of a machine in the form of a computer system within which a set of instructions may be executed for causing the machine to perform any one or more of the methodologies discussed herein, in accordance with some examples.

### DETAILED DESCRIPTION

### Introduction

Digital DJing has revolutionized the music industry, allowing DJs to mix and manipulate music in real-time using digital audio files instead of traditional vinyl records or CDs. This shift to digital has been facilitated by the development of specialized DJ software and hardware, including digital turntables known as DJ media players and digital audio workstations (DAWs).

DJ media players are digital music players that emulate the functionality of traditional turntables, allowing DJs to manipulate digital audio files as if they were vinyl records. They are often network-connected, enabling them to communicate with each other and share information about the state of the music being played. This information can include the current track position, tempo, and other relevant data.

DAWs, on the other hand, are software platforms used for recording, editing, and producing audio files. They provide a range of tools and features for manipulating audio, including effects, equalizers, and automation lanes for controlling various parameters over time. DAWs also support the use of MIDI (Musical Instrument Digital Interface), a protocol for communicating musical information between digital devices.

Despite these advancements, there are still significant technical challenges associated with digital DJing. One of these is the difficulty of accurately recording and reproducing a DJ set. A DJ set is a sequence of tracks mixed together by a DJ during a performance. Recording a DJ set involves capturing not just the audio, but also the various actions and manipulations performed by the DJ, such as track selection, cueing, looping, and the application of effects. This data is often complex and difficult to parse, making it challenging to accurately record and reproduce a DJ set.

Furthermore, the data generated by DJ media players and mixers during a DJ set is often imperfect and incomplete. For example, the data may not accurately reflect the timing and sequence of events, or it may lack information about the initial state of the system. This can make it difficult to accurately reconstruct the DJ set from the recorded data.

Another challenge is the difficulty of visualizing and editing a recorded DJ set. Traditional DAWs are not designed for this purpose and often lack the tools and features that DJs require. For example, they may not provide an intuitive way to visualize and manipulate the sequence of tracks and transitions in a DJ set, or to adjust the timing and synchronization of different elements.

These challenges highlight the complexity of digital DJing and the ongoing demand for improved tools and technologies in this field.

Example disclosure relates to systems and methods for recording, processing, and visualizing DJ performance data. This enables comprehensive logging and post-production editing of DJ sets.

The technology bridges DJ equipment networks (e.g. media players, mixers) with software environments to produce complete digital representations of live DJ performances.

A logging system taps into real-time data streams from networked DJ gear during a live set. This captures granular metadata on cues, loops, effects, transitions, and other DJ actions. A converter module interprets this data based on audio domain knowledge to generate editable post-processed audio files.

Specialized DJ editing software provides tailored tools for workflows like beatmatching, looping samples, and automating transitions between tracks. The system propagates downstream mix changes to maintain continuity when editing. Integrated loudness metering enables precision tuning of mixes.

The unified workflow from live performance to post-production editing facilitates greater creative freedom. It captures the complexity of DJ techniques for in-depth refinement. Tight integration between hardware and software replaces real-time improvisation with flexible post-production experimentation.

By linking specialized DJ ecosystems with flexible editing platforms, the technology makes the recording process transparent. Expert performance data is leveraged to enable novices to produce professional-grade mixes. Creative possibilities expand for both amateur and expert DJs.

### Overview

The described technology, according to some examples, facilitates the recreation of DJ sets by synthesizing at least three data sources: data from DJ media players, MIDI control data, and audio waveform data. This synthesis is used for accurately reconstructing a DJ's live performance within a Digital Audio Workstation (DAW), subsequently allowing for detailed user-driven editing.

Data from DJ Media Players

Data from DJ media players captures the sequence and structure of a performance, including track queues, playback sequences, and beat-matching actions. This data forms a metadata layer that outlines the framework of the DJ set, reflecting the real-time decisions made during the performance.

### MIDI Control Data

MIDI control data provides a second layer, detailing the DJ's interaction with the mixer. This includes adjustments made to the mixer's controls, such as volume, balance, and effects, encoded as MIDI messages. This layer adds granularity to the performance data, illustrating the DJ's manipulation of the mix.

### Audio Waveform Data

The audio waveform data comprises the actual sound content—each track's audio that was played during the set. This data contains the sonic elements that define the set's auditory experience.

Recreation and Editing within the DAW

When the metadata from DJ media players and MIDI control data are imported into a DAW, they are aligned with the audio waveform data. The DAW utilizes this composite data to reconstruct the DJ set, arranging tracks and applying effects as per the original performance.

The DAW is equipped with editing tools specifically designed for DJ workflows. Users can modify various aspects of the set, such as track sequencing, transition timing, and loop durations. The DAW interface allows for precise manipulation of these elements, akin to a live DJ performance.

Users have the flexibility to apply new effects, adjust equalization, and modify volume levels. The DAW's non-destructive editing framework ensures that alterations can be tested and modified without permanent changes to the original audio files.

In essence, this technology provides a method for recreating DJ sets by combining performance metadata with audio content in a DAW, offering users extensive control over post-production editing. This method preserves the integrity of the live performance while enabling creative modifications to the set.

### Digital Audio Environment 102

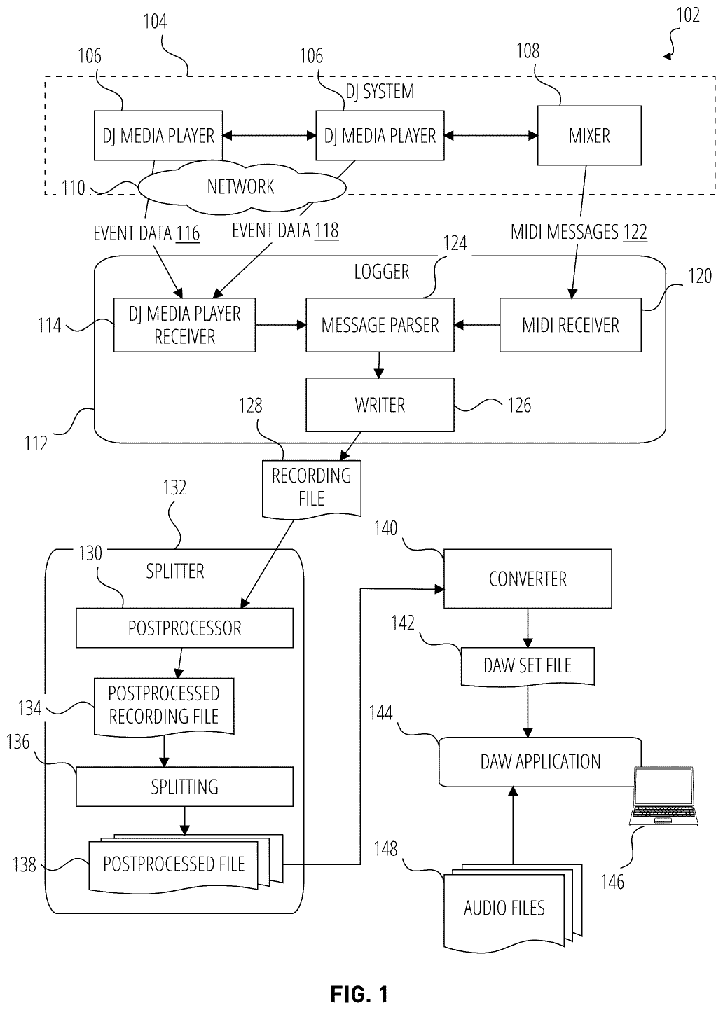

FIG. 1 is a schematic diagram, illustrating a digital audio environment 102 for recording and processing DJ performances, according to some examples. This environment includes a DJ system 104 comprised of multiple DJ media players 106 and a mixer 108 interconnected via a local area network (LAN) router to a network 110.

While FIG. 1 depicts a digital audio environment 102 with specific hardware components such as DJ media players 106 and a mixer 108, it should be noted that, in some examples, the functionalities of these hardware components may be replicated or implemented by software. For example, the digital audio environment 102 could be configured to interface with DJ software that emulates the capabilities of the physical hardware, with all components such as decks and mixers existing within a unified software application on a single laptop or computing device. Integrations may enable the logger 112 to log and process DJ performance data in a manner similar to the hardware-based system, ensuring that the system remains adaptable to advancements in DJ technology and can accommodate a fully software-driven DJing experience.

Returning to FIG. 1, the DJ media players 106 are advanced digital turntables designed specifically for live DJ mixing applications. The DJ media players 106 allow DJs to manipulate audio content from files loaded onto the devices as well as external streams. Each DJ media player 106 contains specialized features tailored for DJ workflows such as automatic tempo matching between units, quantization of cue points to musical beats, slip mode playback, and rapid track navigation controls.

The DJ media players 106 support a digital DJ networking protocol that enables synchronized playback and real-time sharing of detailed track metadata when the units are interconnected. This protocol enables advanced multi-deck mixing techniques by allowing the DJ media players 106 to exchange granular performance details.

The mixer 108 serves as a central hardware control interface for blending and routing audio signals from the various DJ media players 106. It includes multi-channel controls for gain, equalization, filtering, crossfader assignment, cue monitoring, and other adjustments to create the final combined audio mix. Additionally, the mixer 108 offers integrated effects such as echo, filter sweeps, and other real-time manipulations that DJs can apply dynamically while performing.

The DJ media players 106 and mixer 108 interface with each other via Ethernet cables connected through the network route, forming a wired local area network configuration. The DJ media players 106 link together by connecting to available ports on the network router. This interconnection via the router allows the DJ media players 106 to discover each other and exchange track metadata using the DJ network protocol.

The mixer 108 connects to the network router via a separate Ethernet uplink for general connectivity purposes. Unlike the DJ media players 106, the mixer 108 may not utilize the DJ networking protocol itself. Instead, it outputs MIDI (Musical Instrument Digital Interface) data containing control signals and event messages over a direct USB connection.

In some professional DJ setups, multiple DJ media players (e.g., two, three, or four decks) may be connected to the network router simultaneously. The DJ networking protocol is designed to accommodate multiple connected players, allowing each player to broadcast its state and receive updates from other players on the network. When multiple DJ media players 106 are connected, the DJ media player receiver 114 captures data from multiple players on the network, which may be handled, for example, in one of two ways: (1) as a unified aggregate data stream containing interleaved events from connected players, or (2) as separate parallel data streams that are individually captured and later synchronized. The logger 112 is designed to process both configurations, enabling the capture of performance data regardless of how many media players are connected or how the data is structured on the network. This flexibility ensures that the system can accurately record performances from simple two-deck setups to complex multi-player configurations used in professional DJ environments. Whether the performance data is received as a single consolidated network stream or as multiple discrete channels, the message parser 124 processes and synchronize events to create a complete chronological representation of the DJ performance across all decks.

To enable combined logging of the metadata from the DJ media players 106 and the standard MIDI data from the mixer 108, the digital audio environment 102 includes a logger 112 that provides multi-component logging architecture, including the following components:

### DJ Media Player Receiver 114

A software-based DJ media player receiver 114 that emulates one of the physical turntables on the DJ network. The DJ media player receiver 114 intercepts event data of the DJ networking protocol (e.g., event data 116 and event data 118), which constitutes the metadata being streamed from and between the hardware DJ media players 106 so that the metadata can be accessed. For example, the event data may contain detailed metadata generated by the DJ media players 106 during the live performance, including:
Waveform data
Beatgrid—Quantized beat locations
Hot cues—User-defined cue points
Playback position
BPM-Tempo in beats per minute
Beat count-Total beats elapsed
Phase-Position relative to the beat
Play/Pause status
Cue points-Timestamps
Loops-Start/end points and repetitions
Effects parameters
Track metadata-Title, artist, etc.

### Midi Receiver

A MIDI receiver 112020 receives the MIDI data being output from the mixer 108 over the direct USB connection (or a wired or wireless connection). The MIDI receiver 120 logs and stores MIDI messages 122 generated by the mixer 108 representing adjustments by DJs using the DJ media players 106 made during performances. The MIDI messages 122 being output by the mixer 108 may contain the following types of information:
Continuous controller data representing the physical positions/adjustments of knobs, faders, and other components on the mixer interface during the live performance. This data may include:
   Channel volume fader levels
   Equalizer knob settings
   Filter knob positions
   Crossfader position
   Headphone cue mix levels
   Effects parameter adjustments
Button presses and switch toggles corresponding to various controls on the mixer 108, such as:
   Channel on/off status
   Headphone cue activation
   Effect enable/disable
   Tap tempo button presses
   Transport controls like play, stop, etc.
Program change messages indicating the selection of different mixer presets/configurations
Pitch bend messages representing manipulation of the jog wheel
Transport-related MIDI messages for start, stop, continue, etc.
MIDI beat clock information based on the tempo/BPM of tracks
MIDI time code messages representing elapsed time

### Message Parser 124

A message parser 124 ingests both the metadata stream captured by the DJ media player receiver 114 and the MIDI event stream logged by the MIDI receiver 120. The message parser 124 synchronizes the timing of the two streams chronologically based on timestamping each outgoing data packet. For example, the message parser 124 receives two separate data streams—the DJ metadata captured by the virtual DJ media player 106, and the MIDI messages 122 output from the mixer 108.

To interleave these streams into a unified chronological timeline, the message parser 124 may rely on precise timestamping of the data. Specifically, each outgoing packet of metadata or MIDI message is marked with a high-resolution timestamp indicating when it was generated and transmitted. This timestamping is handled at the source by the virtual media player and MIDI receiver components. The message parser 124 then resequences the incoming data packets based on these timestamps. Packets are sorted and interleaved chronologically into a combined stream based on their timestamp order. This allows accurate aligning of the metadata and MIDI streams even though they originate from separate sources. The message parser 124 can interleave a MIDI volume fader adjustment at the correct moment between metadata packets signaling a cue point trigger and loop start.

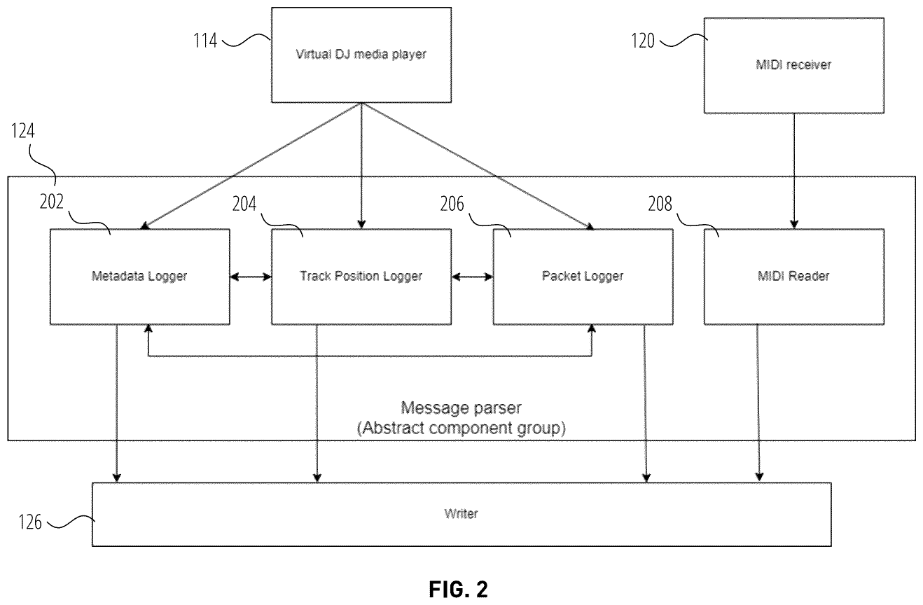

To facilitate precise alignment, the timestamping resolution may be fine-grained-on the order of 1 millisecond. This allows differentiating packet timing within tiny fractions of a second. Additionally, the message parser 124 may be implemented to minimize latency and buffering throughout the pipeline. This reduces any lag between timestamping a packet and processing it in the parser to ensure accurate chronological sequencing. By leveraging high-resolution timestamping and low-latency delivery, the message parser 124 is able to seamlessly synchronize and merge the data streams into a singular combined recording of the performance. The message parser 124 also processes the metadata and MIDI streams into a normalized structured data format for downstream handling. Further details regarding the message parser 124 are provided below with reference to FIG. 2.

### Writer 126

A writer 126 consumes events from other components such as the DJ media player receiver 114, the MIDI receiver 120, and the message parser 124. The writer 126 operates to enrich the event data with metadata (e.g., timestamps) and write events in a unified structure to the recording file 128.

The writer 126 may not buffer events-they are written in FIFO order to the recording file 128 as soon as they are processed. This may help ensure data is not lost in case of an unexpected system crash or reboot.

The raw recording file 128 produced by the writer 126 contains the combined data streams without substantial modifications. The recording file 128 thus constitutes a log of a complete performance by storing granular metadata from the DJ media players 106 via the DJ network protocol along with the MIDI messages representing physical adjustments on the mixer 108.

This raw performance data is later processed by a postprocessor 1300 to repair anomalies and prepare the file for conversion into an editable format.

### Splitter 132 and Postprocessor 130

A splitter 132 executes a postprocessor 130 which operates to convert the raw recording file 128 captured during the DJ performance into a postprocessed recording file 134. For example, the postprocessor 130 analyzes the original recording file 128 which contains an unprocessed log of data streamed from the DJ system 104 during the performance. This raw recording file 128 includes metadata packets from the DJ media players 106 on the LAN, as well as the MIDI messages 122s representing mixer adjustments.

The splitter 132 applies specialized audio domain knowledge data and algorithms to interpret this raw recording file 128. For example, it may infer probable cue points based on track metadata and snap imprecise loop points to the closest beat grid position.

Other techniques may be implemented to process the low-level equipment data streams based on assumptions of common DJ behavior and workflows. This allows for generating a cleaner postprocessed recording file 134 with added semantic information that is optimized for DJ editing software.

Further details for a postprocessor 130, according to some examples, are now provided. The logger approach used to record data may not be 100% accurate and correct. Polling, network instability, component race conditions, wrong parsing logic, or indeterministic behavior of the hardware can cause incorrect data. The purpose of postprocessing of the recording files 128 by the postprocessor 130 is to repair and prepare files for the conversion. Some specific example postprocessing operations performed by the postprocessor 130 may include:

File repair: Lines and events are read from the recording file by the postprocessor 130. Incomplete lines and duplicates are removed from the file. Complete and valid events are stored for further processing.

Event repair: Even incomplete events are being filtered out by File repair; there are events that contain incorrect data. Event repair tries to identify wrong data by tracking events before and after and detecting sequence anomalies that are unlikely to happen in practice. The combination of MIDI (mixer) and DJ media player data is being used to identify an anomaly.

To achieve improved accuracy of the recording Event repair applies a series of algorithms which:
Modify timing
Reorder events
Add/Remove/Modify events
Modify track positions

Because of the limited time processing requirement of the logger 112, there may be a minimal amount of processing during recording. It does not format the data properly for advanced loops (e.g. series of different duration loops, jumps between the loops, jumps inside and outside of the loop). Event repair algorithms detect those advanced loop events and convert a series of events to the correct representation of the actual recording.

Detecting the initial toggle button and slider states that were set before the recording started is not reported to the network. For some of the parameters, Event repair detects the initial state based on the later usage of the parameters.

MIDI matching: Each MIDI message that comes from a mixer 108 has an identifier. Each mixer model maps this identifier to the specific physical parameter on the mixer, written in the MIDI table documentation provided by the device manufacturer. The MIDI table for every supported device is stored to be accessible by the postprocessor 130. By detecting the mixer model, which is written in the recorder, the postprocessor 130 maps the MIDI identifier to the MIDI physical parameter.

Channel matching: After MIDI matching, MIDI values for every channel are known. The information about which DJ media player 106 is connected to which channel is not published on the network. For this reason, the postprocessor 130 includes an algorithm that attempts to detect channel and DJ media player connection based on the usage of the devices. The algorithm looks for parameters that affect the channel (e.g. volume faders, equalizers, etc.) in the first and last quarters of the track played. The logic behind it relies on the premise that volume should increase at the beginning and decrease at the end of a track. The algorithm counts the volume increases and decreases for every channel. The most counted matches per channel are seen as most probable and chosen for later processing.

Play start marking: The logger 112 records every action on the mixer 108 and DJ media players 106. There are parts of the track before it goes “on air”, where the DJ tries to find the best position to play the track on the master output. Also, there were tracks that may not have been played on the master output, but only in the DJ's headphones. The postprocessor 130 goes over the events to identify the point in time when the DJ played the track that went to the master output. The part before that point, which represents the DJ's search for the position to start, should be discarded. To achieve that, this algorithm of the postprocessor 130 looks for the PLAY events after which there were no rewinds or fast-forwards and the volume was up (MIDI value above 31) before the track was stopped.

The output of the postprocessor 130 is the enriched postprocessed recording file 134 which includes data for the conversion. The postprocessed recording file 134 is in the same format as the original input recording file 128.

### Splitter 132—Splitting 136

In addition to operations performed by the postprocessor 130, the splitter 132 also handles the dividing or splitting 136 of the recording for multi-DJ performances. The splitter 132 analyzes the postprocessed recording file 134 to identify transitions between DJs within the set.

In some examples, this may include examining factors such as detecting when a new USB drive is connected to load tracks, changes in mixing style, and other signals that a new DJ has begun playing on the DJ system 104. The splitter 132 thus contains algorithms to parse the recording and isolate each DJ's contribution. Examples of these algorithms may include:
Detecting when new media, such as a USB drive, is connected to load tracks from a different DJ's library. The splitter 132 may look for new track IDs and metadata indicating a switch.
Analyzing mixing techniques and style between segments-changes in habits like EQing, effects, looping, etc. can signal a DJ changeover. The splitter 132 may use machine learning models trained on DJ habits to classify style.
Examining volume levels on mixer channels-crossfading between channels indicates one DJ handing off to another. The splitter 132 may check for patterns in relative channel volumes.
Considering timing and gaps between tracks-large silent periods suggest a DJ switch rather than just a track transition. The splitter 132 may look for anomalous gaps.
Accounting for back-to-back DJs playing together on separate media players rather than a straightforward handoff. The splitter 132 may handle case where two DJs perform together.
Checking for other transition markers like audio announcements of the next DJ's name or stage banter indicating a changeover. The splitter 132 may use speech recognition and natural language processing to detect clues.
Factoring in known event schedules-if the performance lineup is available, this provides additional context for likely DJ transition points.

The splitter 132 then enacts splitting 136 to carve the postprocessed recording file 134 into discrete postprocessed files 138 representing each individual DJ set. This allows the DJs to easily access their own portion for editing and post-production.

In summary, the splitter 132 may execute two roles-postprocessing by the postprocessor 130 to optimize the raw recording file 128 and splitting 136 to divide it into per-DJ files 138.

### Converter 140

A converter 140 executes the final stage of processing on the split recording files 138 to generate a standardized digital audio workstation (DAW) file format suitable for post-production. Specifically, it outputs a DAW set file 142 such as a DAW project file (.set) based on the postprocessed recording files 134.

The DAW set file 142 is a file in JSON format containing information for a DAW application 144 to replicate the recorded DJ performance. It includes metadata like project name, file path, initial tempo, software version, UI settings, tracks played, effects applied, automation lane points, etc. The converter 140 initially populates general project file data based on the postprocessed recording file 134 input.

The converter 140 creates track objects for every track played, including the effects applied to each track by the DJ. To assemble a track object, the converter 140 analyzes the playback events for that track—such as jumps, rewinds, loops, play/pause, etc.—to segment the track into clips representing continuous playback sections. Metadata like time, position, and duration is attached to each clip object. For accurate loop timing, a separate loop processing algorithm compares the recorded loop data against expected intervals to estimate proper start/end points.

The converter 140 also creates processor objects to represent effects and mix adjustments applied to each track. This is achieved by filtering the input event data to isolate mixer-related messages and then mapping the MIDI control data to specific parameters based on the mixer model. Recorded values are normalized from the MIDI range (e.g., 0-127) to the parameter ranges defined in the target DAW application 144.

Finally, tempo changes initiated on the “master” player are converted into global tempo objects, aligned to the session timeline. Beat sync ensures changes propagate across all tracks.

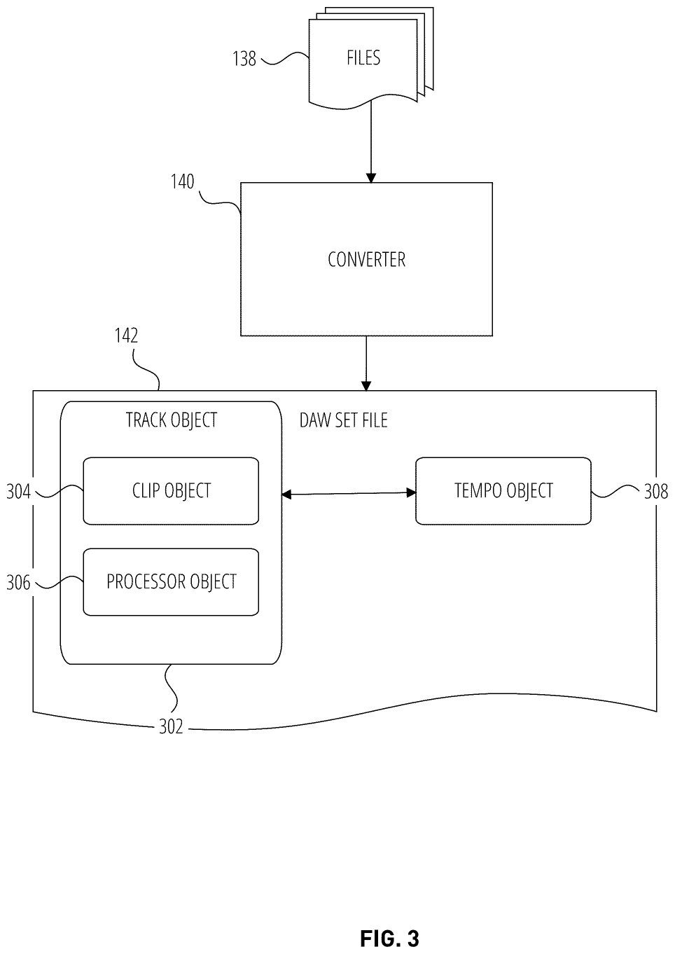

Clip, processor, and tempo objects are temporally aligned and assembled into a unified session timeline that replicates the complete DJ mix. This rendered DAW set file 142 represents the raw performance data transformed into an editable musical project file that can be loaded into a DAW application 144 for further manipulation and refinement. Further details regarding the converter 140, according to some examples, are provided below with reference to FIG. 3

### Daw Application 144

The DAW set file 142, together with audio files 148, are loaded into the DAW application 144. The DAW application 144 operates using both the DAW set file 142 and audio files 148 in tandem to recreate the recorded DJ performance.

Specifically, the DAW set file 142 contains detailed metadata representing all the transitions, effects, loops, cue points, and automation from the original performance. This metadata assembles the arrangement of tracks and processing. The audio files 148 contain the actual waveform recordings for each track played during the set.

By loading the DAW set file 142 and linking its metadata to the audio files 148 waveforms, the DAW application 144 is able to reconstruct the full DJ mix. The DAW set file 142 provides the sequencing, processing, and synchronization data so that the audio file 148 waveforms can be reassembled properly with effects and transitions matching the originally recorded performance.

This dual file approach allows separating the bulky audio waveform data into audio files 148 distinct from the lightweight metadata in the DAW set file 142. This is beneficial for performance and flexibility. For example, the DJ can freely edit the metadata in the DAW set file 142 to modify arrangements without needing to render full audio every time. And alternate audio files 148 can be substituted or updated without disrupting metadata. Thus, the dual documents provide an efficient environment for DJ mix editing and refinement.

The described examples thus provide a process of combining the two distinct data streams—DJ player data and MIDI data—into a cohesive set within the DAW application 144. This combination alone, however, does not encapsulate the full DJ performance. The recreation of the DJ set is the integration of a third key data source: the audio files 148. These audio files 148 contain the actual waveform recordings of each track played during the set and are needed for accurately reconstructing the performance.

When the DAW set file 142, which houses the meticulously synchronized metadata, is loaded alongside the audio files 148 into the DAW application 144, a true representation of the DJ set comes to life. The metadata from the DAW set file 142 aligns with the waveforms from the audio files 148, allowing for a reassembly of the original mix with all its nuances-transitions, effects, loops, cue points, and automation intact.

This triad of data-DJ player data, MIDI data, and audio files-enables the system's capability to recreate the DJ set with fidelity.

### Summary of Architecture

The multi-component architecture enables combined logging of DJ equipment data streams to create an integrated recording of the complete performance. The generated raw recording file provides a detailed low-level representation of the DJ's actions that facilitates downstream conversion and editing.

The logger 112, splitter 132, and converter 140 may be implemented in a variety of architectural configurations. For example, the functionality may be deployed on optimized hardware for maximum performance. In some examples, the logger, splitter, and converter may be hosted on a dedicated device or appliance with onboard computing resources. The appliance may contain an embedded processor, storage, and wired network interfaces to connect with the DJ system 104. By running on specialized hardware, this provides an optimized environment for ingesting the metadata and MIDI streams and executing the processing algorithms. The appliance may be an external computer system 146 for loading into a DAW application 144. Offloading the data capture and processing onto dedicated hardware avoids taxing the resources of other devices.

### Integration in DJ Media Players 106

In some examples, the functionality of logging and processing can be integrated directly into the DJ media players 106. Enhancements to the firmware of the DJ media player 106 may include versions of the logger, splitter, and converter modules that are tailored to the existing computational capabilities of the media players. These modules operate may operate in software form and can store data locally, which allows for the immediate capture and processing of performance metadata without the need for additional external hardware components. The DJ media player 106 may then facilitate the direct export of the finalized DAW set file 142 through a USB connection, enabling swift import into editing software for post-production work. This method of distributing the processing workload across individual DJ media players 106 offers an approach to handling data that reduces or eliminates the reliance on a centralized processing unit or appliance.

In such configuration, DJ media players 106 are equipped with built-in capabilities to handle data management tasks typically performed by external systems. This includes the collection and organization of performance-related information.

The DJ media players 106 may be enhanced with embedded software modules that perform specific functions. The logger module captures performance data, the splitter module segments the data for individual processing, and the converter module transforms the data into a format suitable for editing applications.

Some specific examples of the integrated software modules within the DJ media players 106 may include a logger module that timestamps and records each action taken by the DJ, such as track selection and effect application. The splitter module may analyze the recorded data to identify distinct sections of the performance, such as individual tracks or transitions, and separate them into discrete units for further processing. The converter module may then take these units and reformat them into a standardized file type, like a DAW set file 142, which retains the structural integrity of the performance while allowing for additional modifications and enhancements in a DAW environment. This file can include metadata such as track names, timestamps, beat grid information, and applied effects, formatted to be compatible with a range of DAW applications without the need for external software or hardware.

### Integration in DAW Application 144

Further, in some examples, integrating the logging and processing directly into the DAW application 144 itself is another potential configuration. The DAW application 144 may implement internal modules to capture the external DJ streams and transform the data into the postprocessed DAW set file 142 format natively. This enables a completely integrated experience on the computer system 146. The user simply connects the DJ system 104 to the computer running the DAW application 144 which then handles logging and conversion, loading the resulting DAW set file 142 into the DAW project. By leveraging the existing audio editing environment of the DAW application 144, this allows full integration with no external hardware required.

### Integration in DJ Applications

In some examples, and as noted above, the DJ system 104 comprising the DJ media players 106 and mixer 108 may be implemented entirely in software. In this scenario, the DJ media players 106 and mixer 108 are virtual DJ applications running locally on a computer system 146 rather than physical hardware units.

The DJ software applications provide simulated DJ media player and mixing interfaces that DJs can perform with using physical controllers mapped to the on-screen controls. In such examples, the mixer 108 software also outputs MIDI data representing adjustments made during the performance. To log and process data from this software-based DJ system 104, the logger 112, splitter 132, and converter 140 may be implemented together in a unified DJ recording software package. This package runs locally on the computer system 146 alongside the DJ software.

The logger 112 in the recording software taps into the internals of the DJ applications to intercept the software event data and MIDI messages in real-time. It chronologically synchronizes the data streams and stores the raw combined recording file 128. The splitter 132 then executes its postprocessor 130 algorithms on this data to optimize it and split it into the per-DJ files 138. Finally, the converter 140 transforms these splits into the final DAW set file 142.

This unified recording software package provides integrated logging and processing, specifically tailored for software-based DJ systems 104. It leverages the local computing resources to ingest data from the DJ software internally and generate edit-ready DAW set file 142. With both the DJ system 104 and recording pipeline implemented in software, this configuration provides a fully virtualized environment without the need for any external hardware. The unified recording software seamlessly bridges the DJ software and DAW environments to enable logging and post-production.

It should also be noted that the example digital audio environment 102 is described with DJ media players 106 and a mixer 108 that are interconnected via a local area network (LAN) to facilitate the exchange of performance data. However, in some examples, software-based systems emulate the functionality of traditional DJ hardware may be used. In such examples, DJ software applications may replicate the capabilities of DJ media players and mixers within a single, integrated software environment.

In the examples of DJ software, the concept of an interconnected network is internalized within the software itself, rather than existing as a separate, external network. Consequently, the software may provide a means to expose the internal state and performance data to external systems. This may be achieved through the implementation of an Application Programming Interface (API) or a specialized network protocol designed for this purpose. The API or protocol may allow external systems, such as the digital audio environment 102, to tap into the software's internal data streams, capturing the same detailed information as would be obtained from physical hardware over a LAN.

For the mixer component, when implemented in software, the virtual mixer's adjustments and manipulations may be captured internally within the DJ software. To log this data, the software mixer may be designed to record its state changes and output them in a format that can be accessed by the logging system. This may involve the software mixer generating MIDI-like messages or other control signals that represent the virtual knob adjustments, fader movements, and button presses, which are then made available to the external logging system via the aforementioned API or protocol.

In some examples, the logger, splitter, and converter logic may also be implemented in a cross-platform software application for various host operating systems. Running locally on the computer system 146 alongside the DAW application 144, this software app may be configured to connect to the DJ system 104 to ingest the data streams. It logs and processes the data internally on the computer system 146, taking advantage of its native resources. The output DAW set file 142 may automatically be imported into the DAW application 144 on the same machine computer system 146 for a seamless handoff. This approach may provide flexible software-based processing that can be installed on any compatible computer system 146 equipped with the DAW application 144.

In some examples, the mixer's output could be captured via any suitable control data interface or communication interface or protocol (MIDI being a common standard, but not the only option). For instance, the mixer could transmit control data over USB using HID (Human Interface Device) protocol, over network connections using OSC (Open Sound Control), through proprietary protocols specific to certain manufacturers, or via any other digital communication method capable of conveying mixer state information. The logger 112 and message parser 124 are designed to be protocol-agnostic, capable of receiving, interpreting, and synchronizing control data regardless of the specific protocol used to transmit it from the mixer 108 to the computing system 146.

### Message Parser Architecture

FIG. 2 is a block diagram illustrating an architecture of the message parser 124, according to some examples.

The message parser 124 represents a logical grouping of several sub-components that collectively aggregate, synchronize and process the raw data streams from the DJ equipment.

As noted above, the DJ media player receiver 114 joins the LAN network 110 and listens for state updates and metadata broadcasts from the deck units. It parses this raw data and passes extracted event information to the message parser 124. The MIDI receiver 120 connects via USB to the DJ mixer and logs the real-time MIDI protocol messages representing physical adjustments like slider positions and button presses. This discrete performance data is forwarded to the message parser 124.

The message parser 124 represents a logical grouping of several sub-components that collectively aggregate, synchronize and process the raw data streams from the DJ equipment. The subcomponents may include:

Metadata logger 202: The metadata logger 202 continuously listens for track metadata provided by the DJ media player receiver 114 to discover track changes. Track metadata is continuously queried in a short time interval for DJ media players 106 on the network. If track metadata is different than the last reported for the DJ media player, the metadata logger 202 concludes the track change and passes the event to the writer 126 to persist the event.

In addition, the metadata logger 202 listens to media (USB stick, SD card) mounts/unmounts and passes the events to the writer 126 for persistence.

The last recorded track metadata per DJ media player is stored in the component and available for other components to get information about the track.

Track metadata available to other components may include:
Track title, artist, album, duration, tempo, bitrate
Device number of DJ media player the track is being played on
Device number of DJ media player the media is being mounted to
Saved cues and loops (hot cues, hot loops)

Track position logger 204: The track position logger 204 continuously listens for track position update messages provided by the DJ media player receiver 114 to discover current track position, tempo, and master assignment changes. The last received track position information is cached so other components can query it. For the sake of synchronization, the writer 126 uses this information and adds it to every event that's being persisted.

By listening to the track position included in the track position update messages, the track position logger 204 detects significant changes and identifies the type of the jump (e.g. Rewind, Fast-Forward, Hot Cue/Loop jump . . . ) which is passed to the writer 126 to persist the event.

Every track position update message contains BPM and MASTER information, which is used by the track position logger 204 to detect tempo and master assignment changes from the previously received message for the device and report it to the writer 126 for persistence.

In addition, track position logger 204 continuously listens to device announcements to detect and report devices that are connected to or disconnected from the network.

Packet logger 206: The packet logger 206 continuously listens for device update messages provided by the DJ media player receiver 114 to discover the current state of the DJ media players 106 on the network. By parsing messages, the packet logger 206 detects states of interest for the conversion such as for example:
1. Player is playing
2. Player is paused
3. Player is stopped at the end of the track
4. Player is in a loop
5. Track is loading
6. No tracks are loaded
7. Cue play

Based on these states, the packet logger 206 creates events and passes them to the writer 126 for persistence.

MIDI reader 208: The MIDI reader 208 listens (e.g., on the USB interface) for MIDI messages sent from the DJ mixer 108 representing knob tweaks, slider adjustments, button presses, etc. It enriches these events with additional metadata like track timing and master deck context. The MIDI events are then forwarded to the writer 126 for storage.

### Converter 140

FIG. 3 is a block diagram representation of a converter 140 and a generated DAW set file 142, according to some examples. As noted above, the converter 140 executes a stage of processing the split recording files 138 to generate a standardized digital audio workstation (DAW) file format format—for example, the DAW set file 142.

This DAW set file 142 can then be loaded into a DAW application 144 for editing and post-production. The DAW application 144 refers to the digital audio workstation program that runs on a computer system 146, providing tools to edit, mix, and manipulate audio recordings.

The converter 140 analyzes the split recording files 138 which at this stage may represent isolated sets for each DJ. The converter 140 may contain logic and algorithms to interpret the low-level control messages and infer the actual intended musical performance. Example techniques may include:
Aligning track playback events to a quantized beat grid based on BPM analysis.
Estimating loop start/end points and cue locations based on timing data.
Applying domain knowledge of DJ mixing practices to reconstruct transitions.
Mapping MIDI controller data to corresponding effects parameters and mix adjustments.
Synthesizing a stereo master mixdown based on channel/crossfader levels.
Assembling a unified timeline of tracks, transitions, loops, and other elements representing the full DJ set.

By running the split recording files 138 through these algorithms, the converter 140 is able to produce a rendered DAW set file 142. This file represents a complete DJ mix reconstructed from the raw equipment data in a format that a DAW application 144 can open, edit, and manipulate.

The converter 140 thus provides the final stage of processing to transform the captured performance data into a musical edit-ready DAW set file 142 for loading into DAW application 144 executing on a computer system 146. Its algorithms leverage domain expertise to infer the actual intended DJ mix from the low-level control data. This enables practical post-production of recorded DJ sets.

Further details regarding the converter 140, according to some examples, are now provided. As noted above, the converter 140 outputs the DAW set file 142 (e.g., a DAW project file (.set)) based on the postprocessed recording files 134 (e.g., a postprocessed recording file (.rec)).

In some examples, where the event data 116 and 118 are sufficiently enriched and accurate, the role of the converter 140 in inferring and reconstructing the DJ's intended musical performance may be significantly reduced or even rendered unnecessary. Enrichment of the event data streams may involve the implementation of advanced data capture techniques within the DJ media players and mixers themselves. These techniques might include high-resolution timestamping, precise beat mapping, and direct recording of user actions in a structured format that closely aligns with the requirements of the DAW application 144.

For instance, the DJ media players may be equipped with sensors and software capable of capturing not only the timing of track playback events but also the exact positions of loops and cue points relative to a quantized beat grid. Similarly, the mixer could generate detailed control messages that directly correspond to the effects parameters and mix adjustments within the DAW environment, eliminating the need for additional interpretation by the converter.

By integrating such advanced data capture capabilities, the event data streams may provide a near-complete digital representation of the DJ set, with minimal gaps or ambiguities. This would allow for a direct import of the enriched event data into the DAW application 144, bypassing the need for the converter's inferential algorithms. The DAW application may then utilize this enriched data to recreate the DJ mix with high fidelity, leveraging the precise and comprehensive nature of the captured performance data.

In these examples, where the converter may be omitted, the system architecture would be simplified, and the efficiency of the post-production process would be enhanced. The DAW application would become the primary platform for fine-tuning or editing, supported by the high-quality data provided directly from the DJ equipment.

### Project File (e.g., DAW Set File 142)

The DAW set file 142 is a file in JSON format containing information needed for the DAW application 144 to replicate the recording. It contains various data like project name, file path, initial tempo, software version, UI settings, tracks played, effects applied, automation lane points, etc. The converter 140 initially fills the general project file data based on the postprocessed recording file 134. Logic of the converter 140 executes to create track objects 302 for every track is the files 138 that was played including the effects applied.

Track objects 302: To create track objects 302, the converter 140 takes the events from the previously marked play start points (by the postprocessor 130) until the pause/stop of the track. It may take into account only events related to that track and events that are global and applied to all tracks. The selection is done by filtering channel events while relying on the channel matching, previously done by the postprocessor 130. A track object 302 contains clip objects 304 and processor objects 306, where clip objects 304 represent parts of the track that were played without a jump and processor objects 306 represent effects that were applied to the track (e.g. volume, equalizers, sound color effects, beat effects, etc.).

Clip objects 304: In order to create clip objects 304, the converter 140 goes through DJ media player events from the DJ media player 106 the track was played on. The events that are taken into account for clip creation are the events that affect track positioning (e.g., jumps, rewinds, fast-forwards, loops), playing or pausing the track, switching the track, etc. For example, the converter 140 starts from the “PLAY” event, looking for the next event of interest. When the “HOT CUE” (represents a jump from the current track position) event is found, the converter 140 creates a clip object 304 that starts with the track position from the “PLAY” event and ends at the track position before the jump of the “HOT CUE” event. The beginning of the next clip is the track position after the jump of the “HOT CUE” event. The converter 140 then searches for the next event to find the end of the clip. This is done until the track is stopped or paused. As every recorded event contains the last recorded position of other DJ media players 106, this information is used to synchronize the positioning and timing of the clip related to other track clips. Clip objects 304 contain information like time, position, duration, loop setting, etc. For the sake of improved accuracy, loop clip creation has another layer of processing in the converter 140.

Loop clips: An accurate positioning of the looped track segments is useful for the output. Because of the frequent jumps and track position changes, the recorded jump position inside a loop can be late depending on the model of the DJ media player. Relying only on the recorded jump positions leads to inaccurate loop segment duration. To improve the accuracy, the converter 140 tries to calculate the most likely start and end position of a loop segment. It is done by counting jumps between the interval in which the DJ media player was in a loop and comparing it to that time interval and recorded jump positions. If the loop segment duration difference between the calculated and recorded data is significant, the calculated one is used.

Processor objects 306: In order to add effects that were applied using the mixer 108, the converter 140 creates processor objects 306 for each track. Every processor object 306 contains an identifier for identification of the effect that was used (e.g., Reverb, Equalizer, etc.) and all the points in time when the recorded values were changed containing time, value, and track position.

Every processor object 306 is created by filtering the track events related to a specific processor. Processor events originally came as MIDI messages, their values are between 0-127 (the value range of a MIDI message). The value range of most parameters on the mixer is not in this range, so the values have to be normalized to the correct range. The DAW application 144 defines different ranges for different effects and parameters. Based on the ranges defined by the DAW application 144, the converter 140 normalizes each event value before creating a processor object 306.

Because different mixer models have different features, each processor object 306 parses events depending on the mixer model that was used. As processor objects 306 and clip objects 304 use the same global time (e.g., time elapsed from the beginning of the set) and track positions in the same format, this data is intended to be used for synchronization and visualization in the DAW application 144.

Clip objects 304 and processor objects 306 are stored in the track object 302.

Tempo objects 308: DJ media players 106 have a “beat sync” feature, which adjusts the tempo of playing tracks to the tempo of a “master” DJ media player 106. To support this feature, tempo data in the DAW application 144 is designed to be global (e.g., related to multiple tracks). The format of tempo objects 308 is the same as the processor objects 306 but because a tempo object 308 can be related to multiple tracks, a tempo object 308 is not placed inside of a track object 302. The converter 140 filters the events based on the “master” player and creates tempo objects 308 containing value and time from the beginning of the set. Tempo objects 308 are used in the DAW application 144 to apply tempo to tracks in the set.

After clip, processor and tempo objects are processed for all tracks, the data is written to the project file (.set), namely the DAW set file 142. The DAW set file 142 represents the final version of the recording in a format that is DAW readable by the DAW application 144.

### Architecture of DAW Application 144

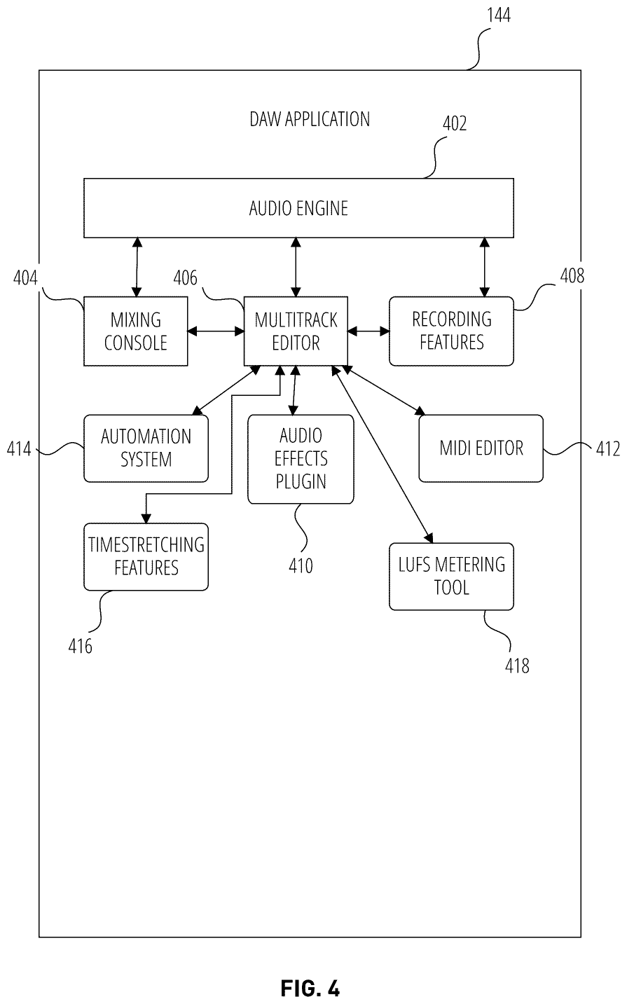

FIG. 4 is a block diagram illustrating the architecture of the DAW application 144, according to some examples. The DAW application 144 provides a professional music production environment integrating a wide range of audio editing, processing, and mixing capabilities.

At the core of the DAW application 144 is a high-performance audio engine 402 optimized for multi-track mixing and real-time monitoring. Built on efficient digital signal processing (DSP) routines, the audio engine 402 renders audio playback while maintaining minimal latency. This enables users to monitor recordings or mixes with tightly synchronized effects processing and zero delay compensation. The audio engine 402 interfaces directly with the sound drivers for pristine multi-channel audio input and output of the computer system 146.

Connecting to the backend audio engine 402, the DAW application 144 provides a flexible mixing console 404. Each track in the project is represented as a channel strip with controls for volume, panning, inserts, sends, solo/mute, and more. Multiple tracks can be grouped together for unified control of their parameters. The mixing console 404 allows users to finely tune the blend and dynamics of the mix in an intuitive graphical layout. Adjustments to the mixing console 404 are mapped under the hood to parameter controls in the audio engine 402.

At the center of the user experience is a multitrack editor 406 that displays the arrangement of audio clips on multiple lanes corresponding to tracks. Clips can be edited through operations like cut, copy, paste, split, trim, time-stretch, and more in a non-destructive workflow. The multitrack editor 406 enables arranging audio clips in a timeline to build up a complete song or production. Extensive tools are provided for precision editing of clip boundaries and fades.

Recording features 408 allow capturing external audio from sources like microphones, instruments, mixers, and other inputs. The user can configure input sources, take management, and monitoring options for recording sessions. Captured recordings are automatically added to tracks in the multitrack editor 406 for further refinement.

The DAW application 144 may include a wide selection of native audio effects plugins audio effects plugins 410 that provide professional-grade processing like equalization, compression, reverberation, delay, distortion, modulation, and more. Users can insert effects chains into tracks that will be processed in real-time by the audio engine 402 during playback for the highest quality. Automation curves allow effects parameters to be dynamically adjusted over the timeline.

Going beyond audio, the DAW application 144 includes a MIDI editor 412 for working with virtual instruments and external MIDI gear. Piano-roll editing, step sequencing, score notation, and MIDI mapping allow crafting MIDI parts and automation. MIDI data can be converted to or from audio clips as needed.

Automation system 414 enables recording and drawing envelope curves to control volume, panning, effects, and other track parameters over time. This allows mixes to evolve dynamically rather than remaining static.

Timestretching features 416 enable lengthening or shortening the duration of audio clips without affecting their pitch or introducing artifacts. This supports tempo-matched audio editing and creative remixing. The audio engine 402 implements efficient phase-coherent timestretching algorithms.

The DAW application 144 includes an integrated loudness monitoring tool, in the example form of a LUFS metering tool 418, that enables real-time analysis and visualization of perceived loudness levels during audio playback and editing.

The LUFS metering tool 418 performs intelligent analysis of an audio signal to determine measurements of loudness over time according to the LUFS standard. LUFS stands for Loudness Units relative to Full Scale and is a standard for measuring perceived loudness based on the sensitivity of human hearing.

Specifically, the LUFS metering tool 418 analyzes the spectral content in multiple frequency bands across the audible spectrum, including low, mid, and high-frequency regions. It computes time-varying loudness values in each band that reflect how loud those frequencies are perceived. The determined multi-band loudness data is visualized through a multi-channel graphical meter displayed directly within a timeline view presented by the multitrack editor 406 of the DAW application 144. The LUFS metering tool 418 comprises separate channels for the low, mid, and high frequency loudness values. Position indicators within each channel represent the loudness measurements over time throughout the audio track.

As the audio editor scrolls and plays back the track, the LUFS metering tool 418 scrolls in precise synchronization, providing a dynamic real-time view of loudness fluctuations. This tight integration of loudness visualization within the existing DAW environment avoids disrupting workflow or needing external analysis software.

The editor can monitor the live LUFS feedback to identify and correct loudness issues in the mix. For example, insufficient levels in the low-frequency band during a bass drop or excessive peaks distorting the mid band. Optimizing loudness balance across the frequency spectrum results in mixes tailored for a quality listening experience.

In addition to the real-time scrolling meter, the LUFS metering tool 418 provides alternative time-based visualization modes. The editor can examine historical loudness metrics such as average levels over the full track or zoom into detailed short-term variations. Sections of the track exceeding recommended LUFS loudness targets are highlighted to pinpoint problems quickly.

The LUFS metering tool 418 may also include intelligent assistance capabilities. For example, automated suggestions to boost certain frequency regions or reduce peaks based on loudness analysis. The tool 418 integrates persistent loudness optimization into the editing workflow rather than relying on sporadic external processing. Specifically, the LUFS metering tool 418 may use machine learning techniques to train models on loudness metrics and common issues that arise during mixing. The models learn to detect suboptimal loudness balance across frequency bands and other problematic patterns. During playback and editing, the LUFS metering tool 418 may run real-time analysis of the track using these AI models. When the models identify potential deficiencies like insufficient low end or excessive mid-band peaks, the LUFS metering tool 418 may automatically generate suggested edits to improve loudness balance.

For example, the LUFS metering tool 418 may display prompts recommending +2 dB gain adjustment on the low frequency EQ to boost bass levels that are measuring too low. Or, it may suggest attenuating the 1 kHz band by −3 dB to reduce harshness from peaking mids. The editor can review and choose to accept these AI-driven suggestions or disregard them.

By continually monitoring the mix and proposing optimizations, the LUFS metering tool 418 provides ongoing immersive assistance. It integrates this persistent loudness enhancement natively into the editing workflow. The editor receives constant AI-powered support while arranging and mixing rather than having to perform sporadic external analysis.

The tool 418 may also combine its mix analysis with customizable target presets. For example, the user can define ideal LUFS loudness ranges for different genres and applications. When the track strays outside the targets, the LUFS metering tool 418 may pinpoint where alignment is needed.

The intelligent assistance and persistent loudness optimization capabilities of the LUFS metering tool 418 provide an efficient integrated workflow. The editor receives continuous AI support to remedy loudness deficiencies identified by predictive models. This tight coupling of analysis and assistance enables creating listener-optimized mixes.

The LUFS metering tool 418 enables DAW users like DJ editors to visualize and adjust perceived loudness in real-time while arranging and mixing audio tracks. The multi-band spectral analysis and tight integration with the multitrack editor 406 of the DAW application 144 provides an efficient loudness optimization workflow to create listener-focused mixes.

### Data Architecture

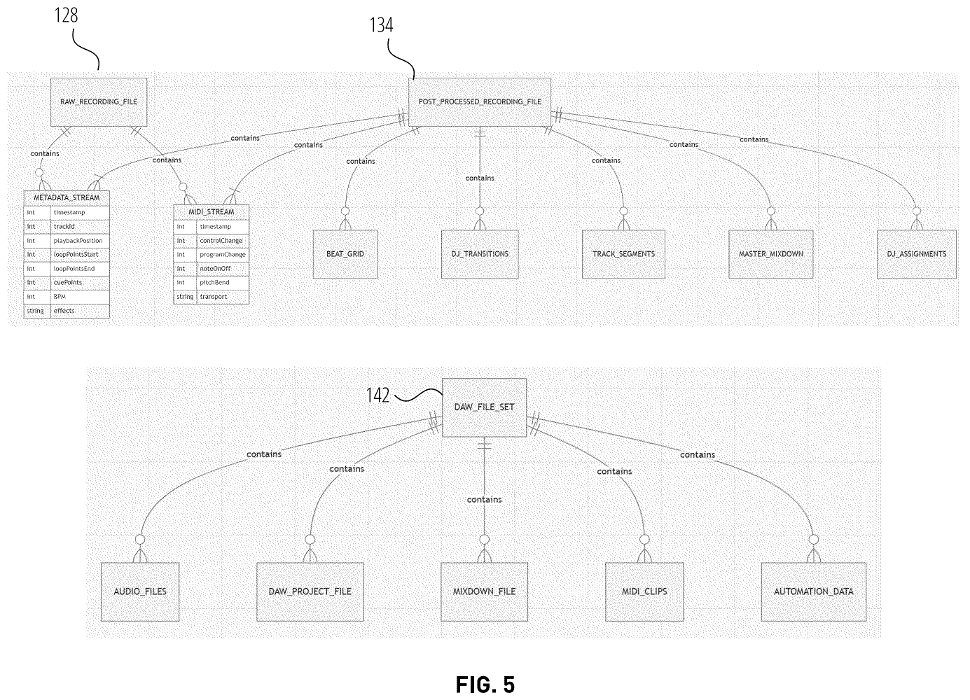

FIG. 5 is an entity relationship diagram highlighting the structure and data fields of output files, according to some examples, generated during the DJ recording pipeline, described above with reference to FIG. 1.

The raw recording file 128 may contain a log of the unmodified data streams captured from the DJ performance. It stores two core entities—the metadata event stream from the DJ media players 106, and the MIDI event stream from the mixer 108.

The metadata stream entity stores information such as:
Timestamp: The system time when each event occurred.
Track ID: Identifiers for tracks loaded on the media players
Playback position: Current playhead position
Loop points: Start and end points for looped sections
Cue points: Timestamps when cues were triggered
BPM: Detected tempo of the track
Effects: Parameters of any DJ effects applied

The MIDI stream entity stores data like:
Timestamp: Timestamps of when events were generated
Control change: Adjustments to knobs, faders, etc.
Program change: Selection of mixer presets
Note on/off: Triggering of buttons, pads, etc.
Pitch bend: Jog wheel scratch events
Transport: Play, stop, etc. events

By storing these two streams together chronologically, the raw recording file 128 provides a complete low-level representation of the performance.

Next, the postprocessed recording file 134 resulting from the splitter 132 contains cleaned-up data for DJ editing software. In addition to the metadata and MIDI contents the splitter 132 may add:
Beat grid: Quantized beat timings based on BPM analysis
DJ transitions: Markers for transitions between tracks
Track segments: Audio clip portions representing distinct sections.

Master mixdown: Simulated stereo mix based on channel levels
DJ assignments: Mapping of data to individual DJs

Finally, the DAW set file 142 generated by the converter 140 may contain the final audio assets ready for loading into a DAW, such as:
Audio files: Rendered audio clips of the individual tracks
DAW project file: Metadata representing the full timeline arrangement
Mixdown file: Master stereo mixdown audio
MIDI clips: Extracted MIDI note data
Automation data: Effects automation parameters

By transforming the raw data through multiple stages, the pipeline produces a rich DAW set file 142 for editing and post-production.

### Logger 112: Logging Performance Data

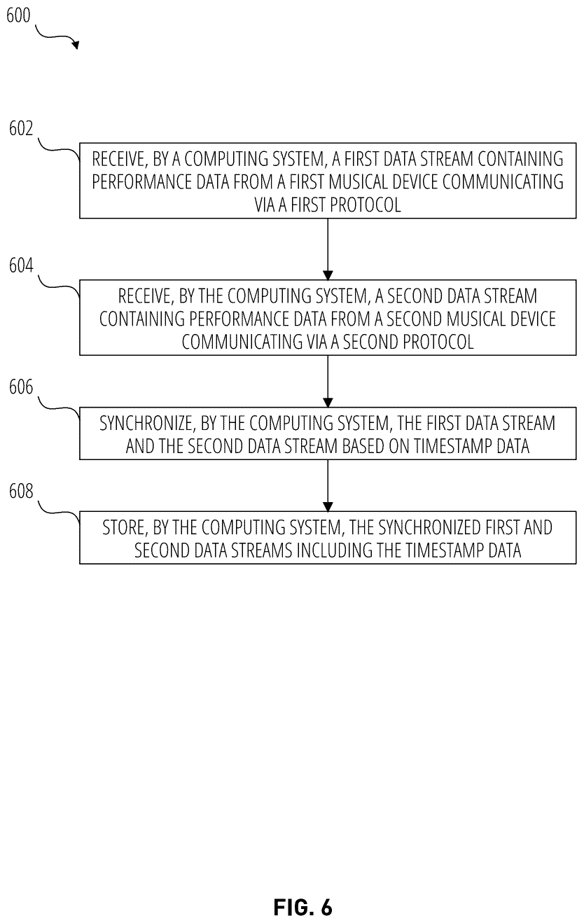

FIG. 6 is a flowchart illustrating a method 600, according to some examples, to log performance data of multiple musical instruments.

In operation 602, a computing system, in the example of the logger 112, receives a first data stream containing performance data from a first musical device communicating via a first protocol. For example, the logger 112 executes a software module acting as a DJ media player receiver 114 that joins the digital DJ equipment network 110 including the DJ media players 106 and the mixer 108. By emulating a DJ media player device on the network, the DJ media player receiver 114 is able to intercept the real-time event data stream broadcast over the network protocol. This event data stream contains detailed metadata generated by the physical DJ media players 106 connected to the network, including precise cue points, loop points, BPM, playback status, track IDs, and other performance parameters. The DJ media player receiver 114 receives this event data stream in the form of network packets and buffers the data stream for further processing.

In operation 604, the logger 112 receives a second data stream containing performance data from a second musical device communicating via a second protocol. For example, the logger 112 executes a software MIDI receiver 120 that interfaces with the hardware DJ mixer via a direct USB connection or other connection. The MIDI receiver 120 is configured to receive the MIDI data stream output from the mixer 108 over this USB link. The MIDI data stream consists of MIDI messages representing real-time adjustments made by the DJ on the mixer interface, including continuous controller data for faders, knobs, and other components as well as MIDI notes, program change messages, and transport commands. The MIDI receiver 120 buffers this incoming MIDI data stream for further processing.

In operation 606, the computing system synchronizes the first data stream and the second data stream based on timestamp data. For example, a software-based message parser 124 aggregates the buffered event data stream and MIDI data stream. The message parser 124 leverages precise timestamping applied to each data packet by the virtual DJ media player and MIDI receiver at the time of origination. By sorting the incoming data packets based on these timestamps, the message parser 124 can accurately interleave and synchronize the two or more streams into a unified chronological timeline. This seeks to address the challenge of synchronizing the separate streams from disjointed sources. The message parser 124 may also minimize latency throughout the pipeline to reduce lag between timestamping packets and processing them to ensure precise timing.

In operation 608, the computing system stores the synchronized first and second data streams including the timestamp data. For example, a software-based writer 126 persistently logs the synchronized data streams from the message parser 124 by writing the raw data to disk or other local storage without any modifications. This raw dump of the synchronized data streams represents a comprehensive digital record of the complete DJ performance including MIDI data. The writer 126 stores the data streams in their native formats along with the timestamp information that was used to synchronize them. This raw unprocessed recording can then be used for further post-processing and conversion into an editable audio file, such as the recording file 128.

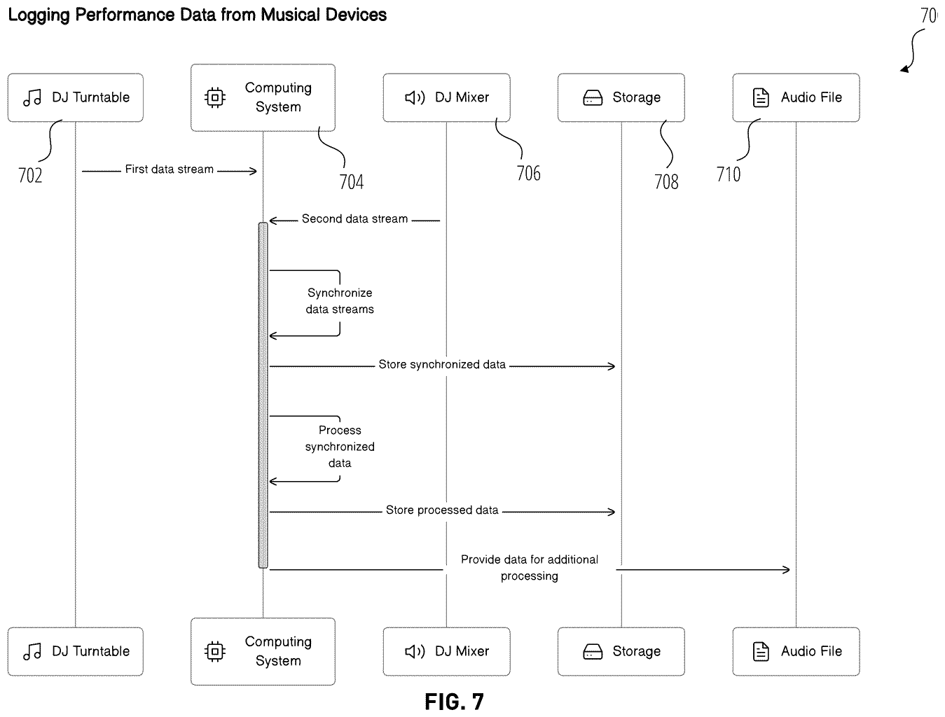

FIG. 7 is an interaction diagram illustrating a method 700, according to some examples, of logging performance data from musical devices.

While FIG. 6 presents a flowchart outlining the sequential operations for logging performance data from musical devices in a procedural format, FIG. 7 provides a complementary visual representation of these same operations as interactions between system components. This interaction diagram builds upon the method steps introduced in FIG. 6 by illustrating how data flows between physical and logical components in the digital audio environment 102 described in earlier figures. The diagram visualizes the implementation of the logger 112 functionality within the broader system architecture established in FIG. 1, showing how the DJ media player receiver 114, message parser 124, MIDI receiver 120, and writer 126 components interact to capture and process performance data.

The diagram depicts a data flow between multiple components in a digital audio environment. The diagram shows various components arranged horizontally, including a DJ turntable 702, a computing system 704, a DJ mixer 706, a storage 708, and an audio file 710.

The interaction begins with a data transmission operation from the DJ turntable 702 to the computing system 704. This operation represents the transfer of performance data from a musical device to a processing system. In some examples, the DJ turntable 702 (e.g., corresponding to DJ media players 106 in FIG. 1) may transmit a first data stream containing performance data via a digital DJ equipment networking protocol. This protocol may enable synchronized playback between networked media players and, in some implementations, can transmit detailed metadata including waveform data with amplitude information, quantized beatgrid information with beat locations, user-defined hot cues, real-time playback position coordinates, tempo information in beats per minute (BPM), cumulative beat count metrics, phase information relative to the beat, play/pause status flags, timestamp-based cue points, loop start/end point coordinates with repetition counts, effects settings, and track metadata including title, artist, and album information.

Concurrently, a second data transmission operation occurs from the DJ mixer 706 to the computing system 704. This operation represents the capture of control data from an audio mixing device. In some examples, the DJ mixer 706 (e.g., corresponding to mixer 108 in FIG. 1) may transmit a second data stream containing MIDI protocol messages over a direct USB connection. These MIDI messages may include continuous controller data (CC) messages with 7-bit resolution values (0-127) representing real-time adjustments to physical faders, knobs, and rotary encoders; program change messages indicating selection between mixer preset configurations; note on/off messages with velocity values representing button presses and releases on performance pads; pitch bend messages encoding jog wheel movements during scratching operations; and transport control messages signaling play, stop, cue, and other playback state changes.

The computing system 704 then performs a data synchronization operation, represented by the “Synchronize data streams” arrow. This operation combines multiple data sources into a coherent timeline. In some examples, the computing system 704 (e.g., the message parser 124 component) may implement a chronological interleaving algorithm that sorts incoming data packets based on timestamps. The synchronization process may use timestamps applied to each packet at the point of origination, enabling the message parser 124 to reconstruct the temporal relationship between events occurring across disparate hardware devices operating on different protocols. This synchronization technique may help address latency variations between the network-based DJ protocol and the USB-based MIDI protocol by establishing a unified time reference frame.

Following synchronization, a data storage operation transfers the synchronized information to persistent storage, as indicated by the “Store synchronized data” arrow. This operation preserves the combined performance data for future processing. In some examples, the computing system 704 (e.g., the writer 126 component) may implement a logging mechanism that writes the raw synchronized data streams to disk without modification or compression. The storage format may preserve the native protocol structures of both the DJ equipment network packets and the MIDI messages, maintaining their original binary representations alongside the timestamp information used for synchronization. This approach may create a digital record (e.g., a recording file 128) that captures the performance state at each moment in time.

The diagram further illustrates a data processing operation performed by the computing system 704, shown by the “Process synchronized data” arrow. This operation transforms raw performance data into an improved format. In some examples, the computing system 704 (e.g., the postprocessor 130 component of the splitter 132) may implement various predefined algorithms and rules to clean and enhance the raw recording file. These predefined rules may include filtering algorithms to remove irrelevant control data, phase correlation techniques to address synchronization issues between tracks, metadata enrichment processes to add semantic information, quantization algorithms that align events to the nearest beat grid position with configurable parameters, smoothing routines to reduce unintentional control movements, and inference engines that insert semantic performance details based on DJ-specific domain knowledge. The insertion of semantic performance details may include adding musically meaningful markers or annotations that were not explicitly present in the raw data streams. For example, the system may analyze patterns in the performance data to infer the beginning of a musical phrase change, detect an intended transition between tracks even when not explicitly marked, identify chorus sections based on waveform analysis, or add annotations about mix techniques being employed (e.g., such as “echo out transition” or “filter sweep”) based on recognized patterns of control movements. These semantic details enhance the digital representation by capturing the musical intent and structure of the DJ's performance beyond what was directly recorded from the equipment. The postprocessor 130 may also implement MIDI mapping algorithms that translate abstract controller identifiers into specific physical parameters based on known mixer models, and channel routing detection that analyzes signal flow between media players and mixer channels.

After processing, another data storage operation occurs, represented by the “Store processed data” arrow. This operation preserves the enhanced performance data. In some examples, the computing system 704 (e.g., the splitter 132) may generate a structured postprocessed recording file 134 containing multiple data layers. These layers may include beat grid information with tempo markers and downbeat indicators, transition markers identifying crossfade points between tracks, segmented audio clip definitions with boundary information, simulated master mixdown data derived from channel level analysis, and DJ assignment metadata mapping performance segments to individual performers. The file format may be designed for subsequent editing operations while maintaining the temporal integrity of the original performance.

The final operation shown in the diagram involves data provision for further processing, flowing from the storage 708 to the audio file 710. This operation represents the transformation of processed data into an editable audio format. In some examples, this may involve a conversion process performed by the converter 140, which analyzes the post-processed recording files to identify and extract audio elements. The converter 140 may implement algorithms to generate a DAW set file 142 containing hierarchically organized objects: track objects 302 representing each audio source with its associated metadata, clip objects 304 defining contiguous playback segments with start/end points and playback parameters, processor objects 306 encapsulating effects chains and parameter automation data with normalized value ranges, and tempo objects 308 defining tempo changes and beat grid information aligned to the session timeline. These objects may be structured according to a specific DAW file format specification to enable loading into professional audio editing software.

At the bottom of the diagram, the same components are shown again (e.g., a DJ turntable 702, a computing system 704, a DJ mixer 706, a storage 708, and an audio file 710), representing the complete system after the data flow has occurred.

Although the example method 700 depicts a particular sequence of operations, the sequence may be altered without departing from the scope of the present disclosure. For example, some of the operations depicted may be performed in parallel or in a different sequence that does not materially affect the function of the method 700. In some examples, different components of an example device or system that implements the method 700 may perform functions at substantially the same time or in a specific sequence.

### Splitter 132: Splitting Recording Files

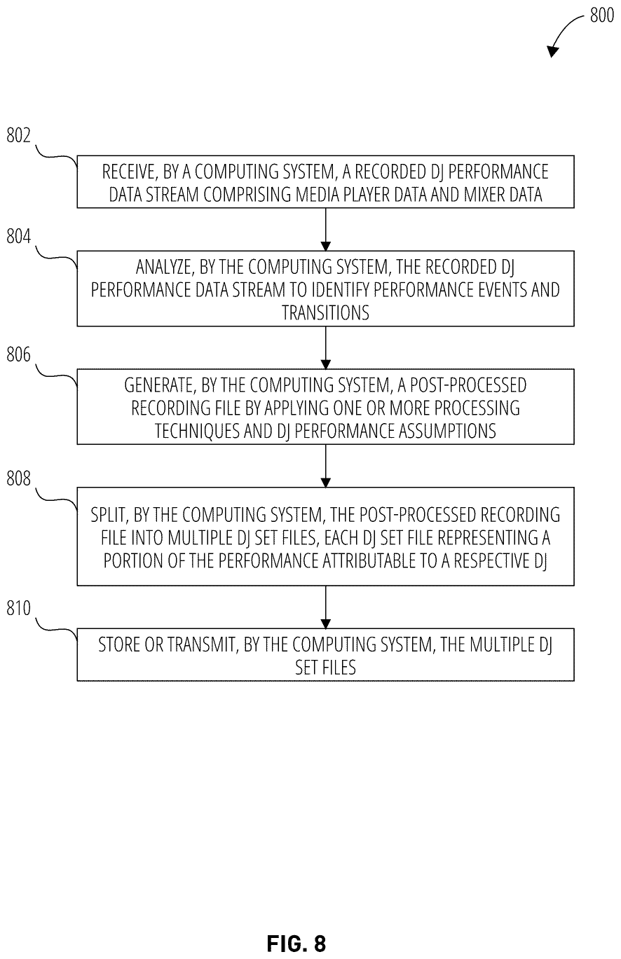

FIG. 8 is a flowchart illustrating a method 800, according to some examples, to process audio data.

In operation 802, the computing system receives a recorded DJ performance data stream comprising media player data and mixer data. In some examples, the splitter 132 receives a raw recording file 128 containing an unprocessed log of the data streams captured from the DJ system 104 during the live performance. This recording file 128 includes both the detailed metadata packets streamed from the networked media players over a digital DJ protocol, as well as the MIDI event messages representing real-time mixer activity that were output over USB.

In operation 804, the computing system analyzes the recorded DJ performance data stream to identify performance events and transitions. In some examples, the splitter 132 executes algorithms to interpret the raw recording file. The splitter 132 processes the low-level equipment data streams to identify key events within the performance, such as cue points, loops, transitions between tracks, mixer adjustments, etc. The splitter 132 leverages domain expertise of common DJ techniques to make informed assumptions about the most probable events represented by the opaque equipment data. For example, imprecise loop points may be snapped to the nearest beat grid position.

In operation 806, the computing system generates a postprocessed recording file 134 by applying one or more processing techniques and DJ performance assumptions. In some examples, the splitter 132 applies various preprocessing techniques to clean up the raw recording file and optimize it for DJ software editing. These may include filtering irrelevant data, fixing sync issues, applying metadata, quantizing events to the beat grid, smoothing out artifacts, and inserting semantic performance details that cannot be directly extracted from the opaque equipment streams. The splitter 132 may make DJ-centric assumptions about intended actions to transform the data into a cleaner post-processed recording file.

In operation 808, the computing system splits the postprocessed recording file 134 into multiple DJ set files 138, each representing a portion attributable to a respective DJ. In some examples, the splitter 132 contains advanced algorithms to detect transitions between DJs within the recording, even when they occur seamlessly back-to-back. Factors considered may include mixing style, channel levels, timing, connected devices, and audio announcements. The splitter 132 slices the file at the detected transitions to isolate each DJ's contribution in distinct audio files 138.

In operation 810, the computing system stores or transmits the multiple DJ set files 138. For example, these post-processed, per-DJ audio files 138 can then be independently loaded into DJ editing software (e.g., the converter 140) for further refinement and post-production. The splitter 132 outputs the optimized editable representations of each DJ's set from the original opaque equipment data streams.

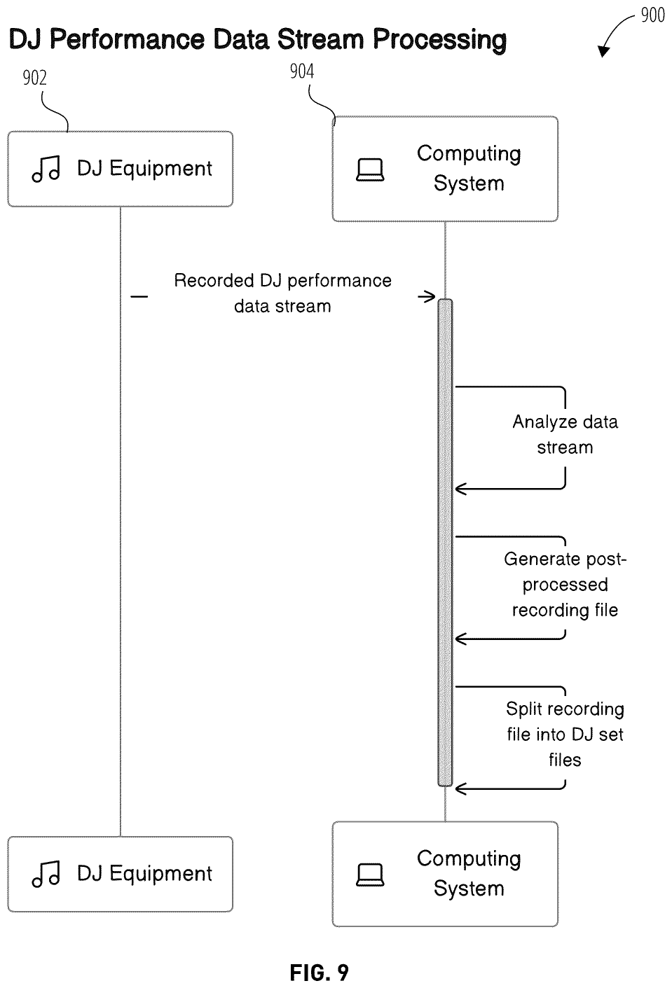

FIG. 9 is an interaction diagram illustrating a data steaming process 900 according to some examples, of processing DJ performance data streams.

While FIG. 8 presents a flowchart detailing the sequential operations of the method 800 for processing a recorded DJ performance data stream, FIG. 9 provides a complementary visual representation of these same operations as interactions between system components. This interaction diagram builds upon the data logging concepts introduced in FIG. 6 and FIG. 7, which focused on capturing the performance data, by illustrating the subsequent processing operations that transform the raw logged data into usable DJ set files. The diagram serves as a bridge between the conceptual method operations and their practical implementation within the system architecture shown in FIG. 1.

The diagram depicts data steaming processes 900 that occur between two components: DJ equipment 902 and a computing system 904. DJ Equipment 902 represents the hardware source of performance data—in some examples, this equipment may comprise a network of multiple DJ media players and a mixer interconnected via a local area network router, forming an integrated digital audio environment capable of capturing granular performance metadata.

The interaction commences with the DJ equipment 902 transmitting a “Recorded DJ performance data stream” to the computing system 904. At a high level, this stream contains performance information captured during a live DJ set. In some examples, this data stream may encompass detailed metadata including waveform data, beatgrid information with quantized beat locations, hot cues, playback positions, BPM values, beat counts, phase information, play/pause status, cue points, loop parameters, effects settings, and track metadata.

Upon receipt of the data stream, the computing system 904 executes a sequence of data processing operations. The first operation involves data analysis—the computing system 904 analyzes the incoming data stream to identify performance events and transitions within the recorded DJ performance, as indicated by the “Analyze data stream” step in the diagram. At a general level, this analysis identifies structural elements within the performance. In some examples, this analysis may employ digital signal processing algorithms to identify beat markers, extract waveform characteristics, detect loop boundaries, identify cue point activations, and recognize transitions between media files through algorithmic interpretation of the raw equipment data streams. The computing system 904 may implement models trained on DJ performance patterns to make inferences about the musical elements represented by the granular equipment data.

Following the analysis phase, the computing system 904 performs data transformation—generating a post-processed recording file, represented by the “Generate post-processed recording file” step in the diagram. At a fundamental level, this process restructures the raw data into an optimized format. In some examples, this transformation may involve signal processing operations including filtering of frequency-specific noise artifacts, temporal synchronization between multiple data streams, metadata enrichment with performance context, quantization of timing events to align with a derived beat grid, waveform smoothing to address capture artifacts, and algorithmic inference of semantic performance details that may not be directly extracted from the equipment data streams.

The final operation performed by the computing system 904 involves data segmentation—splitting the post-processed recording file into multiple DJ set files, shown as “Split recording file into DJ set files” in the diagram. At its core, this operation divides the unified recording into logical segments. In some examples, this splitting process may employ spectral analysis algorithms to detect acoustic transitions between DJs, even when they occur seamlessly back-to-back, by analyzing parameters including frequency distribution patterns, mixing technique signatures, channel level relationships, temporal characteristics, device connection metadata, and processing of audio announcements. The computing system 904 may implement temporal slicing at the detected transition boundaries to isolate each DJ's contribution into discrete audio files with minimal artifacts at the segmentation points.

Although the example method 900 depicts a particular sequence of operations, the sequence may be altered without departing from the scope of the present disclosure. For example, some of the operations depicted may be performed in parallel or in a different sequence that does not materially affect the function of the method 900. In some examples, different components of an example device or system that implements the method 900 may perform functions at substantially the same time or in a specific sequence.

Converter 140: Generating DAW set file 142

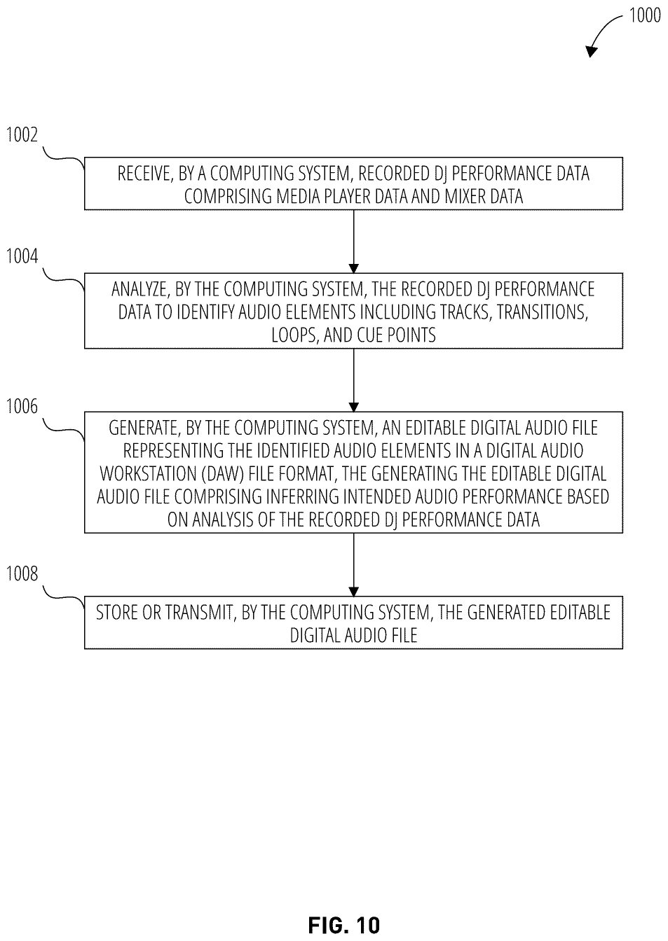

FIG. 10 is a flowchart illustrating a method 1000, according to some examples, of generating an editable digital audio file using the converter 140.

In operation 1002, the computing system receives recorded DJ performance data comprising media player data and mixer data. For example, the converter 140 executing on a computing system ingests the post-processed per-DJ split recording files 128 output by the splitter 132. These files 138 contain optimized editable representations of each DJ's individual set with added semantic data but still consist of the low-level control messages from the equipment.

In operation 1004, the computing system analyzes the recorded DJ performance data to identify audio elements including tracks, transitions, loops, and cue points. In some examples, the converter 140 executes DSP algorithms to interpret the optimized per-DJ recording files. The converter 140 leverages domain expertise (e.g., embedded in algorithms or AI models) of DJ workflows to make inferences about the high-level musical elements represented by the granular equipment data. For example, waveform analysis and audio fingerprinting may identify transition markers between tracks. Quantized beat grid positions may pinpoint loop start/end points and cue locations. The converter 140 reconstructs the complete DJ set by mapping the low-level data onto these high-level audio entities.

In operation 1006, the computing system generates an editable digital audio file representing the identified audio elements in a DAW file format. This may include inferring intended audio performance based on analysis of the recorded DJ performance data. In some examples, the converter 140 contains logic to translate the metadata and MIDI messages into a rendered DAW session file containing audio clips, transitions, and automation data. This may include making assumptions about the DJ's intended performance based on the limited data available. For example, the metadata of the MIDI messages 122 are mapped to corresponding effects parameters based on typical DJ mixer layouts and workflows. Audio waveform analysis may reconstruct crossfades between tracks. The converter 140 this leverages domain data to fill in the gaps and synthesize a DAW file.

In operation 1008, the computing system stores or transmits the generated editable digital audio file. In some examples, the converter 140 outputs the final DAW-compatible file representation of the DJ set that can be loaded directly into a digital audio workstation for further editing and refinement.

In some examples, where the event data from the DJ media players and the mixer are already rich with semantic detail, the role for a converter 140 to perform complex inferences may be greatly diminished. The event data may be augmented at the source with comprehensive metadata that precisely delineates audio elements such as track transitions, loops, cue points, and effects parameters. This enriched data may be structured in a way that mirrors the format and requirements of the DAW application 144, allowing for a more streamlined import process.

For instance, the DJ media players may embed metadata within the audio files themselves, marking exact cue points and loop regions in alignment with the DAW's beat grid. The mixer may output control messages that are already formatted to correspond with the DAW's automation lanes, detailing nuances of the mix adjustments in real-time. In such examples, the event data may carry a level of detail that closely approximates the final editable digital audio file structure required by the DAW.

This enriched event data stream may enable the direct translation of the DJ's performance into a DAW session file without the need for the converter to infer intentions or fill in missing information. The DAW application may then utilize this detailed data to recreate the DJ set with high accuracy, reflecting the true intent of the DJ's performance. The editing process within the DAW may then become more about refinement and creative exploration, as the foundational reconstruction of the set would already be complete upon import.

In this scenario, the converter's role might shift from one of interpretation and inference to that of a facilitator for data format compatibility, ensuring that the enriched event data seamlessly integrates with the DAW's existing file structures and editing capabilities. The result is a more efficient path from live performance to post-production, with the DAW application serving as the primary platform for any further adjustments or enhancements to the set.

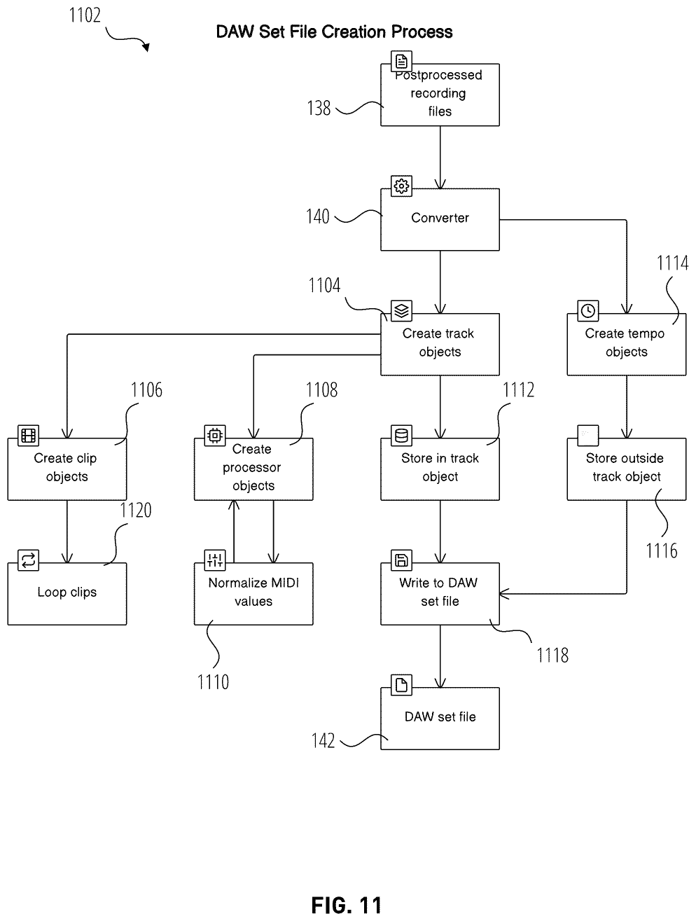

FIG. 11 is a flowchart that shows a method 1102, according to some examples, used by the converter 140 to create a DAW set file 142.

In operation 1104, the converter 140 creates a number of track objects 302 corresponding to the tracks in the DJ set. In operation 1104, the converter 140 creates track objects 302 corresponding to the tracks in the DJ set. This may include:
Parsing Event Data—The converter 140 parses event data from the post-processed recording files 138 associated with each track. Specific events that are extracted may include:
   Track transitions
   Jumps/scrubs within tracks
   Loop start/end points
   Play/pause/stop events
   Effect automation events
Generating Clip Objects—At operation 1106, clip objects 304 are generated representing contiguous track segments between extracted events from the post-processed recording files 138. This may involve:
   Analyzing the sequence of play, pause, jump, and transition events for each track to identify clip boundaries.
   Setting the start time and position of each clip object based on the first relevant event. The end position is derived from the next transition/jump event or stop event.
   Synchronizing transitions between clips across tracks by snapping clip boundaries to shared cue points and beat grid positions extracted from the data.
   Utilizing supplemental metadata about active channels, crossfader position, and relative track volumes to determine which tracks were audible during transitions.
   Encoding information like loop status, cue points, and saved loops from the input events into each clip object for faithful recreation in the DAW.

This synchronization based on extracted timestamp and position data ensures seamless transitions between clip objects 304 when loading the DAW set file 142 Gaps or overlaps between clips are avoided using the beat grid alignment even if input events have slight timing inaccuracies.

As an alternative implementation, the converter 140 could employ audio analysis to detect transitions rather than purely event-based logic. Machine learning models could also assist in cleaning noisy input data and providing cue point recommendations.
Creating Loop Clip Objects-Loop clip objects are specially constructed to reflect looped portions by analyzing timing of jump events within looped sections at operation 1108. The loop segment duration is calculated based on the interval between repeats of a jump event.

In operation 1108, as part of constructing the track objects 302, the converter 140 generates processor objects 306 representing effects, EQ, and other parameter automation based on MIDI automation events extracted from the input data.

At sub-operation 1110, MIDI parameter values are normalized to value ranges used by the target DAW (e.g., 0-127 to 0-100).

Operation 1112 comprises storing the generated clip objects 304 and processor objects 306 within their associated track object 302.

Operation 1114 involves creating tempo objects 308 representing tempo changes and beat grid information extracted from the input data. This may include:
Detecting master tempo change events in the data based on changes to the BPM parameter of the track designated as tempo master.
Generating a tempo object 308 containing the new BPM value and a timestamp for when the change takes effect.
Extracting beat position data from a tempo master track to reconstruct beat grid alignment information.
Encoding beat grid cue points into tempo objects 308 to facilitate beat-synchronized visualizations and audio warping.
Including time signature metadata to assist with meter analysis.

In operation 1116, the constructed tempo objects 308 are stored globally at the project level rather than within specific track objects 302. This is because tempo forms a common timeline against which all tracks are aligned during playback and visualization in the DAW application 144.

In some examples the converter 140 may generate multiple tempo timeline candidates with different beat grid interpretations. It could also perform audio analysis on tracks to detect transients and infer tempo and meter independently of the input data.

Storing tempo globally allows it to be propagated across tracks automatically while still permitting overrides of grid alignment on individual tracks if needed.

Finally, in operation 1118 the converter 140 writes out the track objects 302 and tempo objects 308 to generate the DAW set file 142. This may include:
Serializing the generated data structures (clips, processors, tempo, etc.) into a JSON format.
Structuring the output JSON with appropriate nesting to represent relationships between tracks, clips, automation lanes, etc.
Specifying project metadata like title, artist, creation date, app version, and global configuration parameters.
Defining external references to associated media files to be linked subsequently during DAW import.
Employing data compression and optimization techniques to minimize file size.
Encrypting certain aspects of the file format while retaining editability.
Generating auxiliary files to store non-critical metadata separate from primary creative content.

This standardized open format ensures cross-platform compatibility while restricting access to editing tools to maintain integrity. The external media linkage allows managing high-volume audio data separately while retaining reference associations.

In some examples, the system leverages binary formats optimized specifically for the target DAW application to improve performance. It could also employ versioning to support format evolution over time.

Editing in DAW application 144: Deleting a Track

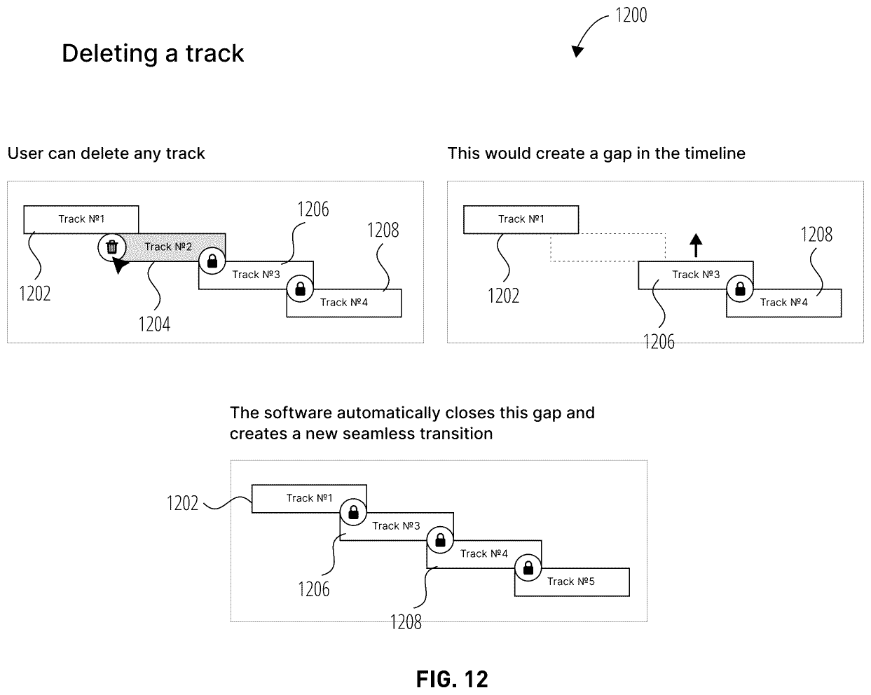

FIG. 12 is a user interface diagram illustrating a method, according to some examples, of propagating downstream changes when editing a DJ mix timeline in a digital audio workstation (DAW) application.

FIG. 12 specifically illustrates how the DAW application 144 may implement intelligent timeline editing to maintain mix continuity. The figure depicts a user interface sequence 1200 showing track manipulation within a timeline view. FIG. 12 shows three distinct panels that demonstrate the progression of a track deletion operation and its automated consequences. The sequence begins with an initial arrangement displaying multiple audio tracks positioned sequentially on a horizontal timeline, each track represented by a rectangular container with identifying labels and reference numbers 1202, 1204, 1206, and 1208 respectively.

Track deletion functionality is represented in the top-left panel. In some examples, this deletion capability may be implemented through a multi-layered interaction system that supports various input modalities including pointer-based selection, touch gestures, keyboard commands, or voice control. The system may employ event listeners to detect user intent, with the trash can icon overlaying Track No2 (track 2 1204) serving as a visual affordance indicating the impending deletion operation.

The middle panel illustrates timeline discontinuity that would result from track deletion. This representation employs dotted outlines and spatial gaps to communicate the potential disruption in playback continuity. The system maintains internal data structures that track the temporal relationships between media elements, allowing it to identify and visualize the consequences of operations before they are fully committed.

Temporal relationship analysis is performed by the system to determine appropriate adjustment strategies. In some examples, this analysis employs algorithms that examine multiple signal characteristics including transient detection, spectral content matching, rhythm pattern recognition, and harmonic compatibility between adjacent tracks. These algorithms may utilize machine learning models trained on professional DJ transitions to identify suitable connection points between track 1 1202 and track 3 1206 after the removal of track 2 1204.

The bottom panel shows automated gap resolution through intelligent track repositioning. In some examples, this functionality is implemented via a multi-stage process that first identifies affected timeline segments, calculates new positions based on musical structure analysis, generates appropriate transition metadata, and finally renders the updated arrangement with visual feedback. The curved connection lines between tracks represent transition objects that encapsulate crossfade parameters, beat-matching information, and effect automation data.

The propagation mechanism extends to all downstream content through a cascading update system. In some examples, this system maintains a directed graph of track dependencies, allowing changes to propagate through the timeline while preserving relative timing relationships. The appearance of Track No5 in the bottom panel demonstrates how the system can dynamically adjust viewport boundaries to reveal previously off-screen content affected by the propagation.

Transition management is handled through an automated crossfade generation subsystem. In some examples, this subsystem analyzes waveform characteristics at track boundaries to determine helpful crossfade curves, transition durations, and EQ adjustments. The system may employ spectral analysis to identify frequency bands that may benefit from special attention during transitions, automatically generating appropriate filter automation to facilitate smooth blending between tracks 1202, 1206, and 1208.

Security features are represented through visual lock indicators on certain tracks. In some examples, these security controls are implemented through a permissions framework that supports role-based access control, edit protection policies, and audit logging. The lock icons may indicate tracks that have been finalized through an approval workflow or protected by content ownership restrictions in collaborative editing environments.

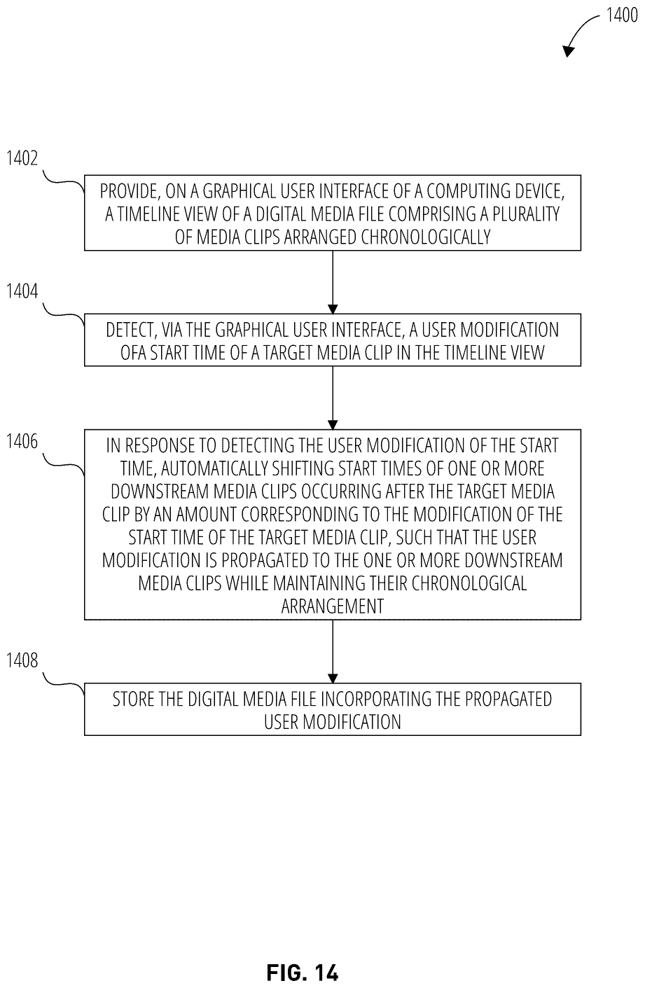

The automatic propagation functionality implements the method described in operation 1406 of FIG. 14, where, in response to detecting a user modification, the system automatically shifts the start times of downstream media clips by an amount corresponding to the modification. This preserves the chronological arrangement and timing relationships between clips while maintaining proper transitions.

### Editing in DAW Application 144: Reordering a Track

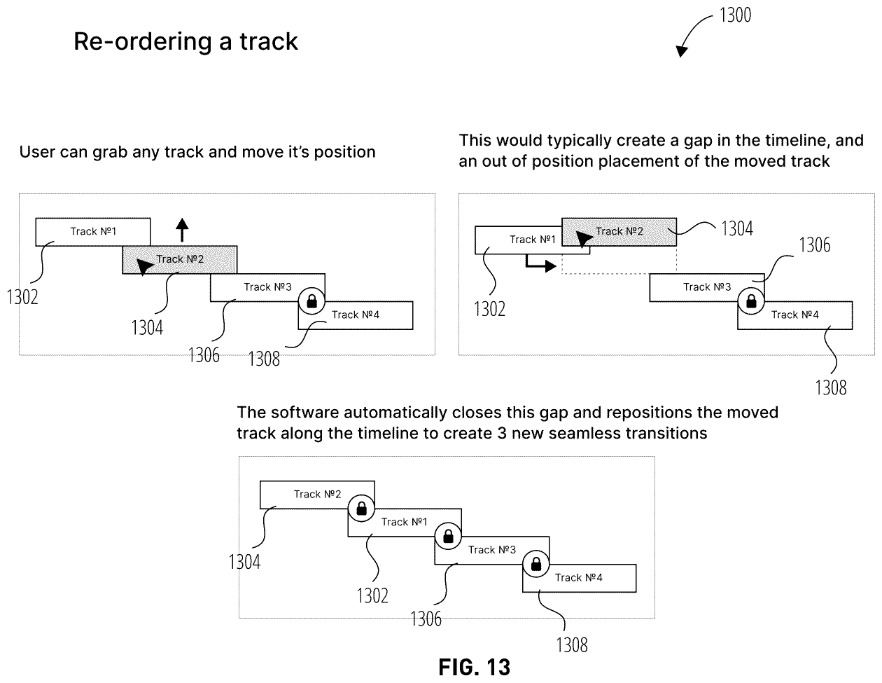

FIG. 13 is a user interface diagram illustrating a method, according to some examples, of reordering tracks in a digital audio workstation (DAW) application with automatic downstream propagation of changes.

Building upon the track editing capabilities shown in FIG. 12, which demonstrated how the DAW application 144 handles track removal by automatically closing timeline gaps, FIG. 13 extends this editing paradigm to track reordering operations. While FIG. 12 focused on removing tracks and maintaining timeline continuity, FIG. 13 illustrates the scenario of repositioning tracks within the timeline while preserving seamless transitions between affected tracks. This functionality represents another aspect of the DAW application's approach to maintaining mix integrity during post-production editing of DJ performances.

FIG. 13 presents a user interface sequence 1300 that demonstrates the track reordering process in three distinct stages, according to some examples. At a high level, the interface displays audio tracks arranged chronologically on a timeline. In some examples, this timeline representation may use a multi-lane visualization system where each track occupies its own horizontal lane with temporal alignment to adjacent tracks. The top panel shows an initial arrangement with Track No1 1302, Track No2 1304, Track No3 1306, and Track No4 1308 sequentially positioned along the timeline. The visual representation, in some examples, may include waveform renderings, color-coded track segments, or rectangular containers with labeled identifiers to facilitate user recognition of different audio segments within a DJ mix.

A directional indicator, shown as an upward arrow in the top panel, signifies a user interaction mechanism for track manipulation. This interaction paradigm, in some examples, allows users to select and reposition timeline elements. In some examples, this interaction may be implemented through event-driven input handling that supports various modalities such as mouse dragging operations, multi-touch gesture recognition, keyboard shortcut combinations, or voice commands. The system can, in certain implementations, employ coordinate mapping algorithms that translate raw input device coordinates into timeline position changes while maintaining temporal relationships.

The middle panel illustrates a problematic scenario that conventional audio editing applications may encounter when handling track repositioning. The visualization demonstrates two fundamental issues that arise in traditional systems: temporal discontinuity and positional misalignment. Here, moving Track No2 1304 would result in an empty timeline segment (represented as a gap after Track No1 1302) and a disjointed placement of the moved track (shown positioned after Track No3 1306). This representation effectively highlights the technical challenge that the system addresses through its timeline management algorithms.

The bottom panel showcases a technical solution, according to some examples, implemented by the DAW application 144. At one level, the system performs automatic timeline reconstruction to maintain continuity. In some examples, this reconstruction process may involve a series of operations including gap closure, track repositioning, and transition regeneration. The system automatically executes these operations by closing the gap created by the track movement, repositioning Track No2 1304 at the beginning of the timeline, and adjusting subsequent tracks (Track No1 1302, Track No3 1306, and Track No4 1308) to maintain transitions between them. The adjustment process may, in certain implementations, involve algorithms that recalculate start and end times for each affected track, apply appropriate crossfade parameters at transition points, and ensure beat-synchronization between adjacent audio segments through waveform analysis.

The DAW application 144 implements a downstream propagation algorithm for timeline modifications. At its core, this algorithm identifies and updates affected timeline elements. In some examples, the DAW application 144 may employ a relational data model that identifies downstream clips as those having original start times equal to or later than the original start time of the target clip that was modified. The temporal adjustment calculation may involve frame-accurate or sample-accurate timing updates where the identified downstream clips have their start times updated by the exact same temporal offset (e.g., measured in milliseconds, frames, or samples) that was applied to the target clip's start time. This maintains chronological arrangement and preserves timing relationships between the target clip and all downstream elements. The transition preservation mechanism, in certain implementations, may utilize metadata retention techniques that preserve the original transitions between the target and downstream clips, including crossfade curves, cut points, or other transition effects, with their durations and characteristics maintained despite the timeline shifting.

Visual indicators, shown as circular elements at the junctions between tracks in the bottom panel, represent the connection points between adjacent tracks. These indicators highlight transition regions in the timeline. In some examples, these visual elements may represent crossfade regions or beat-matched transition points that the DAW application 144 automatically generates when repositioning tracks. A transition generation system may employ audio analysis algorithms that examine characteristics such as tempo markers, key signatures, rhythmic patterns, and transient positions to create musically coherent transitions between repositioned tracks. In certain implementations, the system may utilize quantization techniques that snap the shifted start times of downstream clips to a beat grid, ensuring that all transitions remain musically aligned according to the underlying rhythmic structure of the content.

An automatic propagation system maintains timeline coherence through relational data management. At its foundation, this system preserves relationships between timeline elements during editing operations. In some examples, when a track position is modified, the system may execute a cascade of adjustments through a dependency graph that maintains the relative timing relationships between elements while accommodating the new arrangement. The real-time update mechanism may use rendering techniques that provide visual feedback about the resulting timeline structure as edits are performed. The preview functionality, in certain implementations, may include a non-destructive scrubbing mechanism that allows users to preview propagated changes before committing them to the timeline, enabling experimentation without permanent modification.

The DAW application 144 determines appropriate positioning for reordered content and seeks to provide musical coherence despite timeline modifications. In some examples, the system may employ analysis methods that evaluate musical compatibility factors such as harmonic progression, rhythmic consistency, energy curve mapping, and timbral compatibility to help maintain musical coherence despite the reordering. The transition quality optimization mechanism may, in certain implementations, apply automatic volume envelope adjustments at transition points to facilitate smooth blending between tracks in their new positions, potentially using loudness normalization techniques to maintain consistent perceived volume across the mix. The persistence layer, following the reordering operation, may update the media file's metadata to reflect the new start times while preserving the original media content, enabling non-destructive editing that maintains the integrity of the source material.

FIG. 14 is a flowchart illustrating a method 1400, according to some examples, of generating a user interface, incorporating some of the functionality described with reference to FIG. 12 and FIG. 13.

In operation 1402, the method 1400 provides, on a graphical user interface (GUI) of a computing device, a timeline view of a digital media file comprising a plurality of media clips arranged chronologically. The GUI may be the multitrack editor 406 of a video editing or digital audio workstation (DAW) (e.g., DAW application 144) that displays a multi-track timeline representing a media project. The media clips are displayed as waveforms on separate lanes or tracks along the timeline, which represents time.

The media clips may be of various media types, such as video clips, audio clips, still image clips, etc. The clips are arranged sequentially along the timeline according to their playback order and timing. Metadata associated with each clip, such as start/end times, duration, transitions, etc. is stored to maintain the chronological arrangement.

The GUI view may provide zooming and panning capabilities to navigate along the timeline. Clips can be trimmed, split, joined, or otherwise edited directly on the displayed timeline. The user can scrub along the timeline to dynamically preview the media.

In operation 1404, the method 1400 detects, via the GUI, a user modification of the start time of a target media clip in the timeline view. In some examples, this may involve the user clicking and dragging the edge of a target or selected clip to change its start position on the timeline, thereby altering its timing relative to other clips. The GUI detects this action and updates the underlying metadata for the target clip's start time. The detection may involve event listeners on a timeline view UI component of the multitrack editor 406 to detect drag operations, compare underlying clip start/end times before and after drag, and determine the precise modification amount in milliseconds or video frames.

In operation 1406, in response to detecting the user modification of the start time, the method 1400 automatically shifts start times of one or more downstream media clips occurring after the target media clip by an amount corresponding to the modification of the start time of the target media clip. For example, the downstream clips may be identified by having original start times equal to or later than the original start time of the target clip that was modified. The identified downstream clips have their start times updated by the same number of milliseconds or frames that the target clip's start time was adjusted.

This shifting maintains the proper chronological arrangement and timing relationships between the target clip and downstream clips, preventing unintended gaps, overlaps, or synchronization issues from arising due to the edit. The shifting may also preserve the original transitions between the target and downstream clips, such as crossfades or cuts between clips. The transition durations and types are maintained despite the shifting.

In operation 1408, the method 1400 stores the digital media file incorporating the propagated user modification. The media file's metadata is updated to reflect the new start times of the target and shifted downstream clips. The actual media content of the clips does not need to be modified. The metadata preserves the edits for future playback, rendering, or additional editing of the media file. The file may be stored locally on the user's computer (e.g., computer system 146) or on a media asset management system. Storing the modification allows the user to incrementally build up a media project over time without losing work.

### Editing in DAW Application 144: Looping

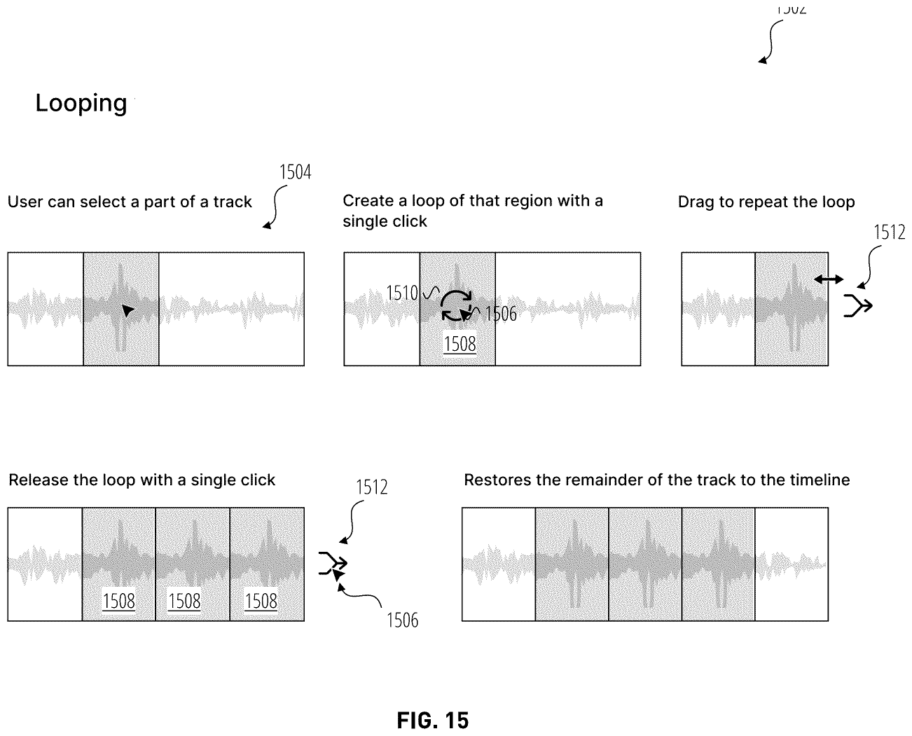

FIG. 15 is a user interface diagram illustrating a method, according to some examples, of modifying an audio track displayed within a user interface of a digital audio workstation (DAW) application to loop a selected track section of the audio track.

Building upon the DAW application architecture described in FIG. 4, which illustrates the core components including the audio engine 402, mixing console 404, multitrack editor 406, and automation system 414, FIG. 15 demonstrates implementation of the looping functionality within the multitrack editor 406, according to some examples. This figure extends the concepts introduced in previous figures by showing how the abstract data structures of clip objects 304 and processor objects 306 described in FIG. 3 are manifested in the user interface. While earlier figures established the technical foundation for converting recorded DJ performance data into editable DAW set files, FIG. 15 illustrates how users can interact with and manipulate these converted files through intuitive visual controls designed for DJ workflows.

FIG. 15 presents a visual sequence depicting the progression of a looping operation, according to some examples. In the topmost panel, an audio representation appears as a single audio track 1504 displayed within a dedicated lane in the user interface In some examples, the visual representation may include detailed waveform renderings of the audio content aligned with and synchronized to the timeline, providing acoustic characteristic indicators that update dynamically when modifications are applied to the track arrangement.

The second panel illustrates the initial selection process. A user interaction mechanism, implemented as cursor 1506, enables definition and selection of track section, identified as selected track section 1508. In some examples, the cursor 1506 may be controlled through various input peripherals such as a mouse, touchpad, or other pointing device. The system may support multiple selection paradigms—in some implementations, track sections may exist as predefined segments within the system architecture, while in other examples, users may dynamically define track sections through spatial selection operations over relevant portions of audio track 1504.

Upon selection confirmation, the system implements visual feedback mechanisms. The selected track section 1508 receives automatic visual differentiation, which may be implemented through various rendering techniques such as shading algorithms or color differentiation protocols. Simultaneously, an interactive control element, manifested as looping indicium 1510, appears within the user interface. This control element provides an activation mechanism for the looping functionality specifically targeting the selected track section 1508. In some examples, the looping indicium 1510 may be implemented as a graphical button, interactive icon, or other responsive interface element that processes user input events.

The third panel demonstrates the system's response to activation of the looping functionality. Following user selection of looping indicium 1510, the system executes a display management operation where chronologically downstream sections of audio track 1504 are temporarily removed from the visible interface or hidden within the lane. Concurrently, a manipulation control, represented as drag indicium 1512, becomes visible within the user interface. This drag indicium 1512 serves as an interactive endpoint controller, programmatically attached to the terminal boundary of selected track section 1508. In some examples, this control enables duration modification of the looping playback through direct manipulation.

The underlying technical implementation involves an event processing system. In some examples, the DAW application 144 employs an event handling system that processes input signals, which are then transformed into coordinate data within the timeline's spatial framework. As manipulation of drag indicium 1512 occurs, the system dynamically updates internal timeline state representations to reflect the modified endpoint position of the looped segment. This state change triggers real-time visual rendering updates, providing immediate feedback regarding the extended loop duration.

The loop extension functionality employs processing logic. In some examples, the DAW application 144 implements algorithms designed to handle input events efficiently, ensuring duration adjustments while maintaining synchronization with the global track timing framework. This technical approach facilitates creative control over the temporal characteristics of the looped audio segment.

Audio analysis capabilities may enhance the looping precision. In some examples, the system performs beat detection analysis within the selected track section 1508 and implements automatic alignment of loop endpoints to the nearest beat boundaries. This quantization functionality preserves rhythmic integrity throughout the looping process by ensuring alignment with the underlying musical structure. In certain implementations, the drag indicium 1512 may move in discrete increments corresponding to these detected beat boundaries rather than allowing continuous arbitrary positioning.

Loop positioning accuracy may be further enhanced through processing algorithms. The system seeks to address technical challenges related to timing precision in loop implementation. In some examples, due to the nature of frequent position changes and timing jumps, recorded position data within loops may contain latency variations depending on the specific hardware characteristics of the DJ media player. Rather than relying solely on recorded position data, which can produce inaccurate segment durations, the system may implement analytical algorithms based on predefined rules that calculate start and end positions.

This calculation process may involve quantitative analysis of jump events within the looped interval, comparing them against temporal measurements and recorded position data. When significant discrepancies are detected between calculated and recorded duration values, the system may prioritize the calculated values to ensure accuracy.

The bottom panel illustrates the completion state of the looping operation. Following release of drag indicium 1512, which signals operation termination, the system executes an automatic restoration process. Previously hidden track sections, such as track section #3, are programmatically reintroduced and appended to audio track 1504 immediately following the extended looping section created by the repeated instances of selected track section 1508.

The loop termination process involves playback management. Upon detecting the release condition of drag indicium 1512, the DAW application 144 transitions from looped playback to linear playback, enabling the remainder of the track to resume from the appropriate position. In some examples, the system implements transition algorithms that align the media segments originally following the target section with the end boundary of the looped section. This technical approach helps address discontinuities in the audio playback, potentially employing various audio processing techniques such as crossfade algorithms, volume envelope adjustments, or other signal processing methods to create smooth transitions between the looped section and subsequent audio content.

The technical implementation of looping may utilize various approaches. In some examples, the system may create multiple duplicate instances of selected track section 1508 and position them sequentially to create the loop effect. Alternative implementations may establish loop markers at the segment boundaries and implement playback logic that repeatedly returns to the start position upon reaching the end marker. In other examples, the system may configure an audio buffer to repeatedly process only the selected track section 1508 for the specified duration.

Throughout the looping process, the system maintains data structures that represent each segment of audio track 1504 as distinct programmatic objects. When looping mode is activated through looping indicium 1510, the system preserves the complete properties of downstream segments in memory despite their temporary visual removal. Upon loop mode termination through release of drag indicium 1512, the system leverages these preserved data objects to efficiently reconstruct the complete track arrangement, eliminating the need for manual track reconstruction operations.

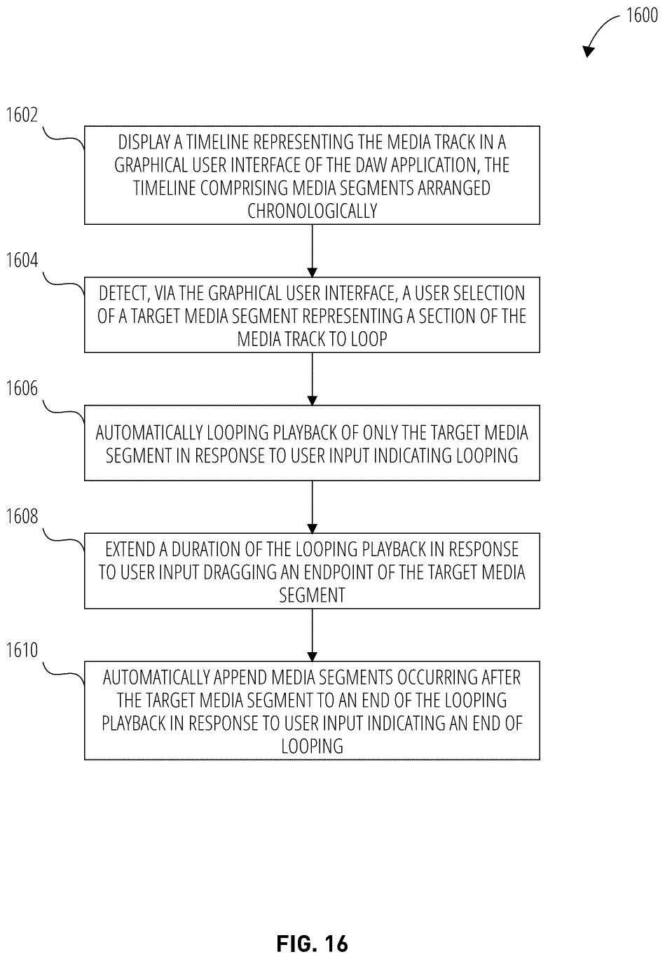

FIG. 16 is a flowchart illustrating a method 1600, according to some examples, to loop a track segment within a user interface of an audio editing application (e.g., DAW application 144).

In operation 1602, the DAW application 144 displays a timeline representing a media track (e.g., audio track 1504) in its graphical user interface (GUI), which could be implemented using a GUI framework, graphics API, or web technology. The timeline comprises individual media segments arranged chronologically to represent the time dimension of the media track. The timeline may be oriented horizontally, with time extending left to right, or may use alternative layouts like vertical, circular, 3D, etc. The media segments can be displayed visually as waveforms, rectangles, labels, or abstract shapes like circles. The segments may be arranged linearly, stacked, overlapping, nested, etc. Some examples may also use a node graph or freeform layout without time-based arrangement. The timeline view synchronizes with the audio buffer position during playback but could alternatively operate statically.

In operation 1604, the DAW application 144 detects a user selection of a target segment (e.g., selected track section 1508) for looping on the displayed timeline via the GUI. The user input may be provided through various tools like mouse, touch, pen, keyboard, voice, or a brain-computer interface. The selection triggers a visual highlight, color change, or other indicator on the target segment. Input events are captured by the GUI through an event listener, callback, polling, or other technique and mapped to timeline coordinates to determine the selected target. An alternative implementation could automate target selection using audio analysis like detecting a chorus.

In operation 1606, the DAW application 144 initiates looping extension of the media track that repeats only the selected target segment in response to user input indicating looping. This may be triggered by a button press, voice command, or other input mechanism. The looping may be implemented via segment duplication, loop markers, or redirecting playback position. It may further precisely repeat the segment or introduce crossfades/effects. Some examples may adjust pitch or tempo on each loop. The looping logic may be handled in a dedicated engine, buffer, or playback module.

In operation 1608, the duration of the looping playback is extended when the user drags an endpoint (e.g. drag indicium 1512) of the target segment. Dragging may directly manipulate the endpoint position using mouse, touch, pen, wheel, slider, dial, etc., and may operate smoothly or in discrete steps. The drag logic is implemented by handling input events, mapping coordinates, and updating the timeline state. Duration may also be extended, in some examples, by adding instances of the segment, time-stretching, or generating additional content algorithmically. Some examples may also extend the loop based on detected beats, bar lines, etc.

Finally in operation 1610, upon indication of the end of looping, the media segments originally following the target are appended to playback after the looping extension concludes. The DAW application 144 may wait for explicit user input or end looping automatically based on a condition being met.

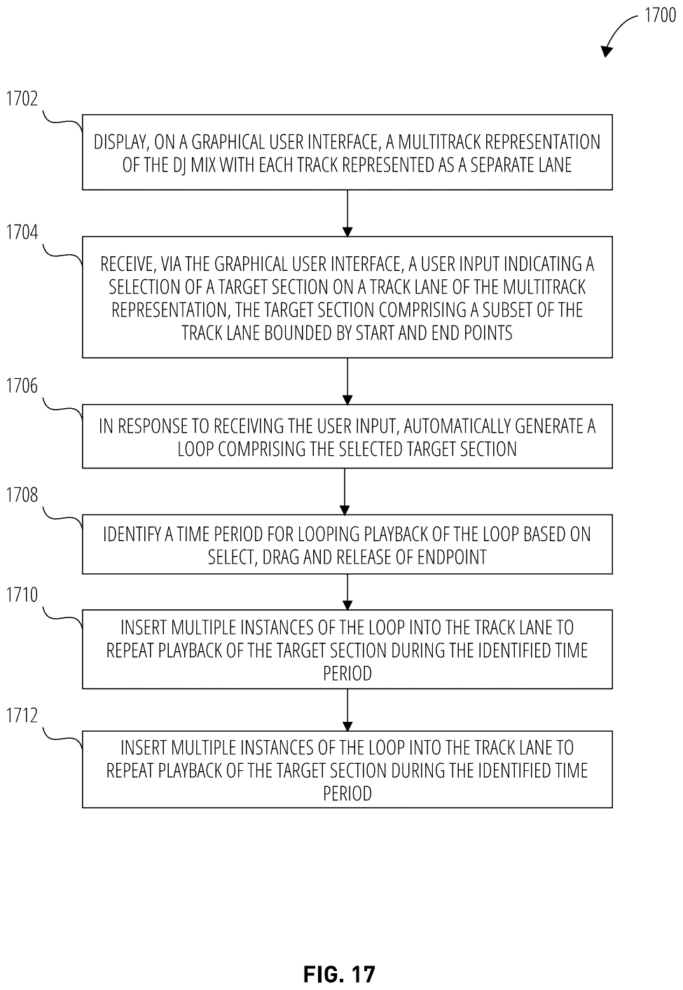

FIG. 17 is a flowchart illustrating a method 1700, according to some examples, to loop a track segment within a user interface of a DAW application 144, as for example shown in FIG. 15.

In operation 1702, the DAW application 144 displays a multitrack representation of the DJ mix on its graphical user interface (GUI). The GUI could be implemented using a graphical framework, game engine, or web technology. The mix is visualized with each constituent track represented as a separate horizontal lane. The tracks contain audio waveforms and are arranged vertically stacked on the interface. Alternative arrangements could show tracks side-by-side, overlapping, or in 3D. The GUI includes a playback position indicator that scrolls during playback to provide temporal context. Alternative implementations could use a static visualization without integrated playback.

In operation 1704, the DAW application 144 receives user input indicating a selection of a target section to loop on one of the track lanes. The input may be provided via mouse, touch, pen, keyboard, voice, motion, or other means. The selected target section comprises a subset of the track lane bounded by start and end points. Selection may involve clicking and dragging along the waveform or using timecode entry. Assistive snapping to musical beats may help define loop boundaries. Some examples may infer target sections automatically through audio analysis. The selection triggers a visual highlight, color change, or other indicator on the target segment. Input events are captured by the GUI through an event listener, callback, polling, or other technique and mapped to timeline coordinates to determine the selected target.

In operation 1706, in response to the user input, the DAW application 144 automatically generates a loop comprising the selected target section. The loop may be instantiated as a dedicated looping audio buffer or integrated into the main track buffer. Some examples may synthesize new audio content for each loop iteration.

In operation 1708, as detailed in the context of FIG. 15, the DAW application 144 engages in an interaction with the user to determine the duration of a looped playback segment within an audio track. This process begins when the user initiates a click and drag operation on the graphical user interface (GUI), targeting a specific segment of the audio track for looping.

Upon the user's action, the DAW application 144 activates a visual indicator, known as the drag indicium 1512, which is associated with the endpoint of the selected segment. The user then engages with this drag indicium 1512, typically using a mouse, touch interface, stylus, or other input devices such as a rotary wheel, slider, or dial. The user's interaction with the drag indicium 1512 may be continuous, allowing for smooth adjustments, or it may snap to predefined discrete intervals, depending on the DAW's configuration or user preference.

The technical mechanism behind this interaction involves the DAW application 144 processing input events, which are then translated into coordinate data within the timeline's framework. As the user drags the drag indicium 1512, the DAW application 144 dynamically updates the timeline state to reflect the new endpoint position of the looped segment. This real-time update is visually represented on the GUI, providing immediate feedback to the user regarding the extended duration of the loop.

The DAW application 144's loop extension logic is designed to handle these input events efficiently, ensuring that the loop duration is adjusted accurately and that the looped segment remains synchronized with the overall track timing. This allows the user to extend or shorten the looped playback duration as desired, facilitating creative control over the looping behavior of the audio segment.

In operation 1710, the DAW application 144 executes a series of actions to replicate the selected section of the audio track multiple times, creating a continuous loop effect. This is achieved by inserting successive instances of the loop into the timeline within the target track lane. The user's input, as captured in the previous operation, determines the number of instances and the total duration for which the loop will play back.

The DAW application 144 calculates the exact number of loop instances required to fill the identified time period for looping playback. Each instance of the loop is then placed sequentially on the timeline, ensuring that the end of one instance aligns precisely with the beginning of the next. This arrangement is critical to maintaining the rhythmic and musical continuity of the looped section.

During this process, the DAW application 144 may introduce intentional gaps or overlaps between instances, depending on the creative effect desired by the user. For example, a slight overlap could be used to create a crossfade effect between loops, while a gap might be used to insert a beat of silence for dramatic effect.

Additionally, the DAW application 144 provides the capability to add effects or transitions between instances of the loop. These could include reverb tails, echo effects, or any other transition effects that the DAW supports. The application ensures that these effects are applied consistently and in accordance with the user's specifications, enhancing the overall auditory experience of the looped section.

The DAW application 144 handles the technical complexity of this operation, allowing the user to focus on the creative aspects of their project. The software's underlying algorithms manage the precise timing and synchronization required to execute this operation, ensuring that the looped playback is seamless and meets the user's artistic vision. Once the operation is complete, the looped section is ready for playback or further editing within the DAW environment.

Finally in operation 1712, upon detecting a loop release condition (e.g., release of the drag indicium 1512), the DAW application 144 ceases looping playback so that the remainder of the track resumes play at this point. For example, the process seamlessly abuts the media segments originally following the target section against the end of the looped section. In some examples, the process of releasing a loop involves several technical steps that ensure a seamless transition from the looped section back to the normal playback of the track. The operation of releasing a loop may be as follows:
Loop Release Detection: The DAW application 144 continuously monitors user interactions with the graphical user interface (GUI) for specific actions that indicate a loop release condition. This condition could be triggered by the user releasing a control element within the GUI, referred to as the drag indicium 1512. The drag indicium 1512 is typically a visual element, such as a handle or marker, that the user can manipulate to adjust the length of the looped section. When the user completes the adjustment and releases the drag indicium 1512, the DAW application 144 detects this as a signal to terminate the loop.
Loop Termination: Upon detecting the loop release condition, the DAW application 144 executes a series of operations to cease the looping playback. This involves stopping the repetition of the looped section and preparing to resume playback of the subsequent track sections. The DAW application 144 manages the playback state and timing information to ensure that the transition out of the loop is executed at the correct moment in the audio timeline.
Track Continuity Restoration: The DAW application 144 then performs an operation to restore the continuity of the track by abutting the media segments that originally followed the looped section against the end of the looped section. This is achieved by adjusting the start time of the subsequent media segments to align precisely with the endpoint of the looped section. The DAW application 144 may utilize internal data structures that represent the timeline and track segments to calculate the new start times and modify the arrangement of the segments accordingly.
Seamless Transition: The process is designed to create a seamless transition from the looped section to the remainder of the track. The DAW application 144 ensures that there are no audible gaps or abrupt changes in the audio playback. This may involve applying crossfade algorithms, adjusting volume envelopes, or other audio processing techniques to blend the end of the looped section with the beginning of the subsequent section smoothly.
User Interface Update: Finally, the DAW application 144 updates the GUI to reflect the changes made to the track arrangement. This includes redrawing the waveform representations and any associated markers or indicators to show the new playback sequence. The GUI provides visual feedback to the user, confirming that the loop has been released and that the track will continue to play as expected.

By executing these technical steps, the DAW application 144 facilitates an intuitive and efficient workflow for DJs and audio engineers to manipulate looped sections within a track while maintaining the musical integrity and flow of the performance.

The method 1700 thus enables quick, intuitive looping workflows tailored for DJs within a multitrack DAW interface.

LUFS metering tool 418

In some examples, the DAW application 144 integrates a LUFS metering tool 418 directly into a timeline view alongside the waveform display. The LUFS meter data is rendered on a LUFS meter track above the main audio waveform track on the same timeline. The start and end points of the LUFS meter track segments are programmatically aligned to the underlying audio segments on the waveform track.

When new audio segments are added or edited on the waveform track, new blank LUFS meter segments are added and aligned automatically. The blank LUFS meter segments are shaded light gray to indicate they require analysis.

When the user clicks on a blank LUFS meter segment, the DAW application 144 performs a LUFS analysis on just the corresponding audio segment to plot the loudness graph for that segment only. This avoids having to process or playback the full timeline.

Transition regions 1802, where two audio segments overlap, may be shaded darker gray on the LUFS meter track. When clicked, only the transition region is analyzed, speeding up loudness analysis on these critical areas.

When audio parameters like volume are changed on a track, existing LUFS meter segments for the modified sections (e.g., modified segment 1804) are invalidated and shaded light gray again to indicate the analysis is outdated. The selective segment analysis and transition shading provide rapid re-analysis of LUFS levels on the fly as the user edits the audio. This saves needing to completely re-analyze or scrub the full timeline to update LUFS reading.

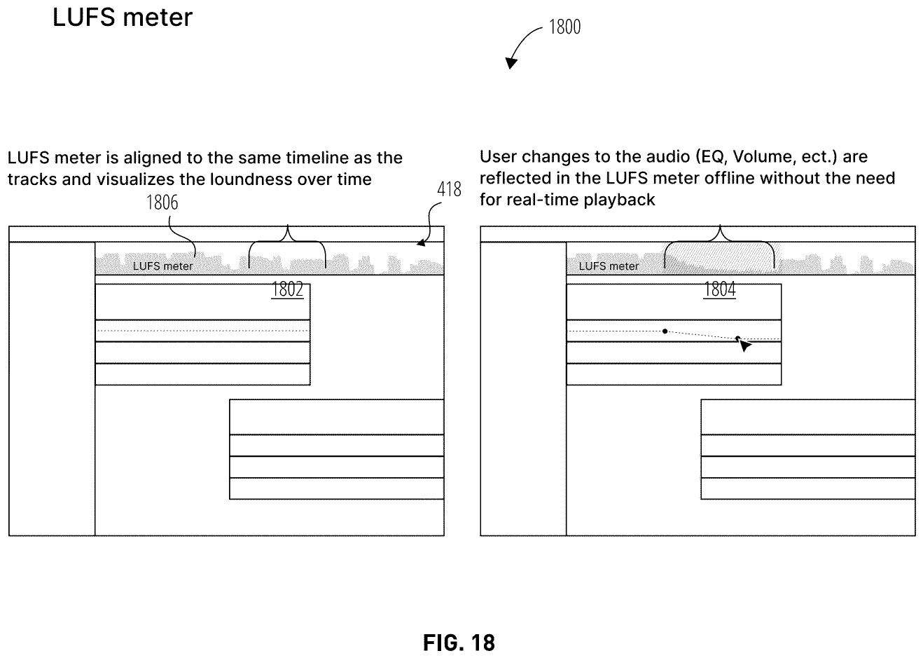

FIG. 18 illustrates the user interface 1800 of the DAW application 144 displaying an integrated loudness metering tool (e.g., LUFS metering tool 418). As described with reference to FIG. 4, the DAW application 144 features a (Loudness Units relative to Full Scale) LUFS metering tool 418 built directly into the multitrack editor 406 timeline view, aligned with the waveforms of the DJ mix tracks.

As shown in FIG. 18, the LUFS metering tool 418 is displayed in a dedicated channel positioned above the multi-track timeline containing the individual audio tracks representing the DJ mix. The multi-track timeline shows each track on a separate lane, with waveform representations of the audio content. A playhead indicator on the timeline may show the current playback position that scrolls during playback of the mix. The timeline has time markings to indicate the duration.

The LUFS metering tool 418 is displayed as a single channel above the multi-track timeline. The channel contains a line graph 1806 indicating the overall loudness of the full mix over time. As the playhead scrolls during playback, the LUFS meter scrolls in sync, with the line graph updating to show loudness values at each point in time. This allows the user to monitor the momentary and short-term loudness of the overall mix. The LUFS meter is integrated directly into the multi-track editor, aligned above the audio tracks, to provide efficient loudness visualization without disrupting workflow.

In addition, the LUFS metering tool 418 may display separate loudness levels for different frequency bands, including low, mid, and high frequencies. This allows the user to monitor the loudness balance across the spectrum.

The LUFS metering tool 418 leverages advanced audio analysis algorithms to determine the loudness values. Specifically, it may analyze the waveform of the combined multitrack audio in real-time, applying auditory models to calculate perceived loudness as would be sensed by the human car. This psychoacoustic analysis provides an objective measurement of loudness comparable to subjective human listening tests. The analysis accounts for factors like frequency sensitivity, masking effects, and temporal integration that impact perceived loudness.

The LUFS metering tool 418 computes these loudness values continuously across the timeline at a high sample rate. It segments the audio into short blocks, analyzes each block applying the auditory models, and aggregates the results to determine instantaneous, short-term, and integrated loudness values. The loudness values are visualized in relation to recommended loudness targets, such as −14 LUFS integrated loudness, to provide a clear reference point for ideal loudness balance. Engineers can diagnose problems and dynamically adjust the mix to maintain optimal loudness throughout the playback.

The LUFS metering tool 418 is integrated into the primary multitrack editor 406 of the DAW application 144 interface displaying the waveforms, avoiding disrupting workflow by eliminating the need for external analysis tools. The tight integration allows audio engineers to monitor loudness as they are editing tracks, applying effects, and adjusting mix levels.

The DAW application 144 contains advanced analysis algorithms that can measure loudness in real-time during playback. It can also rapidly scan sections of the mix waveform to update loudness visualizations, indicated by the diagonal shaded areas.

When the user clicks on a shaded area (e.g., modified segment 1804), the LUFS metering tool 418 will analyze just that segment to provide on-demand loudness data without playing through it.

The LUFS metering tool 418 can visualize historical data in additional modes, such as showing average loudness over longer periods like an entire track or DJ set. Engineers can diagnose problems by examining loudness fluctuations at different zoom levels and time scales.

The DAW application 144 may highlight sections exceeding recommended LUFS loudness levels or balance thresholds between frequency bands. The system can suggest edits to the user based on intelligent loudness analysis, providing an efficient optimization workflow.

The LUFS metering tool 418 may also display momentary loudness, short-term loudness, integrated loudness, loudness range, maximum true peak, and other advanced loudness metrics tailored to the needs of audio engineers and DJs.

The deep integration of loudness metrics within the core DAW 144 interface is tailored to DJ workflows and enables precision mix refinement.

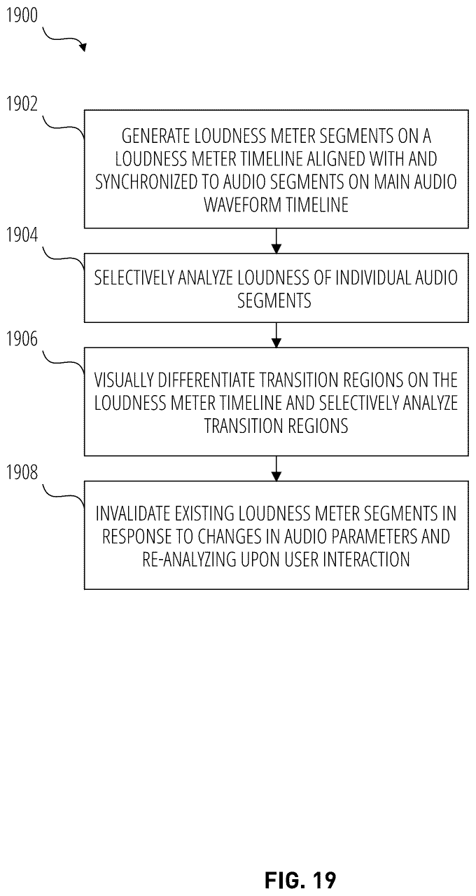

FIG. 19 presents a flowchart illustrating a method 1900 for monitoring and displaying the loudness of an audio signal during playback within a Digital Audio Workstation (DAW). The method 1900 includes several operations that facilitate the real-time analysis of audio loudness and its visualization in a manner that is synchronized with the audio signal's playback position. The graphical representation of loudness is displayed concurrently with the waveform of the audio signal within a unified graphical user interface of the DAW.

The operations in the method 1900 are as follows:

Operation 1902: The method 1900 initiates with the generation of loudness meter segments on a loudness meter timeline within a digital audio workstation (DAW). These segments are aligned with and synchronized to corresponding audio segments on the main audio waveform timeline of the DAW application 144. This precise alignment ensures that the loudness data is accurately associated with the specific audio content being played back or edited within the DAW environment.

The integration of the LUFS (Loudness Units relative to Full Scale) metering tool directly into the DAW's timeline is a distinctive feature that sets this system apart from standalone LUFS meters available in the market. By embedding the LUFS meter within the DAW, users benefit from a seamless workflow where loudness monitoring becomes an integral part of the audio production process. The alignment with the DAW's main audio timeline means that users can visually correlate the loudness information with the audio waveforms, enabling more informed mixing and mastering decisions.

This integration allows for real-time loudness monitoring that is synchronized with the DAW's timeline, providing an immediate and contextually relevant visual representation of loudness levels across the audio project. It may reduce the need for external plugins or applications for loudness analysis, thereby streamlining the audio production process and enhancing the user experience within the DAW.

The aligning of loudness meter segments with audio segments on the main audio waveform timeline within a DAW is accomplished through a series of processes. Initially, the DAW application 144 analyzes the audio waveform data to identify discrete segments, each representing a portion of the audio track. These segments are then used as reference points for the generation of corresponding loudness meter segments.

To enable synchronization, each loudness meter segment is timestamped, matching the start and end points of the associated audio segment. This timestamping process allows the loudness meter to reflect the loudness levels at the intervals of the audio playback or editing operations.

The DAW application 144 maintains a data structure that maps the relationship between the audio waveform segments and the loudness meter segments. As the audio plays back or is edited, the DAW application 144 dynamically updates the loudness meter in real-time, ensuring that the visual representation of loudness remains in lockstep with the audio content.

This embedded LUFS metering capability within the DAW application 144 leverages the computing system's resources to perform real-time analysis of the audio signal. It calculates the loudness values for each segment, then renders these values onto the loudness meter timeline, visually aligning them with the waveform timeline. The result is an integrated and interactive loudness monitoring tool that provides immediate feedback directly within the DAW's graphical user interface, enhancing the audio engineer's ability to make precise adjustments based on both the visual waveform and the measured loudness levels.

Operation 1904: The method involves selectively analyzing the loudness of individual audio segments. When a user interacts with a segment on the loudness meter timeline, the system performs a focused analysis on the corresponding audio portion to determine its loudness values over time.

In some examples, at operation 1904, responsive to a user clicking within a loudness meter segment, the DAW application 144 extracts just the audio portion aligned with that segment based on the internal alignment tracking. This audio portion is passed to a loudness analysis algorithm of the LUFS metering tool 418. The algorithm processes the waveform data to generate loudness values over time just for the selected segment. The loudness analysis is bounded by the start and end points of the clicked loudness meter segment. This selective analysis avoids needing to process the entire timeline to update the loudness data. Only the clicked segments are analyzed on demand, providing rapid selective loudness measurements.

Operation 1906: Transition regions on the loudness meter timeline are visually differentiated. These regions indicate where two audio segments overlap, and the system is configured to selectively analyze these transition regions for loudness changes, which are used during mixing and mastering processes.

The technical process for differentiating transition regions involves analysis of the audio waveform to detect points where the end of one segment meets the beginning of another. This detection is based on a comparison of the timestamps and audio content of adjacent segments. When an overlap is identified, the DAW application 144 marks these regions on the loudness meter timeline with a distinct visual indicator, such as a change in color or shading. This visual cue alerts the user to the presence of a transition, which is a mixing point that often requires loudness balancing.

To perform selective analysis of these transition regions, the DAW application 144 employs specialized algorithms that focus on the crossfade area—the portion where one segment fades out as the next fades in. The algorithms analyze the combined loudness of both segments within the transition region, taking into account factors such as the relative volume levels, the duration of the crossfade, and the presence of any applied effects that might influence perceived loudness.

For example, if a transition region involves a segment with a loud chorus overlapping with a quieter verse, the analysis may reveal a potential loudness spike at the point of overlap. The DAW application 144 then generates loudness data specific to this transition region, allowing the user to make informed decisions about adjusting levels or applying dynamic range compression to smooth out the loudness transition.

By providing detailed loudness information for these critical points, the DAW application 144 aids in achieving a balanced and cohesive final mix, ensuring that transitions between tracks are sonically seamless and meet industry loudness standards.

Operation 1908: Existing loudness meter segments are invalidated in response to changes in audio parameters, such as volume or equalization adjustments that affect loudness. The system prompts the user to re-analyze these segments to update the loudness data, ensuring that the loudness representation remains accurate after any modifications to the audio signal.

In some examples, the technical mechanism behind this operation involves the system's monitoring of parameter changes within the DAW application 144 that could impact the loudness profile of the audio track. When a user adjusts a parameter like volume or EQ, the DAW application 144 detects this change and triggers a flagging process. This process involves marking the loudness meter segments that correspond to the time period of the adjusted audio parameters as outdated or invalid. The visual differentiation, such as a change in color or pattern overlay on the invalidated segments, serves as an indicator to the user that the loudness data for these segments no longer reflects the current state of the audio signal.

Upon invalidation, the DAW application 144 may automatically queue these segments for re-analysis or await user initiation. When the user initiates re-analysis, the system applies the same sophisticated loudness measurement algorithms used during the initial analysis to the altered audio segments. These algorithms reassess the loudness levels by considering the new parameter settings and generate updated loudness values that accurately represent the perceived loudness post-adjustment.

For instance, if a user applies a significant boost to the low-frequency EQ band of a segment, the algorithms will re-calculate the loudness values, taking into account the increased energy in the bass frequencies, which contribute heavily to perceived loudness. Similarly, if a user reduces the overall track volume, the system will adjust the loudness meter to reflect the decrease in loudness across the entire frequency spectrum.

By maintaining an up-to-date representation of loudness, the DAW application 144 ensures that users can rely on the loudness meter as a true reflection of the audio signal's perceived loudness at any point in the editing process. This capability is crucial for audio engineers and producers who need to make precise adjustments to meet broadcast standards, streaming service requirements, or artistic goals for dynamic range and impact.

Overall, FIG. 19 depicts a method 1900 that integrates loudness monitoring tools within a DAW, allowing users to maintain an accurate and up-to-date understanding of the perceived loudness of their audio projects. This integration streamlines the workflow by providing essential loudness information directly within the editing environment, eliminating the need for external analysis tools.

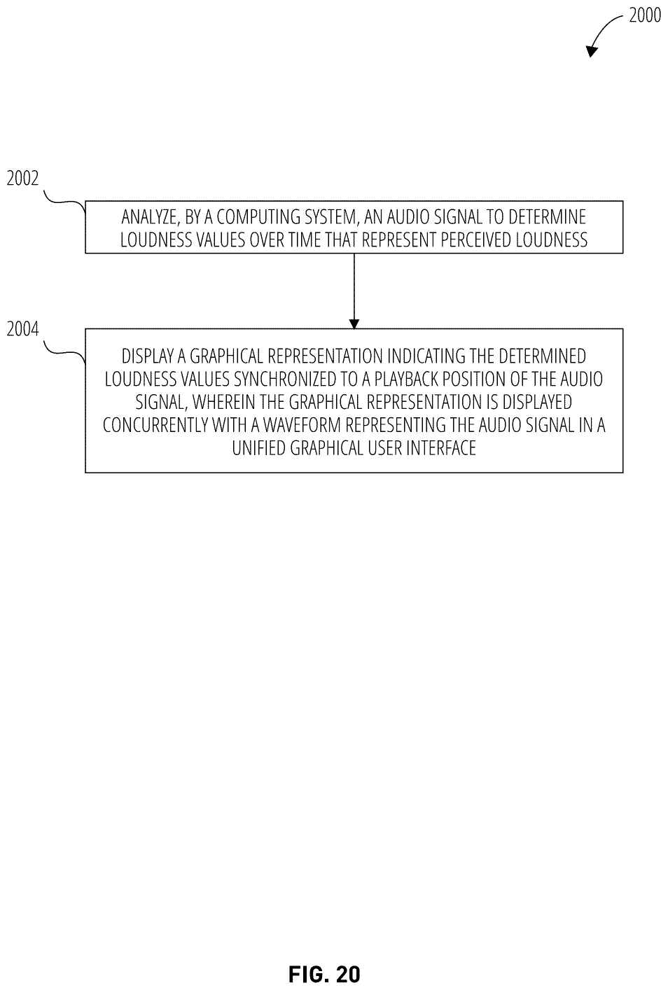

FIG. 20 is a flowchart illustrating a method 2000, according to some examples, of monitoring and displaying loudness of an audio signal during playback within a digital audio workstation (DAW) application, such as DAW application 144. This method is distinct from other loudness meters available in the market, as it involves the integration of a Loudness Unit Full Scale (LUFS) meter directly within the DAW's graphical user interface. The LUFS meter is not only embedded seamlessly into the DAW environment but is also precisely synchronized and aligned with the main audio waveform timeline.

The method 2000 includes generating LUFS meter segments that correspond to and are synchronized with the audio segments on the DAW's main audio waveform timeline. This embedded LUFS meter provides users with real-time visual feedback on the perceived loudness levels of the audio tracks they are working on, directly within the DAW's timeline. The integration of the LUFS meter into the DAW's main audio timeline allows users to make informed loudness adjustments in the context of their overall project, ensuring that loudness levels are consistent and meet both industry standards and personal aesthetic goals.

By embedding the LUFS meter within the DAW and aligning it with the main audio timeline, the method 2000 offers a streamlined and efficient approach to loudness monitoring. This approach is particularly advantageous for audio professionals and enthusiasts who require precision and convenience in their audio editing and mixing processes. The method 2000 enhances the user's ability to achieve optimal loudness levels across their project, contributing to higher quality audio production.

In operation 2002, the method 2000 analyzes, by a computing system, an audio signal to determine loudness values over time that represent perceived loudness.

In some examples, the LUFS metering tool 418 of the DAW application 144 segments the audio signal into discrete blocks of audio samples and applies a psychoacoustic model to each block that analyzes spectral content across audible frequency bands. The psychoacoustic model determines time-varying loudness values in low, mid, and high-frequency regions to estimate perceived loudness of each block. Loudness values are computed by applying auditory filters modeling the frequency sensitivity of human hearing. The loudness values for each block are aggregated to determine instantaneous, short-term, and integrated loudness measurements over time.

In some examples, the loudness values may be determined using machine learning models trained to predict perceived loudness based on audio features. The models may analyze spectral content, amplitude envelopes, and other audio characteristics to estimate loudness.

In operation 2004, the LUFS metering tool 418 generates and causes the presentation (or display) of a graphical representation indicating the determined loudness values synchronized to a playback position of the audio signal, wherein the graphical representation is displayed concurrently by the LUFS metering tool 418 with a waveform representing the audio signal in a unified graphical user interface of the multitrack editor 406 of the DAW application 144.

For example, the graphical representation includes separate loudness meters for low, mid, and high-frequency regions plotted over time. The loudness meters comprise line graphs or bar indicators showing the loudness values in each frequency band at each moment in the audio. A playback head indicator on the meters shows the current playback position synchronized with the waveform display.

Alternatively, the graphical representation may use colors rather than line graphs to indicate loudness, with color intensity representing the loudness level and colored segments scrolling in sync with playback. The unified interface displays the graphical meters aligned directly above or below the waveform to facilitate comparison.

In some examples, the audio signal being analyzed comprises a musical recording such as a DJ mix recording. The graphical loudness meter enables DJs to monitor the perceived loudness of the mix in real-time while arranging and editing.

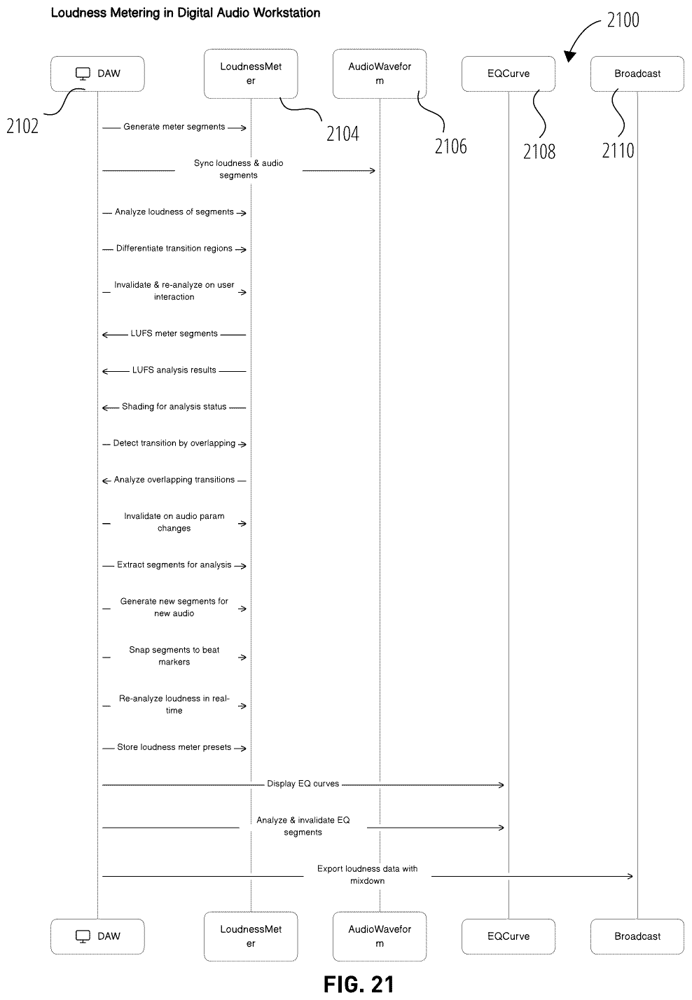

FIG. 21 is an interaction diagram 2100 illustrating a method, according to some examples, of monitoring and displaying loudness of an audio signal during playback.

Building upon the loudness metering capabilities introduced in previous figures, FIG. 21 provides a detailed view of the interactions between system components that enable the LUFS metering tool 418 described in FIG. 18. While FIG. 18 illustrated the user interface aspects of the loudness metering tool, and FIG. 19 and FIG. 20 outlined the methodological operations for monitoring and displaying loudness, FIG. 21 now reveals the underlying component interactions and data flows that implement these capabilities within the digital audio workstation environment.

FIG. 21 depicts a communication framework between five example components arranged horizontally across the top: DAW 2102, loudness meter 2104, audio waveform 2106, EQ curve 2108, and broadcast 2110. These components exchange information through a series of directed messages that form a workflow. In some examples, these messages may be implemented as function calls between software modules, event-driven notifications, or asynchronous data transfers through a message queue architecture.

The process initiates at the DAW 2102 component with meter segment generation. This operation transmits initialization data to the loudness meter 2104 as indicated by the rightward arrow. In some examples, this generation process may involve creating specialized data structures that represent discrete segments of the audio timeline, with each segment containing metadata such as timestamp boundaries, track identifiers, and reference pointers to the corresponding audio samples.

Following initialization, the DAW 2102 performs timeline synchronization between loudness and audio segments. This coordination mechanism provides temporal alignment between different data representations. In some examples, this synchronization may employ a shared timeline reference system where each loudness meter segment maintains bidirectional links to its corresponding audio waveform segment, enabling navigation and modification across multiple visualization layers.

The DAW 2102 then conducts segment loudness analysis, a computational process that transforms raw audio data into perceptual loudness metrics. In some examples, this analysis may implement the ITU-R BS.1770 algorithm that applies frequency weighting filters to simulate human hearing sensitivity across the audible spectrum, followed by mean-square calculation and integration over specified time windows to derive momentary (400 ms), short-term (3s), and integrated loudness values.

The system employs transition region differentiation to identify and process boundary areas between audio segments. In some examples, this differentiation algorithm may detect potential discontinuities by analyzing amplitude gradients, spectral content changes, and phase correlation between adjacent segments, then flag these regions for specialized processing that can help ensure smooth loudness transitions.

The DAW 2102 implements an invalidation and re-analysis mechanism that responds to user modifications of the audio content. This adaptive update system can contribute to analysis efficiency. In some examples, this mechanism may employ a dependency tracking system that monitors which audio parameters affect which loudness calculations, creating a directed graph of dependencies that allows selective recalculation of only the affected loudness values when specific parameters change.

The loudness meter 2104 generates response data including LUFS meter segments, which are visual representations of the calculated loudness values. In some examples, these segments may be implemented as vector graphics objects containing multiple data channels for different loudness metrics (e.g., integrated, short-term, momentary) and frequency bands (e.g., low, mid, high), with each channel rendered as a separate visualization layer that can be independently shown or hidden.

The loudness meter 2104 provides detailed analysis results that quantify the perceived loudness characteristics of the audio. In some examples, these results may include statistical distributions of loudness values, identification of potential loudness compliance considerations according to broadcast standards like EBU R128 or ATSC A/85, and suggestions for adjustments to meet target loudness specifications.

The system utilizes visual status indication through shading techniques that communicate analysis state information. In some examples, this visual encoding may implement a multi-level shading system where light gray indicates segments awaiting analysis, darker gray indicates transition regions that may benefit from special attention, and color gradients represent the confidence level of the analysis based on factors such as signal-to-noise ratio and presence of potentially challenging audio content.

The diagram illustrates transition detection through overlap analysis, an algorithmic approach to identifying mixing points between audio segments. In some examples, this detection process may employ cross-correlation techniques that compare waveform characteristics across segment boundaries, combined with beat detection algorithms that identify rhythmic alignment points to determine potentially suitable transition locations.

The system performs a focused transition analysis that allocates computational resources to mixing regions. In some examples, this specialized analysis may apply psychoacoustic masking models to evaluate whether potential loudness discontinuities at transition points would be perceptible to listeners, and automatically suggest crossfade durations or gain adjustments to create perceptually smooth transitions.

The DAW 2102 implements parameter-based invalidation that responds to audio processing changes by marking affected analysis results as outdated. In some examples, this invalidation system may maintain a parameter dependency graph that tracks which audio effects and processing stages influence loudness characteristics, allowing the system to identify which loudness segments need recalculation when specific parameters like equalization curves, compression thresholds, or volume levels are modified.

The system provides segment extraction capabilities that isolate specific portions of audio for targeted analysis. In some examples, this extraction process may implement non-destructive audio region selection that creates virtual audio segments referencing the original audio data, with applied processing parameters stored as metadata rather than modifying the underlying samples, enabling analysis of multiple processing variations.

The DAW 2102 features dynamic segment generation that automatically creates new analysis regions when audio content changes. In some examples, this adaptive segmentation may employ machine learning algorithms trained to identify acoustic boundaries in the audio, automatically creating appropriate segment divisions at points where timbre, instrumentation, or arrangement characteristics change substantially.

The system implements beat-aligned segmentation through a snapping mechanism that aligns analysis regions with musical elements. In some examples, this alignment system may utilize multi-resolution beat detection that identifies both beat-level and bar-level musical structures, then quantizes segment boundaries to these rhythmic divisions to help ensure that loudness analysis corresponds meaningfully to musical phrases and sections.

The DAW 2102 provides real-time loudness analysis capabilities that deliver feedback during playback or editing. In some examples, this real-time system may implement a multi-threaded processing architecture where background threads continuously analyze audio segments ahead of the playback position, with results cached and available when the playhead reaches those segments, combined with predictive analysis that anticipates likely playback paths based on editing patterns.

The system may support configuration persistence through preset storage functionality that preserves loudness monitoring settings. In some examples, this preset system may store not only basic parameters like target loudness levels and visualization preferences, but also configuration data such as custom weighting curves for different musical genres, loudness tolerance thresholds for different delivery platforms, and automated correction settings for common loudness considerations.

The diagram shows integration with equalization visualization through the EQ curve 2108 component. In some examples, this integration may synchronize frequency-domain representations with loudness measurements, allowing users to visualize how specific frequency adjustments correlate with perceived loudness changes across different parts of the spectrum, with interactive capabilities to adjust EQ settings directly from the loudness visualization interface.

The system extends its analysis capabilities to equalization through EQ segment analysis and invalidation. In some examples, this extended analysis may implement frequency-dependent loudness modeling that predicts how specific equalization changes will affect perceived loudness before those changes are applied, enabling users to preview loudness impacts of potential EQ adjustments.

The diagram concludes with broadcast integration through the broadcast 2110 component, enabling loudness data export with audio mixdown. In some examples, this export functionality may embed standardized loudness metadata in industry-standard file formats like BWF (Broadcast Wave Format) with integrated loudness descriptors compliant with ITU-R BS.1770 specifications, helping to ensure that loudness information is preserved throughout the broadcast chain and correctly interpreted by downstream processing systems.

Although the example method 2100 depicts a particular sequence of operations, the sequence may be altered without departing from the scope of the present disclosure. For example, some of the operations depicted may be performed in parallel or in a different sequence that does not materially affect the function of the method 2100. In some examples, different components of an example device or system that implements the method 2100 may perform functions at substantially the same time or in a specific sequence.

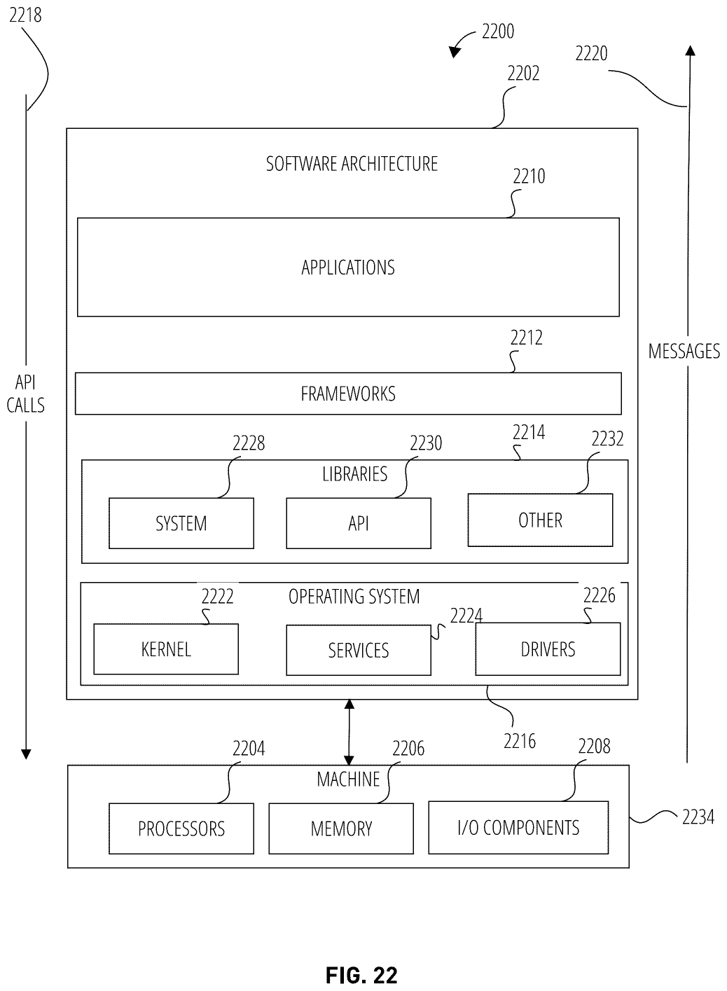

FIG. 22 is a block diagram 2200 showing a software architecture 2202, which can be installed on any devices like smartphones, tablets, or computers. The software architecture 2202 runs on hardware like a machine 2234 with processors 2204, memory 2206, and I/O components 2208. In this example, the software architecture 2202 has layers that each provide specific functions. The layers are applications 2210, frameworks 2212, libraries 2214, and an operating system 2216.

In operation, the applications 2210 make API calls 2218 through the software stack and get messages 2220 back responding to the API calls 2218.

The operating system 2216 handles hardware resources and common services. It includes a kernel 2222, services 2224, and drivers 2226. The kernel 2222 abstracts the hardware for the other software. It handles memory, processing, components, networking, security, and more. The services 2224 provide common services to the layers. The drivers 2226 control and interface with the hardware. Examples are display, camera, Bluetooth, flash memory, USB, Wi-Fi, audio, and power drivers.

The libraries 2214 have low-level code the applications 2210 use. The libraries 2214 include system libraries 2228 like the C standard with functions for memory, strings, math, and more. They also have API libraries 2230 like media, graphics, database, web, and other libraries 2232. The graphics libraries render 2D and 3D graphics.

The frameworks 2212 have high-level common infrastructure the applications 2210 use. For example, they provide graphical user interfaces, resource management, location services, and other APIs.

The applications 2210 execute program functions using languages like Objective-C, Java, C++, C, or assembly. For example, a third-party application may be made with the iOS or Android SDK by another company. It uses the operating system's 2216 APIs.

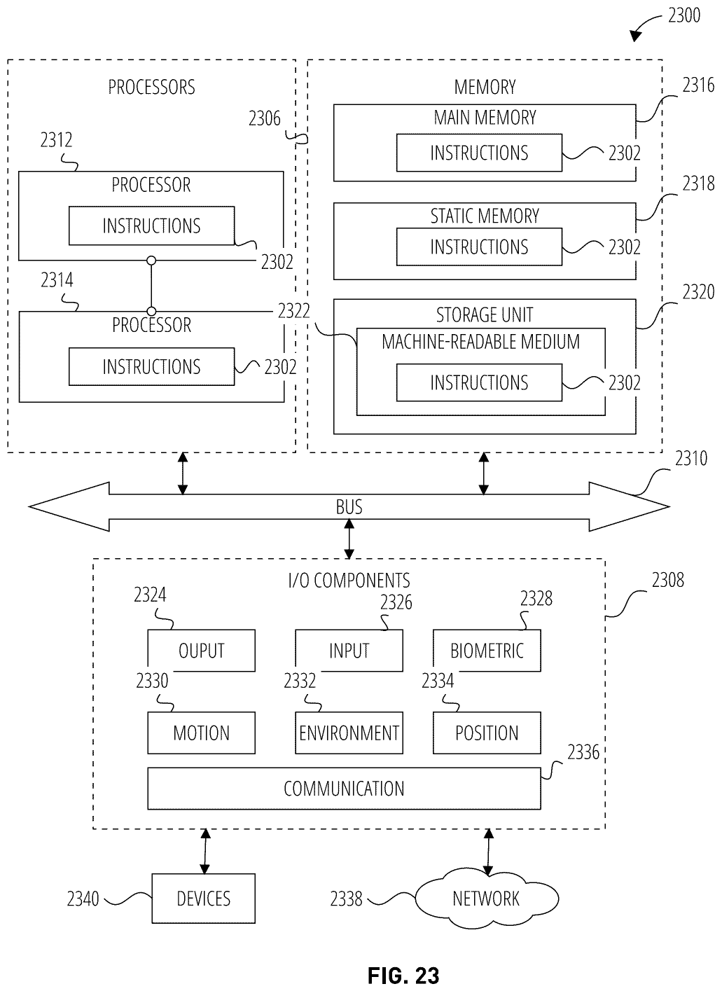

FIG. 23 is a diagrammatic representation of the machine 2300 within which instructions 2302 (e.g., software, a program, an application, an applet, an app, or other executable code) for causing the machine 2300 to perform any one or more of the methodologies discussed herein may be executed. For example, the instructions 2302 may cause the machine 2300 to execute any one or more of the methods described herein. The instructions 2302 transform the general, non-programmed machine 400 into a particular machine 2300 programmed to carry out the described and illustrated functions in the manner described. The machine 2300 may operate as a standalone device or be coupled (e.g., networked) to other machines. In a networked deployment, the machine 2300 may operate in the capacity of a server machine or a client machine in a server-client network environment, or as a peer machine in a peer-to-peer (or distributed) network environment. The machine 2300 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2302, sequentially or otherwise, that specify actions to be taken by the machine 2300. Further, while a single machine 2300 is illustrated, the term “machine” may include a collection of machines that individually or jointly execute the instructions 2302 to perform any one or more of the methodologies discussed herein.

The machine 2300 may include processors 2304, memory 2306, and I/O components 2308, which may be configured to communicate via a bus 2310. In some examples, the processors 2304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), a Tensor Processing Unit (TPU), a Neural Processing Unit (NPU), a Vision Processing Unit (VPU), a Machine Learning Accelerator (MLA), a Cryptographic Acceleration Processor, a Field-Programmable Gate Array (FPGA), a Quantum Processor, another processor, or any suitable combination thereof) may include, for example, a processor 2312 and a processor 2314 that execute the instructions 2302.

Although FIG. 23 shows multiple processors 2304, the machine 2300 may include a single processor with a single core, a single processor with multiple cores (e.g., a multi-core processor), multiple processors with a single core, multiple processors with multiples cores, or any combination thereof. Modern processor architectures include superscalar, very long instruction word (VLIW), vector processor, multi-core, manycore, neuromorphic, and quantum architectures.

The memory 2306 includes a main memory 2316, a static memory 2318, and a storage unit 2320, both accessible to the processors 2304 via the bus 2310. The main memory 2306, the static memory 2318, and storage unit 2320 store the instructions 2302 embodying any one or more of the methodologies or functions described herein. The instructions 2302 may also reside, wholly or partially, within the main memory 2316, within the static memory 2318, within machine-readable medium 2322 within the storage unit 2320, within the processors 2304 (e.g., within the processor's cache memory), or any suitable combination thereof, during execution thereof by the machine 2300.

The I/O components 2308 may include various components to receive input, provide output, produce output, transmit information, exchange information, or capture measurements. The specific I/O components 2308 included in a particular machine depend on the type of machine. For example, portable machines such as mobile phones may include a touch input device or other such input mechanisms, while a headless server machine will likely not include such a touch input device. The I/O components 2308 may include many other components not shown in FIG. 23. In various examples, the I/O components 2308 may include output components 2324 and input components 2326. The output components 2324 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 2326 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 2308 may include biometric components 2328, motion components 2330, environmental components 2332, or position components 2334, among a wide array of other components. For example, the biometric components 2328 could include components to detect expressions (e.g., hand gestures, facial expressions, vocal expressions, body movements, or eye tracking) or measure biosignals (e.g., heart rate, blood pressure, body temperature, perspiration, or brain waves) in an aggregate, anonymous way that does not identify individuals. Technologies like facial recognition, fingerprint identification, voice identification, retinal scanning, or electroencephalogram-based identification are of course only be implemented with explicit informed consent from users, if at all. When biometric data is collected, it is minimized, encrypted, and accessed only for authorized purposes. Users are able to opt-out of biometric collection by the biometric components 2328 and have their data permanently deleted. With proper consent, security protections, data minimization, and respect for user privacy, certain biometric components may be implemented ethically.

The motion components 2330 include acceleration sensor components (e.g., accelerometer), gravitation sensor components, rotation sensor components (e.g., gyroscope). The environmental components 2332 include, for example, one or cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 2334 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2308 further include communication components 2336 operable to couple the machine 2300 to a network 2338 or devices 2340 via respective coupling or connections. For example, the communication components 2336 may include a network interface Component or another suitable device to interface with the network 2338. In further examples, the communication components 2336 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2340 may be another machine or any of a wide variety of peripheral devices (e.g., a peripheral device coupled via a USB).

Moreover, the communication components 2336 may detect identifiers or include components operable to detect identifiers. For example, the communication components 2336 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 2336, such as location via Internet Protocol (IP) geolocation, location via Wi-Fi® signal triangulation, or location via detecting an NFC beacon signal that may indicate a particular location.

The various memories (e.g., main memory 2316, static memory 2318, and/or memory of the processors 2304) and/or storage unit 2320 may store one or more sets of instructions and data structures (e.g., software) embodying or used by any one or more of the methodologies or functions described herein. These instructions (e.g., the instructions 2302), when executed by processors 2304, cause various operations to implement the disclosed examples.

The instructions 2302 may be transmitted or received over the network 2338, using a transmission medium, via a network interface device (e.g., a network interface component included in the communication components 2336) and using any one of several well-known transfer protocols (e.g., hypertext transfer protocol (HTTP)). Similarly, the instructions 2302 may be transmitted or received using a transmission medium via a coupling (e.g., a peer-to-peer coupling) to the devices 2340.

### Example Technical Problems

### Difficulty Recording Complete High-Quality DJ Sets for Later Editing and Publishing Due to the Real-Time Manual Nature of DJ Performances.

Some examples seek to provide a solution to the long-standing challenge DJs face in recording complete, high-fidelity sets for later editing and publishing. This issue arises from the inherently real-time, manual nature of DJ performances. Unlike a typical musical performance where the artist plays pre-composed songs, DJ sets involve live, improvised mixing and transitioning between tracks. DJs manually beatmatch tempos, adjust audio levels, apply effects, loop samples, and sequence tracks on-the-fly using hardware DJ mixers and media players. This precludes simply recording the output, as any mistakes cannot be corrected and the DJ must re-perform the entire set flawlessly. The complex, rapid manipulations DJs perform also makes it effectively impossible to manually notate actions taken in real-time.

To address this, examples systems may tap directly into the data streams from networked DJ equipment such as DJ media players and mixers. This provides access to a rich representation of the DJ's performance at an atomic level. Specifically, the system receives and logs data stream from a set of DJ media players 106. This contains detailed information on cues, loops, tracks played, and other granular media player actions. Concurrently, the system logs the MIDI data stream from the mixer, capturing every knob twist, slider adjustment, and button press on the hardware mixer surface. Logging these two streams simultaneously creates a comprehensive digital record of the live DJ performance, including both track playback operations and real-time mixer manipulations.

This performance data then feeds into a specialized converter algorithm. The converter processes the raw equipment data streams into an editable digital audio file optimized for post-processing in DJ-centric editing software. The converter applies domain-specific assumptions and heuristics based on analysis of common DJ workflows. For example, it can infer probable cue points based on the track metadata and snap imprecise loop timings to the nearest beat grid. This results in a high-fidelity representation of the complete DJ set-effectively “recording the hands” by sourcing data directly from the equipment. The generated file provides the basis for subsequent editing, allowing the DJ to polish transitions, tweak effects, adjust levels, remove mistakes, and finalize arrangements.

In summary, by creating a bridge between DJ gear networks and software environments, example systems may enable reliable recording of complete DJ performances. No longer limited to real-time outputs, DJs can leverage the system to capture sets flawlessly and promote their art through high-quality recordings. This advancement stands to expand creative possibilities for DJs and refine the listening experience for electronic music fans across mediums. The system thus addresses a longstanding limitation and provides a foundation for new creative workflows in the DJ ecosystem.

### Lack of Interoperability Between DJ Equipment Networks and Protocols Hinders Logging Performance Data.

A challenge facing DJs is the inability to comprehensively log performance data due to equipment networks. Most professional DJ setups utilize media players and mixers from major brands. These operate on protocols that enable advanced features but limit interoperability with other systems. Meanwhile, widespread protocols like MIDI provide more flexibility for communication between musical devices but lack the specialized control signaling of DJ networks. This dichotomy hinders the seamless logging of granular performance data from a complete DJ rig.

Example systems described herein provide an innovative solution to bridge this gap. Some examples create a conduit between DJ equipment networks and standard protocols by concurrently logging and synchronizing data streams in both formats. Specifically, the system taps into the data from a set of DJ media players 106 in parallel with the MIDI data from a mixer. This is achieved by interfacing with the network which carries detailed media player actions and also receiving the MIDI signal containing real-time mixer activity.

By aggregating both data streams in a time-aligned fashion, the example systems may construct a comprehensive digital representation of the live performance. This addresses the limitations of the disparate protocols. DJ network protocols may provide precise cues, loops, and other granular playback operations unavailable over MIDI. Meanwhile, MIDI conveys continuous controller data for knobs, sliders, and buttons operated on the mixer. Combining this data yields a complete low-level recording of the performance that would be impossible from either source independently.

The synchronized data streams are stored without modification, preserving the native formats. This raw performance capture can then be processed by a specialized converter algorithm. The converter interprets the data based on domain knowledge of typical DJ techniques. It makes informed assumptions to generate an editable post-processed file optimized for DJ software. This workflow from equipment data to editable audio files is possible because the system bridges the gap between protocols.

In summary, by concurrently logging events and MIDI streams in a time-aligned manner, the example systems enable interoperability between the multiple protocols. This facilitates the detailed recording of granular DJ performance data previously hindered by the disconnect between networks. The generated digital representation expands creative possibilities for DJs through integrated editing workflows. The system thus addresses a significant technical barrier and demonstrates the power of bridging specialized and widespread protocols within a musical ecosystem.

Inability to Propagate Downstream Changes when Editing Recorded DJ Mixes in Current DAWs.

A limitation DJs face when editing recorded sets in DAW software is the inability to efficiently propagate downstream changes across the mix. For example, if a DJ needs to adjust the start time of one track in the timeline, existing DAWs do not automatically shift subsequent tracks downstream to maintain continuity. The DJ must manually drag each affected clip one by one-a tedious and error-prone process. This destroys the intended flow and continuity of transitions when making localized edits.

Similarly, removing one track in a DJ mix using standard DAWs leaves an empty gap in the timeline. The DJ must manually close this gap by dragging all subsequent tracks forward to join the segments back together. Again, this is a manual, disconnected process that fails to maintain a seamless flow when editing.

The example systems described herein enable propagating downstream changes when editing recorded DJ mixes. Specifically, an editing interface and underlying algorithms automatically adjust downstream segments based on localized edits. This mirrors the mental model of a DJ mixing live and avoids breaking continuity.

For example, when a DJ adjusts the start time of one track, example systems may automatically shift subsequent tracks downstream by the same amount. This maintains the precise transition timing intended by the DJ. Similarly, removing a track from the mix triggers the system to intelligently abut downstream tracks to close the gap and reconnect the segments. The mix retains seamless flow despite removing elements.

This downstream propagation occurs in real-time as edits are made, keeping the mix intact. The DJ can experiment freely without tedious manual work to rearrange clips. The editing environment reflects the mindset of transitioning tracks as a unified flow rather than disconnected segments.

In summary, by incorporating automatic downstream mix propagation, the example systems described here seek to address significant pain points when editing recorded DJ sets. They enable quick experimentation and refinement that maintains intended continuity and flow. This facilitates more creative freedom during post-production without the headaches of manually repairing transitions. The system brings DJ workflows upstream into the editing process for a more unified environment.

### Integrated Tools in DAWs for Monitoring Perceived Loudness of Audio Signals.

While digital audio workstations (DAWs) provide various tools for editing and mixing audio, systems may lack integrated meters to monitor perceived loudness levels in real-time during playback. DAWs may rely on peak signal meters or basic volume controls, but these do not indicate how loud a mix will sound to the human ear. This requires audio engineers to utilize external plugins or applications to analyze loudness, disrupting workflow. The lack of integrated, intelligent loudness metering hampers efficient editing and mixing in DAW environments.

The example systems described herein incorporate loudness monitoring capabilities in order to address this limitation. Specifically, the example DJ audio workstation software may feature an intelligent LUFS (Loudness Units relative to Full Scale) meter built directly into the timeline view.

This integrated LUFS meter analyzes the audio in real-time during playback to determine perceived loudness based on human hearing. The system displays a multi-channel graphical representation indicating momentary and short-term loudness across the frequency spectrum. For example, the interface may show separate loudness levels for low, mid, and high-frequency bands. The loudness meters scroll in sync during playback, providing an intuitive visualization of loudness changes over time.

Engineers may use this tool while editing and mixing to optimize loudness levels. For example, the system could indicate insufficient low-frequency content during a bass drop or overly loud peaks distorting the mix. The editor can adjust the mix based on this real-time feedback to achieve desired loudness targets. The integrated nature avoids disrupting workflow by eliminating the need for external analysis tools.

Additional metering modes may display historical loudness data. For example, engineers could examine average loudness over the entire track or zoom in to inspect detailed short-term fluctuations. The system may also highlight sections exceeding recommended loudness levels to quickly identify problem areas. Intelligent assistance features could suggest edits to improve loudness balance.

In summary, by incorporating integrated loudness metering technology, the example systems seek to provide DJs and audio engineers with an efficient loudness optimization workflow. This would address a significant blind spot in existing DAWs, leading to better balanced, listener-optimized mixes. The system stands to benefit all content creators working in the digital audio realm.

Challenges in Integrating Multi-Source Data from Diverse DJ Equipment

An example technical challenge in DJ performance recording is the integration of data from multiple hardware sources operating on different protocols and timebases. Professional DJ setups typically involve multiple media players (often 2-4 decks) and a mixer, each generating distinct data streams. These devices operate on separate communication protocols-media players using proprietary networking protocols for track synchronization and mixers typically using MIDI or other control interfaces. The technical difficulty lies in capturing, synchronizing, and meaningfully combining these disparate data sources into a coherent representation.

Example systems address this challenge through a multi-receiver architecture that simultaneously interfaces with both the DJ equipment network and the mixer's control output. The logger 112 implements specialized receivers for each protocol—the DJ media player receiver 114 connects to the network to capture detailed playback data from all connected media players, while the MIDI receiver 120 interfaces with the mixer to log control adjustments. This dual-protocol approach enables comprehensive data capture from the entire DJ ecosystem rather than just a single component. The message parser 124 then applies precise timestamp synchronization to align events from these different sources despite their varying transmission latencies and update rates. This multi-source integration enables the system to reconstruct the complete performance context—which tracks were playing on which decks, how they were being mixed, and what effects were applied—information that would be impossible to derive from any single data stream alone.

### Technical Challenges in Post-Processing and Synchronizing Imperfect Performance Data

Raw data captured from DJ equipment may present a technical challenge for accurate reconstruction. DJ performance data is inherently imperfect—it contains timing inconsistencies, missing state information, and protocol-specific limitations. For example, DJ media players may not report their initial state upon connection, mixer control movements may have variable resolution depending on the control type, and network packets can arrive out of sequence due to transmission delays.

Example systems seek to overcome these challenges through post-processing algorithms specifically designed for DJ performance data. The converter 140 applies domain-specific knowledge to interpret and refine the raw data streams. This includes quantizing imprecise timing events to the nearest beat grid position, inferring missing initial states based on subsequent events, and applying musical assumptions derived from common DJ practices. The system also implements specialized synchronization techniques that align events from different sources based on musical time rather than just clock time, ensuring that actions like track transitions and effect applications are properly correlated despite being captured through different data streams. By addressing the inherent imperfections in DJ performance data through intelligent post-processing, the system produces a high-fidelity digital representation that accurately reflects the DJ's creative intent rather than just the raw equipment signals.

### Technical Limitations of Audio-Only Recording Versus Structured Metadata Preservation

Traditional approaches to recording DJ performances may capture only the final audio output, resulting in significant limitations for post-production. Such recordings lose all the structural information about the performance—the individual tracks used, precise transition points, effect parameters, and other creative decisions made by the DJ. This creates a technical barrier to high-quality editing, as the resulting audio file contains a flattened representation with no access to the component elements.

Example systems seek to solve this problem through a different approach that preserves the original track files and structured metadata rather than just recording audio output. The system generates a digital representation that maintains references to the original high-quality audio files used in the performance, along with precise metadata about how they were manipulated. This structured approach creates track objects 302 that contain references to the source audio content along with all associated metadata, clip objects 304 that define exactly which segments of those tracks were used, processor objects 306 that capture all effect parameters and automation, and tempo objects 308 that preserve timing information. By maintaining this structured representation rather than flattening to audio, the system enables non-destructive editing with access to the original high-quality source material. This allows DJs to make precise adjustments to transitions, extend sections, replace tracks, or modify effects parameters while maintaining the overall structure and flow of the performance-capabilities that would be technically impossible with traditional audio recording approaches.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list. Likewise, the term “and/or” in reference to a list of two or more items, covers all of the following interpretations of the word: any one of the items in the list, all of the items in the list, and any combination of the items in the list.

The various features, steps, operations, and processes described herein may be used independently of one another or may be combined in various ways. All possible combinations and sub-combinations are intended to fall within the scope of this disclosure. In addition, certain method or process blocks, or operations may be omitted in some implementations.

The term “operation” is used to refer to elements in the drawings of this disclosure for case of reference and it will be appreciated that each “operation” may identify one or more operations, processes, actions, or steps, and may be performed by one or multiple components.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Terms

“Network” may include one or more portions of a network that are coupled together to form an end-to-end communication path between two points. The communication network may be comprised of multiple network portions using different permutations and combinations of network types.

Example network portions may include:
An ad hoc network
An intranet
An extranet
A virtual private network (VPN)
A local area network (LAN)
A wireless LAN (WLAN)
A wide area network (WAN)
A wireless WAN (WWAN)
A metropolitan area network (MAN)
The Internet.
A portion of the Internet.
A portion of the Public Switched Telephone Network (PSTN)
A plain old telephone service (POTS) network
A cellular telephone network
A wireless network
A Wi-Fi® network
Another type of network
A combination of two or more such networks

Specific examples may include:
5G networks
Low power wide area networks (LPWANs) like LoRaWAN or Sigfox.
Narrowband internet of things (NB-IoT)
6G networks
Bluetooth
Zigbee
Thread
Z-Wave
Near Field Communication (NFC)
Radio Frequency Identification (RFID)
Message Queuing Telemetry Transport (MQTT)
Constrained Application Protocol (CoAP)
Controller Area Network (CAN) bus
FlexRay
Bluetooth
Zigbee
Thread
Body area networks (BANs)
Wireless USB

Example communication networks may utilize a variety of data transfer technologies, such as:
Single Carrier Radio Transmission Technology (1×RTT)
Evolution-Data Optimized (EVDO) technology
General Packet Radio Service (GPRS) technology
Enhanced Data rates for GSM Evolution (EDGE) technology
Third Generation Partnership Project (3GPP) including 3G
Fourth-generation wireless (4G) networks
Universal Mobile Telecommunications System (UMTS)
High-Speed Packet Access (HSPA)
Worldwide Interoperability for Microwave Access (WiMAX)
Long Term Evolution (LTE) standard
Others defined by various standard-setting organizations
Other long-range protocols
Other data transfer technology.

“Component” may include a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner In some examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. A decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of methods described herein may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In some examples, the processors or processor-implemented components may be distributed across a number of several geographic locations.

“Non-transitory computer-readable medium” refers, for example, to one or more storage devices and media (e.g., a centralized or distributed database, and associated caches and servers) that store executable instructions, routines, and data. The term specifically excludes intangible carrier waves, modulated data signals, and other such media, at least some of which are covered under the term “signal medium.” The term shall accordingly be taken to include, but not be limited to, solid-state memories, and optical and magnetic media, including memory internal or external to processors. Specific examples of non-transitory machine-readable media, non-transitory computer-readable media, and device-readable media may include non-volatile memory, including by way of example semiconductor memory devices, e.g., erasable programmable read-only memory (EPROM), electrically erasable programmable read-only memory (EEPROM), Field Programmable Gate Array (FPGA), and flash memory devices; magnetic disks such as internal hard disks and removable disks; magneto-optical disks; CD-ROM and DVD-ROM disks; solid state drives (SSD); USB flash drives; memory cards such as SD cards, microSD cards, CompactFlash cards; optical discs such as Blu-ray discs; as well as cloud storage and network attached storage (NAS). Additional examples include read-only memory (ROM), programmable read-only memory (PROM), ferroelectric RAM (FRAM), phase-change memory (PCM), resistive RAM (RRAM), memristors, racetrack memory, and magnetic tape. The terms “non-transitory machine-readable medium,” “non-transitory device-readable medium,” and “non-transitory computer-readable medium” mean the same thing and may be used interchangeably in this disclosure.

“Module” refers to logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example examples, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some examples, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In examples in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Processor” may include any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

A processor may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently.

A processor may be emulated in software, running on a physical processor, as a virtual processor or virtual circuit. The virtual processor may behave like an independent processor but is implemented in software rather than hardware.

“Signal Medium” refers to any intangible medium that is capable of storing, encoding, or carrying the instructions for execution by a machine and includes digital or analog communications signals or other intangible media to facilitate communication of software or data. The term “signal medium” may include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

### Examples

### Example Set 1

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a computer-implemented method for logging performance data from musical devices, the method comprising: receiving, by a computing system, a first data stream containing performance data from a first musical device communicating via a first protocol; receiving, by the computing system, a second data stream containing performance data from a second musical device communicating via a second protocol; synchronizing, by the computing system, the first data stream and the second data stream based on timestamp data; and storing, by the computing system, the synchronized first and second data streams including the timestamp data.

In Example 2, the subject matter of Example 1 includes, wherein the first protocol comprises a digital DJ equipment networking protocol.

In Example 3, the subject matter of Example 2 includes, wherein the digital DJ equipment networking protocol enables synchronized playback between networked media players.

In Example 4, the subject matter of Examples 1-3 includes, wherein the second protocol comprises a standard musical equipment networking protocol.

In Example 5, the subject matter of Example 4 includes, wherein the standard musical equipment networking protocol comprises MIDI (Musical Instrument Digital Interface).

In Example 6, the subject matter of Examples 1-5 includes, wherein the first musical device comprises a media player.

In Example 7, the subject matter of Example 6 includes, wherein the media player comprises a DJ media player.

In Example 8, the subject matter of Examples 1-7 includes, wherein the second musical device comprises an audio mixer.

In Example 9, the subject matter of Example 8 includes, wherein the audio mixer comprises a hardware DJ mixer.

In Example 10, the subject matter of Examples 1-9 includes, receiving, by the computing system, the timestamp data from the first musical device and the second musical device.

In Example 11, the subject matter of Example 10 includes, wherein the timestamp data indicates a time each data packet in the data streams was generated.

In Example 12, the subject matter of Examples 1-11 includes, wherein synchronizing comprises interleaving the first data stream and the second data stream chronologically based on the timestamp data.

In Example 13, the subject matter of Examples 1-12 includes, processing, by the computing system, the synchronized data streams into a combined formatted data stream.

In Example 14, the subject matter of Example 13 includes, storing, by the computing system, the combined formatted data stream.

In Example 15, the subject matter of Examples 1-14 includes, wherein storing comprises writing the synchronized data streams to a storage medium without modification.

In Example 16, the subject matter of Examples 1-15 includes, wherein the synchronized data streams provide a comprehensive digital representation of a live DJ performance.

In Example 17, the subject matter of Examples 1-16 includes, providing the stored synchronized data streams for additional processing to generate an editable digital audio file representing the performance.

Example 18 is a computer-implemented method for processing a recorded DJ performance data stream, the method comprising: receiving, by a computing system, a recorded DJ performance data stream comprising media player data and mixer data; analyzing, by the computing system, the recorded DJ performance data stream to identify performance events and transitions; generating, by the computing system, a post-processed recording file by applying one or more processing techniques and at least one DJ performance assumptions; splitting, by the computing system, the post-processed recording file into multiple DJ set files, each DJ set file representing a portion of the performance attributable to a respective DJ; and storing or transmitting, by the computing system, the multiple DJ set files.

In Example 19, the subject matter of Example 18 includes, wherein the media player data is received from a plurality of networked media players communicating over a digital DJ equipment networking protocol.

In Example 20, the subject matter of Example 19 includes, wherein the digital DJ equipment networking protocol enables synchronized playback between the networked media players.

In Example 21, the subject matter of Examples 18-20 includes, wherein the mixer data is received from an audio mixer communicating over a MIDI protocol.

In Example 22, the subject matter of Examples 18-21 includes, wherein analyzing the recorded DJ performance data stream comprises identifying beat markers, waveform data, loops, cue points, and transitions between media files.

In Example 23, the subject matter of Examples 18-22 includes, wherein generating the post-processed recording file comprises applying DJ-specific assumptions to interpret the recorded DJ performance data stream.

In Example 24, the subject matter of Example 23 includes, wherein the DJ-specific assumptions are based on analysis of DJ workflows and common practices.

In Example 25, the subject matter of Examples 18-24 includes, wherein splitting the post-processed recording file comprises analyzing the file to identify transitions between individual DJs within the performance.

In Example 26, the subject matter of Example 25 includes, wherein analyzing to identify DJ transitions comprises examining factors including mixing style, channel levels, timing, and audio announcements.

In Example 27, the subject matter of Examples 18-26 includes, wherein splitting the post-processed recording file comprises dividing the file into distinct files representing each DJ's individual contribution during the performance.

In Example 28, the subject matter of Examples 18-27 includes, wherein the stored multiple DJ set files can each be further processed to generate editable digital audio files for the individual DJs.

In Example 29, the subject matter of Example 28 includes, wherein the editable digital audio files have a file format optimized for a DJ digital audio workstation.

In Example 30, the subject matter of Examples 18-29 includes, wherein the computing system comprises a hardware device optimized for processing recorded DJ performance data.

In Example 31, the subject matter of Examples 18-30 includes, wherein the computing system comprises a software application executing on a computer system.

In Example 32, the subject matter of Examples 18-31 includes, wherein the computing system is incorporated into networked media players used to generate the recorded DJ performance data stream.

In Example 33, the subject matter of Examples 18-32 includes, wherein the computing system is incorporated into a DJ digital audio workstation application used to further process the DJ set files.

In Example 34, the subject matter of Examples 18-33 includes, wherein the recorded DJ performance data stream is generated by logging data streams from media players and a mixer during a live performance.

Example 35 is a computer-implemented method for converting recorded DJ performance data into an editable digital audio file, the method comprising: receiving, by a computing system, recorded DJ performance data comprising media player data and mixer data; analyzing, by the computing system, the recorded DJ performance data to identify audio elements including tracks, transitions, loops, and cue points; generating, by the computing system, an editable digital audio file representing the identified audio elements in a digital audio workstation (DAW) file format, the generating the editable digital audio file comprising inferring intended audio performance based on analysis of the recorded DJ performance data; and storing or transmitting, by the computing system, the generated editable digital audio file.

In Example 36, the subject matter of Example 35 includes, wherein the media player data is received from networked media players communicating over a digital DJ equipment networking protocol.

In Example 37, the subject matter of Example 36 includes, wherein the digital DJ equipment networking protocol enables synchronized playback between the networked media players.

In Example 38, the subject matter of Examples 35-37 includes, wherein the mixer data is received from an audio mixer communicating over a MIDI protocol.

In Example 39, the subject matter of Examples 35-38 includes, wherein analyzing the recorded DJ performance data comprises making assumptions about intended performance based on DJ workflows.

In Example 40, the subject matter of Examples 35-39 includes, wherein generating the editable digital audio file comprises mapping recorded data to corresponding audio effects and transitions.

In Example 41, the subject matter of Examples 35-40 includes, wherein the editable digital audio file represents a complete DJ set including transitions between a plurality of tracks.

In Example 42, the subject matter of Examples 35-41 includes, wherein the DAW file format is compatible with a DJ digital audio workstation application.

In Example 43, the subject matter of Example 42 includes, loading the generated editable digital audio file into the DJ digital audio workstation application for editing.

In Example 44, the subject matter of Example 43 includes, wherein the DJ digital audio workstation application comprises tools specific for DJ editing workflows.

In Example 45, the subject matter of Examples 35-44 includes, wherein the computing system comprises a hardware device optimized for converting recorded DJ performance data.

In Example 46, the subject matter of Examples 35-45 includes, wherein the computing system comprises a software application executing on a general-purpose computer system.

In Example 47, the subject matter of Examples 35-46 includes, wherein the computing system is incorporated into the networked media players used to generate the recorded DJ performance data.

In Example 48, the subject matter of Examples 35-47 includes, wherein the computing system is incorporated into the DJ digital audio workstation application.

In Example 49, the subject matter of Examples 35-48 includes, preprocessing the recorded DJ performance data prior to generating the editable digital audio file.

In Example 50, the subject matter of Example 49 includes, wherein preprocessing comprises filtering, beat grid analysis, metadata insertion, and file splitting.

Example 51 is a system comprising one or more processors and memory storing instructions that, when executed by the one or more processors, cause the system to perform the method of Example 35.

In Example 52, the subject matter of Examples 35-51 includes, wherein the recorded DJ performance data is generated by logging data streams from media players and a mixer during a live performance.

Example 53 is a computer-implemented method for propagating downstream changes when editing a digital media timeline, the method comprising: providing, on a graphical user interface of a computing device, a timeline view of a digital media file comprising a plurality of media clips arranged chronologically; detecting, via the graphical user interface, a user modification of a start time of a target media clip in the timeline view; and in response to detecting the user modification of the start time, automatically shifting start times of one or more downstream media clips occurring after the target media clip by an amount corresponding to the modification of the start time of the target media clip, such that the user modification is propagated to the one or more downstream media clips while maintaining their chronological arrangement.

In Example 54, the subject matter of Example 53 includes, wherein the digital media file comprises a DJ mix recording file.

In Example 55, the subject matter of Examples 53-54 includes, wherein the plurality of media clips comprises audio tracks in the digital media file.

In Example 56, the subject matter of Examples 53-55 includes, wherein each of the plurality of media clips is represented in a separate lane in the timeline view.

In Example 57, the subject matter of Examples 53-56 includes, wherein the user modification comprises altering a playback time of the target media clip.

In Example 58, the subject matter of Examples 53-57 includes, wherein automatically shifting the start times maintains a transition time between the target media clip and a first downstream media clip.

In Example 59, the subject matter of Examples 53-58 includes, identifying the one or more downstream media clips as those having start times equal to or after the start time of the target media clip.

In Example 60, the subject matter of Examples 53-59 includes, snapping the shifted start times of the one or more downstream media clips to a beat grid.

In Example 61, the subject matter of Examples 53-60 includes, wherein the user modification comprises removing the target media clip from the timeline view.

In Example 62, the subject matter of Example 61 includes, wherein automatically shifting the start times comprises closing a gap created by removing the target media clip by joining the one or more downstream media clips.

In Example 63, the subject matter of Examples 53-62 includes, storing the digital media file incorporating the propagated user modification.

In Example 64, the subject matter of Examples 53-63 includes, wherein the graphical user interface enables a user to scrub the timeline to preview propagated changes prior to permanently applying the user modification.

In Example 65, the subject matter of Examples 53-64 includes, wherein the graphical user interface provides a toggle control to enable or disable the automatic propagation of downstream changes.

In Example 66, the subject matter of Examples 53-65 includes, wherein the automatic propagation of changes is limited to media clips on a same track as the target media clip.

In Example 67, the subject matter of Examples 53-66 includes, wherein the automatic propagation of changes applies to media clips on multiple tracks in the timeline view.

Example 68 is a computer-implemented method for looping a section of a media track in a digital audio workstation (DAW) application, the computer-implemented method comprising: displaying a timeline representing the media track in a graphical user interface of the DAW application, the timeline comprising media segments arranged chronologically; detecting, via the graphical user interface, a user selection of a target media segment representing a section of the media track to loop; automatically looping playback of only the target media segment in response to user input indicating looping; extending a duration of the looping playback in response to user input dragging an endpoint of the target media segment;

and automatically appending media segments occurring after the target media segment to an end of the looping playback in response to user input indicating an end of looping.

In Example 69, the subject matter of Example 68 includes, wherein the media track comprises an audio track.

In Example 70, the subject matter of Examples 68-69 includes, wherein detecting the user selection comprises detecting a dragging operation over a portion of the timeline corresponding to the target media segment.

In Example 71, the subject matter of Examples 68-70 includes, wherein automatically looping playback comprises duplicating the target media segment multiple times and abutting the duplicated segments.

In Example 72, the subject matter of Examples 68-71 includes, wherein automatically looping playback comprises setting loop start and end markers at boundaries of the target media segment and repeatedly jumping playback between the markers.

In Example 73, the subject matter of Examples 68-72 includes, wherein automatically looping playback comprises directing an audio buffer to repeatedly play back only the target media segment.

In Example 74, the subject matter of Examples 68-73 includes, displaying a loop indicator on the graphical user interface in response to detecting the user selection of the target media segment.

In Example 75, the subject matter of Example 74 includes, wherein automatically looping playback begins in response to a user activating the loop indicator.

In Example 76, the subject matter of Examples 68-75 includes, wherein extending the looping playback duration comprises duplicating the target media segment additional times to extend the looping segment.

In Example 77, the subject matter of Examples 68-76 includes, wherein extending the looping playback duration comprises processing the target media segment with time stretching.

In Example 78, the subject matter of Examples 68-77 includes, wherein automatically appending media segments comprises removing loop start and end markers and abutting remaining media segments to the looping target media segment.

In Example 79, the subject matter of Examples 68-78 includes, automatically shifting start times of media segments occurring after the target media segment by an amount corresponding to the extended loop duration.

In Example 80, the subject matter of Examples 68-79 includes, analyzing beats within the target media segment and extending the loop duration based on detected beats.

In Example 81, the subject matter of Examples 68-80 includes, displaying a waveform representation of the media track aligned to and synchronized with the timeline.

In Example 82, the subject matter of Example 81 includes, updating the waveform representation upon changes to the media track.

In Example 83, the subject matter of Examples 68-82 includes, snapping the endpoints of the target media segment to detected beat markers within the media track.

In Example 84, the subject matter of Examples 68-83 includes, automatically detecting transitions between media segments and displaying transition indicators on the timeline.

In Example 85, the subject matter of Example 84 includes, emphasizing the transition indicators in response to user input.

In Example 86, the subject matter of Examples 68-85 includes, storing looping steps as a preset that can be applied to other media tracks.

In Example 87, the subject matter of Examples 68-86 includes, nesting loops within the target media segment to create loops within loops.

Example 88 is a computer-implemented method for editing a DJ mix to loop a selected section, the method comprising: displaying, on a graphical user interface, a multitrack representation of the DJ mix with each track represented as a separate lane; receiving, via the graphical user interface, a user input indicating a selection of a target section on a track lane of the multitrack representation, the target section comprising a subset of the track lane bounded by start and end points; and in response to receiving the user input, automatically: generating a loop comprising the selected target section; identifying a time period for looping playback of the loop; inserting multiple instances of the loop into the track lane to repeat playback of the target section during the identified time period.

In Example 89, the subject matter of Example 88 includes, snapping the start and end points of the target section to musical beat boundaries based on a beat grid.

In Example 90, the subject matter of Examples 88-89 includes, wherein the user input indicating the target section comprises clicking and dragging along a waveform representation of the track lane displayed in the graphical user interface.

In Example 91, the subject matter of Examples 88-90 includes, wherein identifying the time period for looping playback comprises detecting a drag operation expanding the selected target section.

In Example 92, the subject matter of Examples 88-91 includes, wherein inserting multiple instances of the loop comprises arranging the loop instances back-to-back to fill the identified time period.

In Example 93, the subject matter of Examples 88-92 includes, detecting a change in the selected target section; automatically updating the generated loop to correspond to the changed target section.

In Example 94, the subject matter of Examples 88-93 includes, upon detecting a loop release condition, removing remaining loop instances from the track lane.

Example 95 is a computer-implemented method to display loudness metering in a digital audio workstation (DAW), the computer-implemented method comprising: generating loudness meter segments on a loudness meter timeline aligned with and synchronized to audio segments on a main audio waveform timeline; selectively analyzing loudness of individual audio segments by extracting and processing the corresponding aligned loudness meter segments; visually differentiating transition regions on the loudness meter timeline; selectively analyzing the transition regions; and invalidating existing loudness meter segments in response to changes in audio parameters and re-analyzing upon user interaction.

In Example 96, the subject matter of Example 95 includes, wherein the loudness meter segments comprise LUFS (Loudness Units relative to Full Scale) meter segments.

In Example 97, the subject matter of Examples 95-96 includes, wherein selectively analyzing loudness comprises performing a LUFS analysis on the extracted audio segment.

In Example 98, the subject matter of Examples 95-97 includes, shading the loudness meter segments to visually indicate analysis status.

In Example 99, the subject matter of Example 98 includes, wherein a first shading indicates the loudness meter segment requires analysis.

In Example 100, the subject matter of Examples 98-99 includes, wherein a second shading indicates the loudness meter segment contains a transition region.

In Example 101, the subject matter of Examples 95-100 includes, wherein analyzing loudness comprises rendering a loudness waveform within the loudness meter segment bounded by start and end points of the segment.

In Example 102, the subject matter of Examples 95-101 includes, wherein transition regions are detected by identifying overlapping audio segments.

In Example 103, the subject matter of Example 102 includes, wherein only the overlapping portion of transition regions is analyzed.

In Example 104, the subject matter of Examples 95-103 includes, wherein changes in audio parameters comprise changes in at least one of volume or equalization.

In Example 105, the subject matter of Example 104 includes, wherein loudness meter segments are invalidated by changing shading in response to corresponding audio parameter changes.

In Example 106, the subject matter of Examples 95-105 includes, extracting audio segments for analysis based on alignment data between audio and loudness meter timelines.

In Example 107, the subject matter of Examples 95-106 includes, automatically generating new loudness meter segments when new audio segments are added.

In Example 108, the subject matter of Example 107 includes, wherein the new loudness meter segments are aligned with the new audio segments.

In Example 109, the subject matter of Examples 95-108 includes, snapping loudness meter segments to audio beat markers.

In Example 110, the subject matter of Examples 95-109 includes, continuously re-analyzing loudness in real-time as the audio is edited.

In Example 111, the subject matter of Examples 95-110 includes, storing loudness meter presets that can be applied to multiple audio tracks.

In Example 112, the subject matter of Examples 95-111 includes, displaying EQ curves aligned with and synchronized to the audio waveform timeline.

In Example 113, the subject matter of Example 112 includes, selectively analyzing and invalidating EQ curve segments similarly to the loudness meter segments.

In Example 114, the subject matter of Examples 95-113 includes, exporting the loudness meter data with the audio mixdown for broadcast proofing.

Example 115 is a method for monitoring and displaying loudness of an audio signal during playback, the method comprising: analyzing, by a computing system, an audio signal to determine loudness values over time that represent perceived loudness; displaying, by the computing system, a graphical representation indicating the determined loudness values synchronized to a playback position of the audio signal, wherein the graphical representation is displayed concurrently with a waveform representing the audio signal in a unified graphical user interface.

In Example 116, the subject matter of Example 115 includes, wherein loudness values are determined according to the LUFS (Loudness Units relative to Full Scale) loudness standard.

In Example 117, the subject matter of Examples 115-116 includes, wherein loudness values are determined for multiple frequency bands of the audio signal.

In Example 118, the subject matter of Example 117 includes, wherein the frequency bands comprise low, mid, and high frequency bands.

In Example 119, the subject matter of Examples 115-118 includes, wherein the graphical representation comprises a multi-channel meter with channels corresponding to determined loudness values in different frequency bands.

In Example 120, the subject matter of Example 119 includes, wherein positions of indicators in each channel represent loudness values over time in each frequency band.

In Example 121, the subject matter of Examples 115-120 includes, wherein the graphical representation is integrated into an audio editing application displaying the waveform representing the audio signal.

In Example 122, the subject matter of Example 121 includes, wherein the graphical representation is displayed aligned with and synchronized to the waveform representing the audio signal.

In Example 123, the subject matter of Example 122 includes, wherein the graphical representation scrolls with the waveform during playback to indicate loudness values at the playback position.

In Example 124, the subject matter of Examples 115-123 includes, wherein the audio signal comprises a musical recording.

In Example 125, the subject matter of Example 124 includes, wherein the musical recording comprises a DJ mix recording.

In Example 126, the subject matter of Examples 115-125 includes, receiving, by the computing system, user input adjusting a playback volume of the audio signal; and updating, by the computing system, the graphical representation to indicate loudness values corresponding to the adjusted playback volume.

In Example 127, the subject matter of Examples 115-126 includes, wherein analyzing the audio signal and determining loudness values is performed in real time during playback.

In Example 128, the subject matter of Examples 115-127 includes, wherein determining loudness values is based on analysis of the audio signal prior to playback.

In Example 129, the subject matter of Examples 115-128 includes, wherein the method is performed within a digital audio workstation application.

Example 130 is a computer-implemented method for converting recorded DJ performance data into an editable digital audio file, the method comprising: receiving, by a computing system, recorded DJ performance data comprising media player data and mixer data; analyzing, by the computing system, the recorded DJ performance data to identify audio elements including tracks, transitions, loops, and cue points; generating, by the computing system, an editable digital audio file representing the identified audio elements in a digital audio workstation (DAW) file format, the generating comprising: creating track objects for tracks played including effects applied to each track; generating clip objects representing parts of tracks played without jumps; generating processor objects representing effects applied to tracks; generating tempo objects representing tempo changes aligned to a session timeline; and storing, by the computing system, the generated editable digital audio file.

In Example 131, the subject matter of Example 130 includes, wherein analyzing comprises making assumptions about intended performance based on DJ workflows.

In Example 132, the subject matter of Examples 130-131 includes, wherein generating the editable digital audio file comprises mapping recorded data to corresponding audio effects and transitions.

In Example 133, the subject matter of Examples 130-132 includes, wherein the editable digital audio file represents a complete DJ set including transitions between a plurality of tracks.

In Example 134, the subject matter of Examples 130-133 includes, wherein the DAW file format is compatible with a DJ digital audio workstation application.

In Example 135, the subject matter of Example 134 includes loading the generated editable digital audio file into the DJ digital audio workstation application for editing.

In Example 136, the subject matter of Examples 130-135 includes, wherein creating track objects comprises: parsing event data associated with each track; and generating clip objects representing contiguous track segments between extracted events.

In Example 137, the subject matter of Example 136 includes, wherein creating clip objects further comprises: analyzing a sequence of events to identify clip boundaries.

In Example 138, the subject matter of Example 137 includes, wherein the events include at least one of play events, pause events, jump events, or transition events.

In Example 139, the subject matter of Examples 130-138 includes, wherein creating clip objects further comprises synchronizing transitions between clips across tracks.

In Example 140, the subject matter of Examples 130-139 includes, wherein generating processor objects comprises: filtering events to isolate mixer-related messages; mapping MIDI control data to corresponding effects parameters based on a mixer model.

In Example 141, the subject matter of Example 140 includes normalizing parameter values from a MIDI range to a range defined in the target DAW application.

In Example 142, the subject matter of Examples 130-141 includes, wherein generating tempo objects comprises: detecting master tempo change events based on changes to a tempo master track; generating a tempo object containing a new BPM value and a timestamp.

In Example 143, the subject matter of Examples 130-142 includes, preprocessing the recorded DJ performance data prior to generating the editable digital audio file.

In Example 144, the subject matter of Example 143 includes, wherein preprocessing comprises at least one of filtering, beat grid analysis, metadata insertion, and file splitting.

In Example 145, the subject matter of Examples 130-144 includes, wherein the computing system comprises a hardware device optimized for converting recorded DJ performance data.

In Example 146, the subject matter of Examples 130-145 includes, wherein the computing system is incorporated into networked media players used to generate the recorded DJ performance data.

In Example 147, the subject matter of Examples 130-146 includes, wherein the computing system is incorporated into the DJ digital audio workstation application.

In Example 148, the subject matter of Examples 130-147 includes, wherein the recorded DJ performance data is generated by logging data streams from media players and a mixer during a live performance.

In Example 149, the subject matter of Examples 130-148 includes, embodied as instructions stored on a non-transitory computer-readable medium and executed on a computing device.

Example 150 is a computer-implemented method for converting a postprocessed recording file to a digital audio workstation (DAW) project file, the method comprising: receiving a postprocessed recording file; extracting recording data from the postprocessed recording file; generating a DAW project file; creating one or more track objects for tracks identified in the recording data; generating clip objects for each track object by analyzing track events in the recording data; synchronizing clip object timing and positioning between tracks; generating processor objects for effects applied to each track; normalizing processor object parameter values to value ranges defined for the DAW; generating tempo objects from tempo data in the recording data; and writing the track objects, clip objects, processor objects and tempo objects to the DAW project file.

Example 151 is at least one machine-readable medium including instructions that, when executed by processing circuitry, cause the processing circuitry to perform operations to implement of any of Examples 1-150.

Example 152 is an apparatus comprising means to implement of any of Examples 1-150.

Example 153 is a system to implement of any of Examples 1-150.

Example 154 is a method to implement of any of Examples 1-150.

### Example Set 2

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one DJ media player and at least one DJ mixer producing performance data; a logging device configured to receive the performance data from the media player and mixer; and a converter module configured to generate an editable multitrack audio representation from the performance data.

In Example 2, the subject matter of Example 1, wherein the at least one DJ media player communicates via a digital DJ equipment networking protocol that enables synchronized playback between networked media players.

In Example 3, the subject matter of any one or more of Examples 1-2, wherein the at least one DJ mixer communicates via a control data interface protocol.

In Example 4, the subject matter of any one or more of Examples 1-3, wherein the control data interface protocol comprises MIDI (Musical Instrument Digital Interface).

In Example 5, the subject matter of any one or more of Examples 1-4, wherein the logging device comprises a DJ media player receiver configured to receive data from the at least one DJ media player and a control data receiver configured to receive data from the at least one DJ mixer.

In Example 6, the subject matter of any one or more of Examples 1-5, wherein the logging device further comprises a message parser configured to synchronize data received from the at least one DJ media player and the at least one DJ mixer based on timestamp data.

In Example 7, the subject matter of any one or more of Examples 1-6, wherein the at least one DJ media player comprises a plurality of DJ media players connected via a network, and wherein the logging device is configured to receive performance data from all of the plurality of DJ media players.

In Example 8, the subject matter of any one or more of Examples 1-7, wherein the converter module is configured to analyze the performance data to identify audio elements including tracks, transitions, loops, and cue points within a DJ performance.

In Example 9, the subject matter of any one or more of Examples 1-8, wherein the converter module is configured to preprocess the performance data prior to generating the editable multitrack audio representation, wherein the preprocessing comprises at least one of: filtering irrelevant data, fixing sync issues, applying metadata, quantizing events to a beat grid, smoothing out artifacts, or inserting semantic performance details.

In Example 10, the subject matter of any one or more of Examples 1-9, wherein the editable multitrack audio representation comprises a digital representation in a structured data format including information related to tracks, effects, and timing.

In Example 11, the subject matter of any one or more of Examples 1-10, wherein the converter module is configured to generate the editable multitrack audio representation by: creating track objects for a plurality of tracks of a DJ performance; generating clip objects representing segments of the plurality of tracks; generating processor objects representing effects applied to tracks; and generating tempo objects representing tempo information.

In Example 12, the subject matter of any one or more of Examples 1-11, wherein the editable multitrack audio representation is compatible with a digital audio workstation application.

In Example 13, the subject matter of any one or more of Examples 1-12, wherein the digital audio workstation application comprises tools specific for DJ editing work flows.

In Example 14, the subject matter of any one or more of Examples 1-13, wherein the converter module is configured to automatically align loop points that deviate from beat grid positions to a closest beat grid position.

In Example 15, the subject matter of any one or more of Examples 1-14, wherein the converter module is configured to map control data to corresponding effects parameters based on a mixer model.

In Example 16, the subject matter of any one or more of Examples 1-15, wherein the converter module is configured to normalize parameter values from a MIDI range to a range defined in a target digital audio workstation application.

In Example 17, the subject matter of any one or more of Examples 1-16, wherein the editable multitrack audio representation comprises a JSON format file containing information needed for a digital audio workstation to replicate a DJ performance.

In Example 18, the subject matter of any one or more of Examples 1-17, wherein the system further comprises a splitter configured to split the performance data into multiple DJ set files, each DJ set file representing a portion of a DJ performance attributable to a respective DJ.

In Example 19, the subject matter of any one or more of Examples 1-18, wherein the system is incorporated into at least one of: a dedicated hardware device, the at least one DJ media player, or a digital audio workstation application.

In Example 20, the subject matter of any one or more of Examples 1-19, wherein the system further comprises a loudness metering tool configured to analyze an audio signal to determine loudness values over time according to the LUFS (Loudness Units relative to Full Scale) loudness standard.

### Example Set 3

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a computer-readable data file produced by a method for generating an editable representation of a DJ performance, comprising a structured arrangement of tracks, clips, effects, and tempo information representing the DJ performance.

In Example 2, the subject matter of Example 1, wherein the structured arrangement comprises track objects for a plurality of tracks of the DJ performance, clip objects representing segments of the plurality of tracks, processor objects representing effects applied to tracks, and tempo objects representing tempo information.

In Example 3, the subject matter of any one or more of Examples 1-2, wherein the computer-readable data file is in a format compatible with a digital audio workstation application.

In Example 4, the subject matter of any one or more of Examples 1-3, wherein the computer-readable data file comprises a JSON format file.

In Example 5, the subject matter of any one or more of Examples 1-4, wherein the computer-readable data file contains information including project name, file path, initial tempo, software version, UI settings, tracks played, effects applied, and automation lane points.

In Example 6, the subject matter of any one or more of Examples 1-5, wherein the structured arrangement of tracks includes transitions between a plurality of tracks, and wherein the transitions include at least one of a beatmatched transition, an effect-based transition, or an EQ-based transition.

In Example 7, the subject matter of any one or more of Examples 1-6, wherein loop points within the structured arrangement are aligned to beat grid positions.

In Example 8, the subject matter of any one or more of Examples 1-7, wherein the computer-readable data file includes parameter values normalized from a MIDI range to a range defined in a target digital audio workstation application.

In Example 9, the subject matter of any one or more of Examples 1-8, wherein the computer-readable data file includes references to original audio files used in the DJ performance rather than recorded audio.

In Example 10, the subject matter of any one or more of Examples 1-9, wherein the computer-readable data file includes information derived from at least three data sources: data from a DJ media player, control data, and audio waveform data.

In Example 11, the subject matter of any one or more of Examples 1-10, wherein the computer-readable data file includes semantic performance details inferred from analysis of the DJ performance.

In Example 12, the subject matter of any one or more of Examples 1-11, wherein the computer-readable data file represents a complete DJ set including transitions between a plurality of tracks.

In Example 13, the subject matter of any one or more of Examples 1-12, wherein the computer-readable data file includes tempo change events aligned to a quantized beat grid.

In Example 14, the subject matter of any one or more of Examples 1-13, wherein the computer-readable data file includes transition parameters between tracks derived from volume envelope data.

In Example 15, the subject matter of any one or more of Examples 1-14, wherein the computer-readable data file is configured to be loaded into a digital audio workstation application for editing using tools specific for DJ editing workflows.

What is claimed is:

1. A computer-implemented method for generating an editable representation of a DJ performance, the computer-implemented method comprising:
accessing, by a computing system, at least one data stream representing the DJ performance;
analyzing, by the computing system, the at least one data stream to identify audio elements within the DJ performance;
generating, by the computing system, a digital representation of the audio elements editable in a digital audio workstation, wherein the digital representation includes information related to tracks, effects, and timing; and
storing, by the computing system, the digital representation.

2. The computer-implemented method of claim 1, further comprises generating the at least one data stream by:
accessing a first data stream from a first musical device communicating via a first protocol;
accessing a second data stream from a second musical device communicating via a second protocol; and
synchronizing the first data stream and the second data stream, based on timestamp data, to generate a synchronized sequence of performance data.

3. The computer-implemented method of claim 2, wherein the first protocol comprises a digital DJ equipment networking protocol that enables synchronized playback between networked media players, and the second protocol comprises a control data interface from a DJ mixer and wherein the first musical device comprises a DJ media player and the second musical device comprises a hardware DJ mixer.

4. The computer-implemented method of claim 2, further comprising preprocessing the synchronized data streams prior to generating the digital representation, wherein the preprocessing comprises at least one of: filtering irrelevant data, fixing sync issues, applying metadata, quantizing events to a beat grid, smoothing out artifacts, or inserting semantic performance details.

5. The computer-implemented method of claim 1, wherein analyzing the at least one data stream comprises applying rules to interpret the at least one data stream, including aligning timing elements with a beat grid.

6. The computer-implemented method of claim 1, wherein the generating of the digital representation comprises:
creating track objects for a plurality of tracks of the DJ performance, the creating of the track objects including effects applied to each track of the plurality of tracks;
generating clip objects representing segments of the plurality of tracks;
generating processor objects representing effects applied to tracks; and
generating tempo objects representing tempo information.

7. The computer-implemented method of claim 6, wherein the creating of the track objects comprises:
parsing event data associated with each track of the plurality of tracks to identify events within the DJ performance;
identifying track boundaries based on transitions between the plurality of tracks; and
generating clip objects representing contiguous track segments between the events within the DJ performance.

8. The computer-implemented method of claim 7, wherein the creating of the clip objects further comprises:
analyzing a sequence of events to identify clip boundaries, wherein the sequence of events includes at least one of play events, pause events, jump events, or transition events, and
aligning any loop points that deviate from beat grid positions to a closest beat grid position.

9. The computer-implemented method of claim 6, wherein the generating of the processor objects comprises:
filtering events to isolate mixer-related messages;
mapping MIDI control data to corresponding effects parameters based on a mixer model; and
generating transition parameters between tracks by analyzing volume envelope data from the at least one data stream.

10. The computer-implemented method of claim 6, wherein the generating of the tempo objects comprises:
detecting master tempo changes based on changes to a tempo master track;
generating a tempo object containing a new BPM value and a timestamp; and
aligning the tempo object to a quantized beat grid within the digital representation.

11. The computer-implemented method of claim 1, wherein the digital representation represents the DJ performance including transitions between a plurality of tracks, and wherein the transitions include at least one of a beatmatched transition, an effect-based transition, or an EQ-based transition.

12. The computer-implemented method of claim 1, wherein the digital representation is compatible with a digital audio workstation application, and further comprising loading the digital representation into the digital audio workstation application for editing using tools specific for DJ editing workflows.

13. The computer-implemented method of claim 1, further comprising:
detecting a user modification of a start time of a target media clip in a timeline view; and
in response to detecting the user modification, automatically shifting start times of one or more downstream media clips occurring after the target media clip to maintain a chronological arrangement of the one or more downstream media clips and the target media clip.

14. The computer-implemented method of claim 1, further comprising:
receiving a user input indicating a selection of a target section on a track;
generating a loop comprising the target section;
inserting multiple instances of the loop to repeat playback of the target section during an identified time period; and
snapping loop boundaries to musical beat boundaries based on a beat grid.

15. The computer-implemented method of claim 1, further comprising:
analyzing an audio signal to determine loudness values over time that represent perceived loudness according to the LUFS (Loudness Units relative to Full Scale) loudness standard;
displaying a graphical representation indicating the loudness values synchronized to a playback position of the audio signal; and
invalidating existing loudness meter segments in response to changes in audio parameters.

16. The computer-implemented method of claim 1, further comprising splitting the at least one data stream into multiple DJ set files, each DJ set file representing a portion of the DJ performance attributable to a respective DJ, wherein splitting comprises analyzing measurable performance characteristics including at least one of channel level patterns, transition timing, effect usage patterns, or detected vocal announcements.

17. The computer-implemented method of claim 1, wherein the at least one data stream comprises at least three data sources: data from a DJ media player, MIDI control data, and audio waveform data, and wherein the digital representation synthesizes the at least three data sources to facilitate recreation of the DJ performance.

18. The computer-implemented method of claim 1, wherein the digital representation comprises a JSON format file containing information needed for the digital audio workstation to replicate the DJ performance, including project name, file path, initial tempo, software version, UI settings, tracks played, effects applied, and automation lane points.

19. A computing apparatus comprising at least one processor and at least one memory storing instructions configured such that, when executed in cooperation with controlling the at least one processor, the instructions operate the computing apparatus to perform a method comprising:
accessing, by a computing system, at least one data stream representing a DJ performance;
analyzing, by the computing system, the at least one data stream to identify audio elements within the DJ performance;
generating, by the computing system, a digital representation of the audio elements editable in a digital audio workstation, wherein the digital representation includes information related to tracks, effects, and timing; and
storing, by the computing system, the digital representation.

20. A non-transitory computer-readable medium on which computer-executable instructions are stored to implement a method comprising:
accessing, by a computing system, at least one data stream representing a DJ performance;
analyzing, by the computing system, the at least one data stream to identify audio elements within the DJ performance;
generating, by the computing system, a digital representation of the audio elements editable in a digital audio workstation, wherein the digital representation includes information related to tracks, effects, and timing; and
storing, by the computing system, the digital representation.
